(19) United States
(12) Patent Application Publication
(10) Pub. No.: US 2025/0223928 A1
(43) Pub. Date: Jul. 10, 2025

(54) GAS TURBINE ENGINE

(71) Applicant: General Electric Company, Evendale, OH (US)

(72) Inventors: Daniel John Oehrle, West Chester, OH (US); Randy M. Vondrell, Newport, KY (US); Apolinario Barra Ruiz, Queretaro (MX)

(21) Appl. No.: 19/091,238

(22) Filed: Mar. 26, 2025

Related U.S. Application Data
(63) Continuation-in-part of application No. 18/824,100, filed on Sep. 4, 2024.
Application No. 18/824,100 is a continuation of application No. 17/972,720, filed on Oct. 25, 2022, now Pat. No. 12,104,539.

(51) Int. Cl. F02C 7/32; B64D 27/12

(52) U.S. Cl. CPC F02C 7/32; B64D 27/12

(57) ABSTRACT

A gas turbine engine includes an unducted primary fan and an engine core having a combustor casing that defines an outer surface. A fastening assembly, a mounting assembly, or both are located between a core cowl that surrounds the core engine. In a radial direction, an outer surface of the core cowl defines a peak cowl diameter (D), and the outer surface of the combustor casing defines a maximum combustor casing diameter (d). A core cowl diameter ratio (CDR) is the peak cowl diameter (D) divided by the maximum combustor casing diameter (d) and is between 2.7 and 3.5. In an axial direction, the core engine defines an overall core axial length (L) and an under-core cowl axial length (L1). A core cowl length ratio (CLR) is the under-core cowl axial length (L1) divided by the overall core axial length (L) and is between 0.25 and 0.50.

### CROSS-REFERENCE TO RELATED APPLICATIONS

This application is a continuation-in-part application of U.S. application Ser. No. 18/824,100, filed Sep. 4, 2024, which is a continuation of U.S. application Ser. No. 17/972,720, filed Oct. 25, 2022, which issued as U.S. Pat. No. 12,104,539 on Oct. 1, 2024, all of which are hereby incorporated by reference in their entirety.

### FIELD

The present disclosure relates to a gas turbine engine, such as an aeronautical gas turbine engine.

### BACKGROUND

A gas turbine engine generally includes a turbomachine. The turbomachine includes several engine accessories such as controllers, pumps, heat exchangers and the like that are necessary for operation. These engine accessories and engine systems may be mounted to the turbomachine.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is perspective view of an exemplary aircraft in accordance with an exemplary embodiment of the present disclosure.

FIG. 2 is a schematic cross-sectional view of a ducted turbofan gas turbine engine in accordance with an exemplary embodiment of the present disclosure.

FIG. 3 is a schematic cross-sectional view of a portion of the ducted turbofan gas turbine engine shown in FIG. 2, in accordance with an exemplary embodiment of the present disclosure.

FIG. 4 is a schematic cross-sectional view of a three-stream engine in accordance with an exemplary embodiment of the present disclosure.

FIG. 5 is an enlarged view of an exemplary fan blade according to exemplary embodiments of the present disclosure.

FIG. 6 is a schematic cross-sectional view of a portion of a core engine of the gas turbine engine as shown in FIG. 4, according to an exemplary embodiment of the present disclosure.

FIG. 7 is a front view of a portion of the gas turbine engine as shown in FIGS. 4 and 6, mounted to a portion of an exemplary wing according to exemplary embodiments of the present disclosure.

FIG. 8 is a schematic cross-sectional view of the gas turbine engine as shown in FIG. 4, according to an exemplary embodiment of the present disclosure.

FIG. 9 is a schematic cross-sectional view of the gas turbine engine as shown in FIG. 4, according to an exemplary embodiment of the present disclosure.

FIG. 10 is a schematic illustration including an engine component, a portion of a core cowl structure, an exemplary fastener and a portion of a core engine structure according to exemplary embodiments of the present disclosure.

FIG. 11 is a schematic illustration including an engine component, a portion of a core cowl structure, an exemplary fastener and a portion of a core engine structure according to exemplary embodiments of the present disclosure.

FIG. 12 is a schematic illustration including an engine component, a portion of a core cowl structure, a push-pull mechanism, and a portion of a core engine structure according to exemplary embodiments of the present disclosure.

FIG. 13 is a schematic illustration including an engine component, a portion of a core cowl structure, a push-pull mechanism, and a portion of a core engine structure according to exemplary embodiments of the present disclosure.

FIG. 14 is a graphical representation illustrating a relationship between CDR and CLR and showing relationships between the various parameters of Expressions (1) and (2) according to exemplary embodiments of the present disclosure.

FIG. 15 is a schematic cross-sectional view of a ducted turbofan engine in accordance with an exemplary embodiment of the present disclosure.

FIG. 16 is a graphical representation illustrating initial compression length ratio (ICLR) values for gas turbine engines in accordance with various exemplary embodiments of the present disclosure.

FIG. 17 shows a schematic, perspective view of a tube spacing and fastening system for tubular structures, according to an embodiment of the present disclosure.

FIG. 18 shows an enlarged schematic, perspective front view of a spacer for the tube spacing and fastening system of FIG. 17, according to an embodiment of the present disclosure.

FIG. 19 shows an enlarged schematic, perspective back view of a spacer for the tube spacing and fastening system of FIG. 17, according to an embodiment of the present disclosure.

FIG. 20 shows a schematic, perspective view of a tube spacing and fastening system for tubular structures, according to an embodiment of the present disclosure.

FIG. 21 shows a schematic, perspective view of a spacer for the tube spacing and fastening system of FIG. 20, according to an embodiment of the present disclosure.

FIG. 22 shows a schematic, perspective view of a tube spacing and fastening system for tubular structures, according to an embodiment of the present disclosure.

FIG. 23 shows an enlarged schematic, perspective view of a spacer for the tube spacing and fastening system of FIG. 22, according to an embodiment of the present disclosure.

FIG. 24 shows a schematic, perspective view of a tube spacing and fastening system for tubular structures, according to an embodiment of the present disclosure.

FIG. 25 shows a schematic, perspective view of a tube spacing and fastening system for tubular structures, according to an embodiment of the present disclosure.

FIG. 26A shows a partial perspective view of a spacer for a tube spacing and fastening system, according to an embodiment of the present disclosure.

FIG. 26B shows a partial perspective view of a spacer for a tube spacing and fastening system, according to an embodiment of the present disclosure.

FIG. 26C shows a partial perspective view of a spacer for a tube spacing and fastening system, according to an embodiment of the present disclosure.

FIG. 27 shows a schematic flow diagram of a method of spacing and fastening multiple tubular structures, according to an embodiment of the present disclosure.

FIG. 28 is a schematic, perspective view of a mounting assembly for engine accessories, according to an embodiment of the present disclosure.

FIG. 29 is a schematic, perspective view of another mounting assembly for engine accessories, according to an embodiment of the present disclosure.

FIG. 30 is a side view of a portion of another mounting system, according to an embodiment of the present disclosure.

FIG. 31 is a cross section of a portion of the mounting assembly of FIG. 29 alone line XXXI, according to an embodiment of the present disclosure.

FIG. 32A is a schematic, perspective view of a fastener for use in the mounting assembly of FIG. 28, according to an embodiment of the present disclosure.

FIG. 32B is a schematic, side view of the fastener of FIG. 32A for use in the mounting assembly of FIG. 28, according to an embodiment of the present disclosure.

FIG. 33A is a schematic, perspective view of a fastener for use in the mounting assembly of FIG. 29, according to an embodiment of the present disclosure.

FIG. 33B is a schematic, side view of the fastener of FIG. 33A for use in the mounting assembly of FIG. 29, according to an embodiment of the present disclosure.

FIG. 34A is a schematic, perspective view of a fastener for use in the mounting assembly of FIG. 29, according to an embodiment of the present disclosure.

FIG. 34B is a schematic, side view of the fastener of FIG. 34A for use in the mounting assembly of FIG. 29, according to an embodiment of the present disclosure.

FIG. 35 is a schematic, perspective view of yet another mounting assembly for engine accessories, according to an embodiment of the present disclosure.

FIG. 36 is a schematic, perspective view of still yet another mounting assembly for engine accessories, according to an embodiment of the present disclosure.

FIG. 37 is a cross section of a portion of the mounting assembly of FIG. 26 along line XXXVII, according to an embodiment of the present disclosure.

FIG. 38 is a cross section of another portion of the mounting assembly of FIG. 29 alone line XXXVIII, according to an embodiment of the present disclosure.

FIG. 39 is a schematic, perspective view of a mounting assembly having a cowl platform, according to an embodiment of the present disclosure.

FIG. 40 is an enlarged view of a portion of the mounting assembly of FIG. 39, according to an embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or aircraft and refer to the normal operational attitude of the gas turbine engine or aircraft. For example, with regards to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “cowl” includes a housing, casing, or other structure that at least partially encases or surrounds a portion of a turbomachine or gas turbine engine.

The phrases “from X to Y” and “between X and Y” each refers to a range of values inclusive of the endpoints (i.e., refers to a range of values that includes both X and Y).

The term “propulsive efficiency” refers to an efficiency with which the energy contained in an engine's fuel is converted into kinetic energy for the vehicle incorporating the engine, to accelerate it, or to replace losses due to aerodynamic drag or gravity.

As used herein, the term “rated speed” with reference to a gas turbine engine refers to a maximum rotational speed that the gas turbine engine may achieve while operating properly. For example, the gas turbine engine may be operating at the rated speed during maximum load operations, such as during takeoff operations.

The term “standard day operating condition” refers to ambient conditions of sea level altitude, 59 degrees Fahrenheit, and 60 percent relative humidity.

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, at a static flight speed, and/or at 86 degree Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

Conventional turbofan engine design practice has been to provide an outer nacelle surrounding the fan to provide relatively efficient thrust for the turbofan engine at high fan speeds (compared with an unducted fan). Such a configuration may generally limit a permissible size of the fan (i.e., a diameter of the fan). Generally, a turbofan engine includes a fan to provide a desired amount of thrust without overloading the fan blades (i.e., without increasing a disk loading of the fan blades of the fan beyond a certain threshold), and therefore to maintain a desired overall propulsive efficiency for the turbofan engine. The inventors of the present disclosure seek to drive the fan diameter higher, thereby to reduce fan pressure ratio while maintaining the same level of thrust to improve fuel efficiency. By increasing the fan diameter, however, an installation of the turbofan engine becomes more difficult. In addition, if an outer nacelle is maintained, the outer nacelle may become weight prohibitive with some larger diameter fans.

The inventors of the present disclosure found that for a three-stream gas turbine engine having an unducted primary fan (the outer nacelle removed) and a ducted secondary fan, with the secondary fan providing an airflow to a third stream of the gas turbine engine, an overall propulsive efficiency of the gas turbine engine that results from providing a high diameter fan may be maintained at a high level, while reducing the size of the primary fan. Such a configuration may maintain a desired overall propulsive efficiently for the gas turbine engine, or unexpectedly, may in fact increase the overall propulsive efficiency of the gas turbine engine. Further, by including a third stream, an axial length of the core engine may be reduced relative to the overall engine axial length by allowing for a portion of the airflow through the engine to flow through the third stream. This reduces an overall weight of the engine. However, the core engine must maintain a sufficient size to produce enough power to drive the primary fan and the ducted secondary fan.

Further, removing the outer nacelle and reducing the overall axial length of the core engine significantly reduces engine accessory storage space. A diameter of a core cowl may be increased to make room for the accessories between an engine casing and an inner surface of the core cowl, however, the core cowl diameter cannot be too large due to potential performance penalties such as excessive drag and installation difficulties.

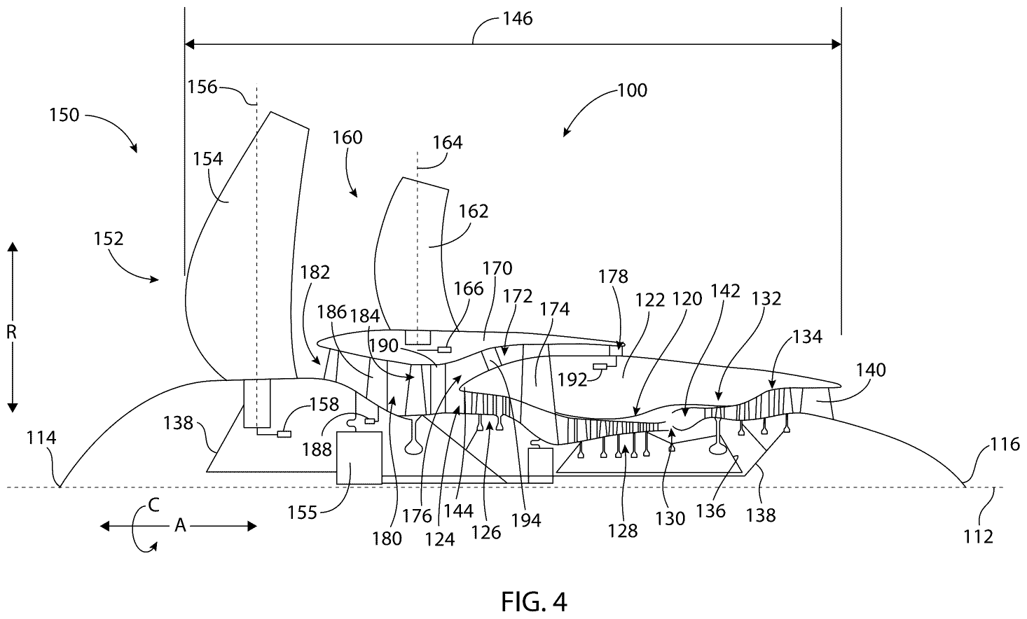

The inventors proceeded in the manner of designing a gas turbine engine with a given core cowl diameter, core diameter, core axial length, and overall engine axial length; checking the propulsive efficiency of the designed gas turbine engine; redesigning the gas turbine engine with varying core cowl diameters, core diameters, core axial lengths, and overall engine axial lengths; rechecking the propulsive efficiency of the redesigned gas turbine engine; and then making accommodations when, for example, it was found that subsystem sizes increased due to certification requirements and/or power requirements, or servicing needs impacted where to locate things during the design of several different types of gas turbine engines, including the gas turbine engine described below with reference to, e.g., FIGS. 4 through 8.

During the course of this practice of studying and evaluating various cowl diameters, core diameters, core length, and engine length considered feasible for best satisfying mission requirements, it was discovered that certain relationships exist between a core cowl diameter ratio (which is equal to a peak cowl diameter divided by a maximum combustor casing diameter) and a core cowl length ratio (which is equal to an under-core cowl axial length divided by an overall core axial length). In particular, the inventors of the present disclosure have found that these ratios can be thought of as an indicator of the ability of a gas turbine engine to provide sufficient packaging space between the core engine combustor casing and the core cowl for packaging/mounting various accessories and/or engine systems, while also having a core engine capable of producing sufficient power to drive primary and secondary fans, particularly in more complex engine designs. In some embodiments, the inventors found that selectively coupling one or more engine components such as an engine accessory or system component to one of the core cowl or to the engine improves accessibility for inspection, repair, and maintenance and improves weigh loads on the core engine.

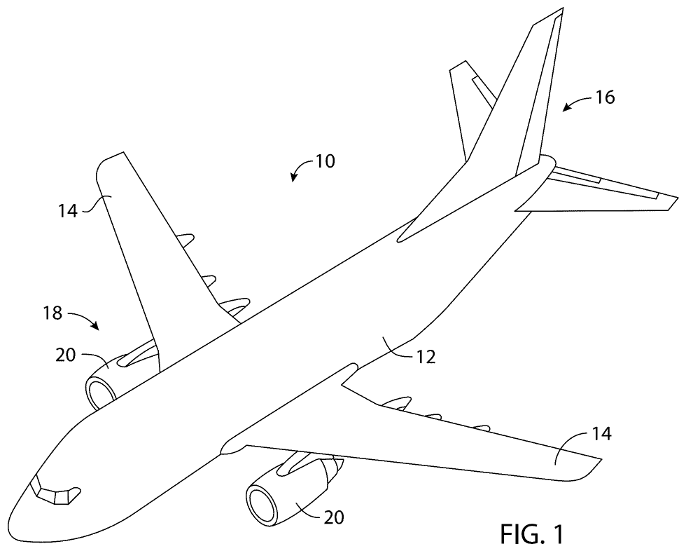

Referring now to the drawings, FIG. 1 is a perspective view of an exemplary aircraft 10 that may incorporate at least one exemplary embodiment of the present disclosure. As shown in FIG. 1, the aircraft 10 has a fuselage 12, wings 14 attached to the fuselage 12, and an empennage 16. The aircraft 10 further includes a propulsion system 18 that produces a propulsive thrust to propel the aircraft 10 in flight, during taxiing operations, etc. Although the propulsion system 18 is shown attached to the wing(s) 14, in other embodiments it may additionally or alternatively include one or more aspects coupled to other parts of the aircraft 10, such as, for example, the empennage 16, the fuselage 12, or both. The propulsion system 18 includes at least one engine. In the exemplary embodiment shown, the aircraft 10 includes a pair of gas turbine engines 20. Each gas turbine engine 20 is mounted to the aircraft 10 in an under-wing configuration. Each gas turbine engine 20 is capable of selectively generating a propulsive thrust for the aircraft 10. The gas turbine engines 20 may be configured to burn various forms of fuel including, but not limited to unless otherwise provided, jet fuel/aviation turbine fuel, and hydrogen fuel.

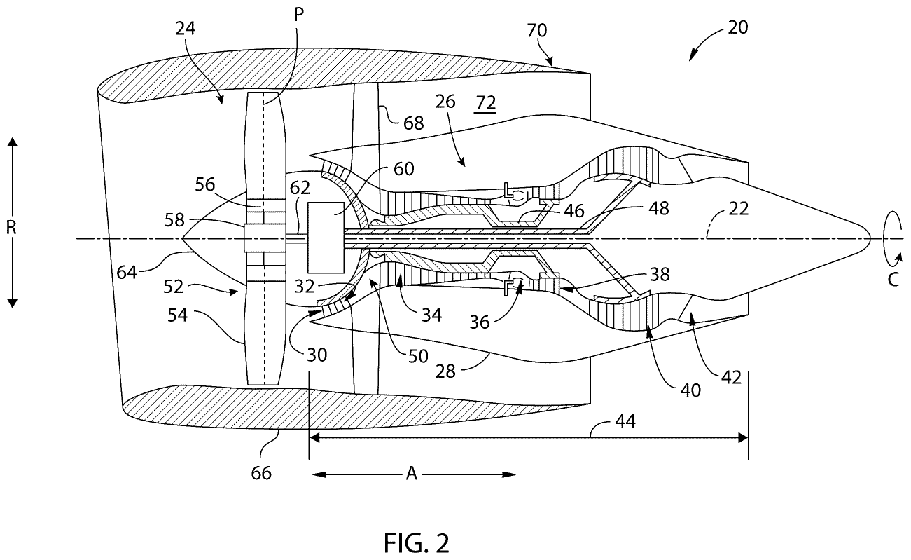

FIG. 2 is a cross-sectional side view of a gas turbine engine 20 in accordance with an exemplary embodiment of the present disclosure. More particularly, for the embodiment of FIG. 2, the gas turbine engine 20 is a multi-spool, high-bypass turbofan jet engine, sometimes also referred to as a “turbofan engine.” As shown in FIG. 2, the gas turbine engine 20 defines an axial direction A (extending parallel to a longitudinal centerline 22 provided for reference), a radial direction R, and a circumferential direction C extending about the longitudinal centerline 22. In general, the gas turbine engine 20 includes a fan section 24 and a turbomachine 26 disposed downstream from the fan section 24.

The exemplary turbomachine 26 depicted generally includes an engine housing, casing, or core cowl 28 that defines an annular core inlet 30. The core cowl 28 at least partially encases, in serial flow relationship, a compressor section including a booster or low-pressure compressor 32 and a high-pressure compressor 34, a combustion section 36, a turbine section including a high-pressure turbine 38 and a low-pressure turbine 40, and at least a portion of a jet exhaust nozzle 42. Together, these components or sections make up a core engine 44 of the turbomachine 26.

A high-pressure shaft 46 drivingly connects the high-pressure turbine 38 to the high-pressure compressor 34. A low-pressure shaft 48 drivingly connects the low-pressure turbine 40 to the low-pressure compressor 32. The compressor section, combustion section 36, turbine section, and jet exhaust nozzle 42 together define a working gas flow path 50 through the gas turbine engine 20.

For the embodiment depicted, the fan section 24 includes a fan 52 having a plurality of fan blades 54 coupled to a disk 56 in a spaced apart manner. As depicted, the fan blades 54 extend outwardly from disk 56 generally along the radial direction R. Each fan blade 54 is rotatable with the disk 56 about a pitch axis P by virtue of the fan blades 54 being operatively coupled to a suitable pitch change mechanism 58 configured to collectively vary the pitch of the fan blades 54, e.g., in unison. The fan blades 54, disk 56, and pitch change mechanism 58 are together rotatable about the longitudinal centerline 22 by the low-pressure shaft 48.

In an exemplary embodiment, as shown in FIG. 2, the gas turbine engine 20 further includes a power gearbox or gearbox 60. The gearbox 60 includes a plurality of gears for adjusting a rotational speed of the fan 52 relative to a rotational speed of the low-pressure shaft 48, such that the fan 52 and the low-pressure shaft 48 may rotate at more efficient relative speeds. The gearbox 60 may be any type of gearbox suitable to facilitate coupling the low-pressure shaft 48 to the fan 52 while allowing each of the low-pressure turbine 40 and the fan 52 to operate at a desired speed. For example, in some embodiments, the gearbox 60 may be a reduction gearbox. Utilizing a reduction gearbox may enable the comparatively higher speed operation of the low-pressure turbine 40 while maintaining fan speeds sufficient to provide for increased air bypass ratios, thereby allowing for efficient operation of the gas turbine engine 20. Moreover, utilizing a reduction gearbox may allow for a reduction in turbine stages that would otherwise be present (e.g., in direct drive engine configurations), thereby providing a reduction in weight and complexity of the engine.

Referring still to the exemplary embodiment of FIG. 2, the disk 56 is connected to the gearbox 60 via a fan shaft 62. The disk 56 is covered by a rotatable front hub 64 of the fan section 24 (sometimes also referred to as a “spinner”). The front hub 64 is aerodynamically contoured to promote an airflow through the plurality of fan blades 54. Additionally, the exemplary fan section 24 includes an annular fan casing or outer nacelle 66 that circumferentially surrounds the fan 52 and/or at least a portion of the turbomachine 26. The nacelle 66 is supported relative to the turbomachine 26 by a plurality of circumferentially spaced struts or outlet guide vanes 68 in the embodiment depicted. Moreover, a downstream section 70 of the nacelle 66 extends over an outer portion of the turbomachine 26 to define a bypass airflow passage 72 therebetween.

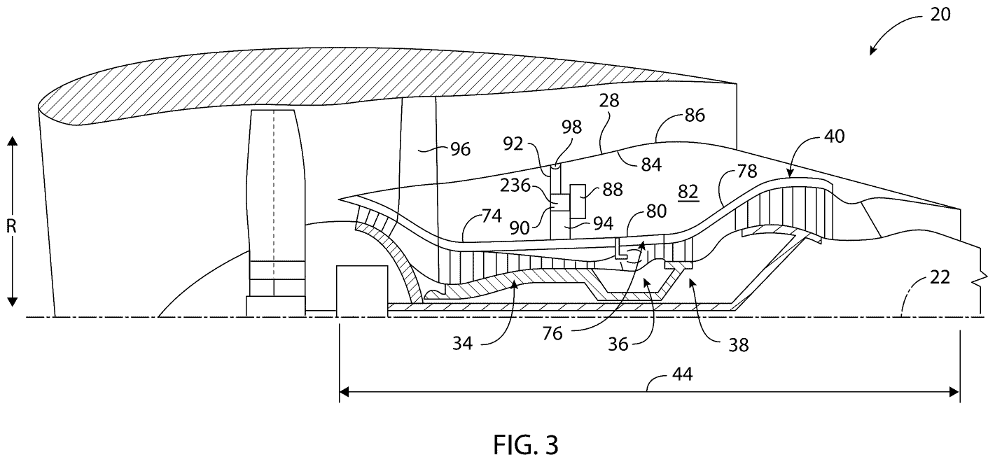

FIG. 3 is a schematic cross-sectional view of a portion of the core engine 44 of the gas turbine engine 20 as shown in FIG. 2, according to an exemplary embodiment of the present disclosure. As shown in FIG. 3, the high-pressure compressor 34 is encased within a compressor casing 74. The combustion section 36 is encased within a combustor casing 76. The high-pressure turbine 38 and the low-pressure turbine 40 are encased within one or more turbine casing(s) 78. The combustor casing 76 defines an outer surface 80. A void or space 82 is defined between an inner surface 84 of the core cowl 28 and the outer surface 80 of the combustor casing 76. The core cowl 28 further includes an outer surface 86 radially spaced from the inner surface 84 with respect to radial direction R. In exemplary embodiments, at least one engine component 88 is coupled to the core cowl 28 inner surface 84. The at least one engine component 88 may include but is not limited to valves, electronics including engine and system controllers, fire and overheat detection system components, fire extinguisher components, heat exchangers, pumps, generator, etc.

In exemplary embodiments, engine component 88 is selectively coupled to the core engine 44 or the core cowl 28. When the engine component 88 is coupled to the core cowl 28, the engine component 88 travels with the core cowl 28 when pivoted away from the core engine 44. When the engine component 88 is coupled to the core engine 44, the engine component 88 stays coupled to the core engine 44 when the core cowl 28 is pivoted away from the core engine 44. In exemplary embodiments and as previously presented, the engine component 88 is one of a heat exchanger, a sensor, a controller, a pump, a duct, a valve, fire and overheat detection system components, fire extinguisher components, or a generator. It should be appreciated that this list is not all inclusive of possible engine components that may be selectively coupled to the core cowl 28 or the core engine 44.

In exemplary embodiments, the engine component 88 is selectively coupled to the core engine 44 or the core cowl 28 via a fastener 90. As shown in FIG. 3, the fastener 90 may be disposed between a core cowl structure 92 such as a strut or bracket, and a core engine structure 94 such as a strut, a casing or bracket. The core cowl structure 92 may be fixedly coupled to the core cowl 28, such that the core cowl structure 92 moves with the core cowl 28, as described below. By contrast, the core engine structure 94 is not moveable with the core cowl 28 and instead may be fixedly coupled to a stationary and structural component of the core engine 44, such as the compressor casing 74 (as in the embodiment depicted), or one or more of the combustor casing 76, turbine casing 78, or a support frame such as a compressor frame 96, a mid-frame, or a rear support frame or turbine frame, etc.

The fastener 90 may be fixedly connected to the engine component 88. The fastener 90 may comprise a cam lock type fitting, bayonet fitting, quarter-turn fastener or other mechanical or electromechanical fastener or device that allows selectively coupling the engine component 88 to the core cowl 28 or the core engine 44. In particular embodiments, the core cowl 28 defines or includes an access opening or hatch 98 wherein the fastener 90 is accessible from the access opening 98.

It should be appreciated, however, that the exemplary gas turbine engine 20 depicted in FIGS. 2 and 3 is provided by way of example only, and that in other exemplary embodiments, the gas turbine engine 20 may have other configurations. For example, FIG. 4 is a schematic cross-sectional view of a gas turbine engine 100 according to another example embodiment of the present disclosure. Particularly, FIG. 4 provides a turbofan engine having a rotor assembly with a single stage of unducted rotor blades. In such a manner, the rotor assembly may be referred to herein as an “unducted fan,” or the entire engine 100 may be referred to as an “unducted turbofan engine.” In addition, the engine 100 of FIG. 4 includes a third stream extending from the compressor section to a rotor assembly flowpath over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

As shown in FIG. 4 the engine 100 includes a turbomachine 120 having a fan section 150 that is positioned upstream thereof. Generally, the turbomachine 120 includes, in serial flow order, a compressor section, a combustion section, a turbine section, and an exhaust section. Particularly, as shown in FIG. 4, the turbomachine 120 includes a housing or core cowl 122 that defines an annular core inlet 124. The core cowl 122 further encloses at least in part a low-pressure system and a high-pressure system. For example, the core cowl 122 depicted encloses and supports at least in part a booster or low-pressure (“LP”) compressor 126 for pressurizing the air that enters the turbomachine 120 through core inlet 124. A high-pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low-pressure” are used with respect to the high-pressure/high speed system and low-pressure/low speed system interchangeably. Further, it will be appreciated that the terms “high” and “low” are used in this same context to distinguish the two systems and are not meant to imply any absolute speed and/or pressure values.

The high energy combustion products flow from the combustor 130 downstream to a high-pressure turbine 132. The high-pressure turbine 132 drives the high-pressure compressor 128 through a high-pressure shaft 136. In this regard, the high-pressure turbine 132 is drivingly coupled with the high-pressure compressor 128. The high energy combustion products then flow to a low-pressure turbine 134. The low-pressure turbine 134 drives the low-pressure compressor 126 and components of the fan section 150 through a low-pressure shaft 138. In this regard, the low-pressure turbine 134 is drivingly coupled with the low-pressure compressor 126 and components of the fan section 150. The low-pressure shaft 138 is coaxial with the high-pressure shaft 136 in this example embodiment. After driving each of the high-pressure turbine 132 and the low-pressure turbine 134, the combustion products exit the turbomachine 120 through a rear support frame or turbomachine exhaust nozzle 140. A core engine 146 of the gas turbine engine 100 is defined as the part of the gas turbine engine 100 that extends from the fan section 150 to the rear support frame or turbomachine exhaust nozzle 140.

Accordingly, the turbomachine 120 defines a working gas flowpath or core duct 142 that extends between the core inlet 124 and the rear support frame or turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream. The fan section 150 includes a fan 152, which is the primary fan in this example embodiment. For the depicted embodiment of FIG. 4, the fan 152 is an open rotor or unducted fan 152. In such a manner, the engine 100 may be referred to as an open rotor engine. Moreover, it will be appreciated that the fan section 150 includes a single fan 152, and the fan 152 is the only unducted fan of the gas turbine engine 10 depicted.

As depicted, the fan 152 includes a plurality or an array of fan blades 154 (only one shown in FIG. 4). The fan blades 154 are rotatable, e.g., about the longitudinal axis 112. As noted above, the fan 152 is drivingly coupled with the low-pressure turbine 134 via the low-pressure shaft 138. For the embodiments shown in FIG. 1, the fan 152 is coupled with the low-pressure shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 4) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 4 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan housing or fan cowl 170.

As shown in FIG. 4, in addition to the fan 152, which is unducted, a ducted fan 184 is included aft of the fan 152, such that the engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low-pressure turbine 134 (e.g., coupled to the low-pressure shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 4) arranged in a single stage, such that the ducted fan 184 may be referred to as a single stage fan. The fan blades of the ducted fan 184 can be arranged in equal circumferential spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially extending and circumferentially spaced stationary struts 174 (only one shown in FIG. 4).

The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The exemplary engine 100 shown in FIG. 4 also defines or includes an inlet duct 180. The inlet duct 180 extends between the engine inlet 182 and the core inlet 124 and fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or the leading edge 144 of the core cowl 122. In the embodiment depicted, the inlet duct 180 is wider than the core duct 142 along the radial direction R. The inlet duct 180 is also wider than the fan duct 172 along the radial direction R.

Notably, for the embodiment depicted, the engine 100 includes one or more features to increase an efficiency of a third-stream thrust, Fn3S (e.g., a thrust generated by an airflow through the fan duct 172 exiting through the fan exhaust nozzle 178, generated at least in part by the ducted fan 184). In particular, the engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112.

Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third-stream thrust, Fn3S, during one or more engine operating conditions. Further, by introducing a variability in the geometry of the inlet guide vanes 186 and the fan exhaust nozzle 178, the engine 100 may be capable of generating more efficient third-stream thrust, Fn3S, across a relatively wide array of engine operating conditions, including takeoff and climb (where a maximum total engine thrust FnTotal, is generally needed) as well as cruise (where a lesser amount of total engine thrust, FnTotal, is generally needed).

Moreover, referring still to FIG. 4, in exemplary embodiments, air passing through the fan duct 172 may be relatively cooler (e.g., lower temperature) than one or more fluids utilized in the turbomachine 120. In this way, one or more heat exchangers 194 may be positioned in thermal communication with the fan duct 172. For example, one or more heat exchangers 194 may be disposed within the fan duct 172 and utilized to cool one or more fluids from the core engine 146 with the air passing through the fan duct 172, as a resource for removing heat from a fluid, e.g., compressor bleed air, oil or fuel.

Although not depicted in detail, the heat exchanger 194 may be an annular heat exchanger extending substantially 360 degrees in the fan duct 172 (e.g., at least 300 degrees, such as at least 330 degrees). In such a manner, the heat exchanger 194 may effectively utilize the air passing through the fan duct 172 to cool one or more systems of the engine 100 (e.g., lubrication oil systems, compressor bleed air, electrical components, etc.). The heat exchanger 194 uses the air passing through duct 172 as a heat sink and correspondingly increases the temperature of the air downstream of the heat exchanger 194 and exiting the fan exhaust nozzle 178.

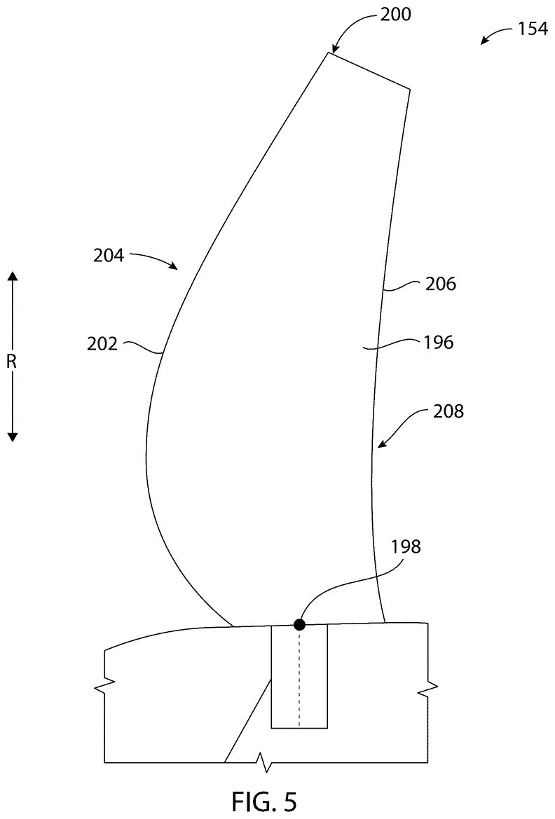

FIG. 5 is an enlarged view of an exemplary fan blade 154 of the plurality or array of fan blades 154 as shown in FIG. 4, according to exemplary embodiments of the present disclosure. As previously presented, each fan blade 154 has an airfoil or blade body 196. The blade body 196 spans in the radial direction R between a root 198 and a tip 200 of the blade body 196. The blade body 196 includes a leading edge 202 that extends along the span between the root 198 and the tip 200 along an upstream or forward portion 204 of the fan blade 154. The blade body 196 further includes a trailing edge 206 that extends along the span between the root 198 and the tip 200 along a downstream or aft portion 208 of the fan blade 154.

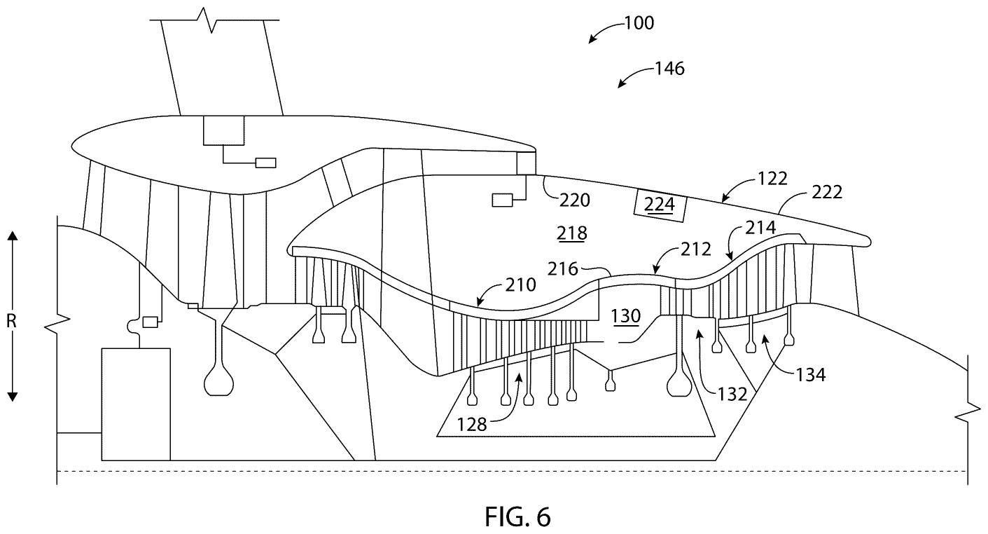

FIG. 6 is a schematic cross-sectional view of a portion of the core engine 146 of the gas turbine engine 100 as shown in FIG. 4, according to an exemplary embodiment of the present disclosure. As shown in FIG. 6, the high-pressure compressor 128 is encased within a compressor casing 210. The combustor 130 is encased within a combustor casing 212. The high-pressure turbine 132 and the low-pressure turbine 134 are encased within one or more turbine casing(s) 214. The combustor casing 212 defines an outer surface 216. A void or space 218 is defined between an inner surface 220 of the core cowl 122 and the outer surface 216 of the combustor casing 212. The core cowl 122 further includes an outer surface 222 radially spaced from the inner surface 220 with respect to radial direction R. In exemplary embodiments, at least one engine component 224 is attached to the core cowl 122 inner surface 220. The at least one engine component 224 may include but is not limited to valves, electronics including engine and system controllers, fire and overheat detection system components, fire extinguisher components, heat exchangers, pumps, generator, etc.

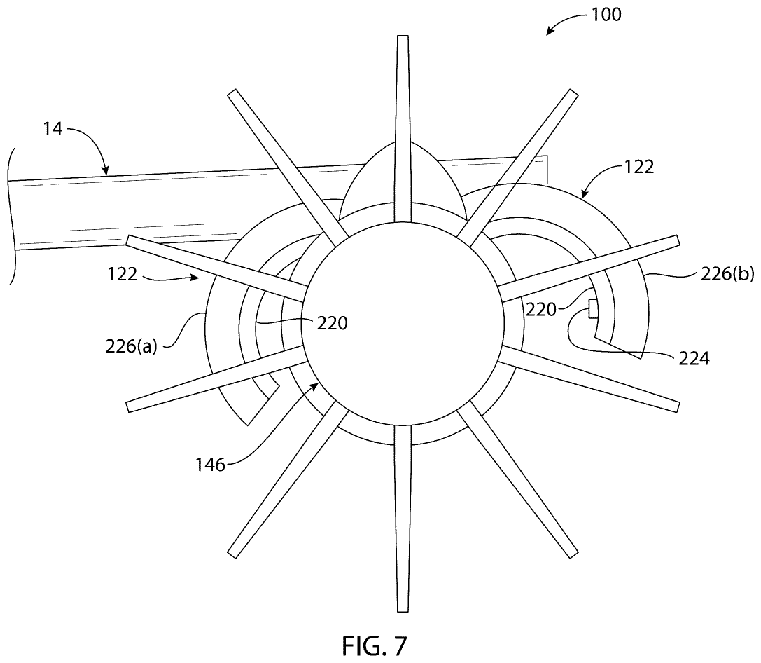

FIG. 7 is a front view of a portion of the gas turbine engine 100 as shown in FIGS. 4 and 6, mounted to a portion of an exemplary wing 14 according to exemplary embodiments of the present disclosure. It should be noted that fan section 150 (shown in FIG. 4) is not shown in FIG. 7 for clarity. As shown in FIG. 7, the core cowl 122 is formed from at least two shells 226(a), 226(b). It should be appreciated that the core cowl 122 shown in FIG. 7 may also be representative of the core cowl 28 shown in FIGS. 2 and 3. The shells 226(a), 226(b) are pivotally mounted to the gas turbine engine 100 to allow the shells 226(a), 226(b) to swing upward and away from the core engine 146, thereby exposing several engine accessories and systems of the core engine 146 such as engine component 224 or engine component 88 from FIG. 3, for inspection, repair, and maintenance. The shells 226(a), 226(b) are shown in FIG. 7 in an at least partially open state. When coupled to the inner surface 220 of the core cowl 122, the one or more engine accessories or engine systems will move with the core cowl 122 when the shells 226(a) and 226(b) are moved between open and closed positions.

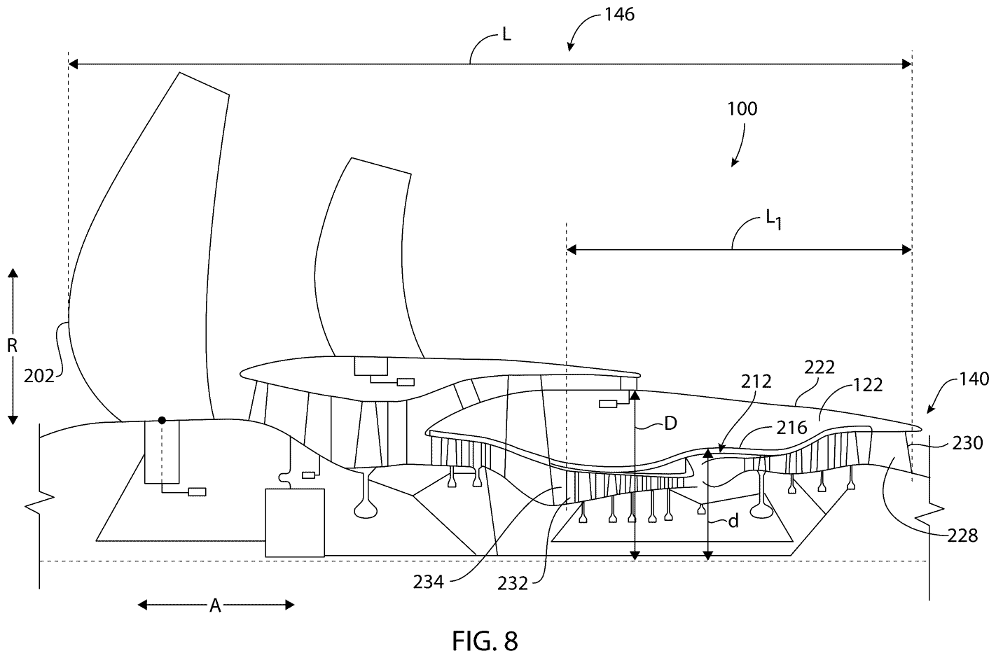

FIG. 8 is a schematic cross-sectional view of the gas turbine engine 100 as shown in FIG. 4, according to an exemplary embodiment of the present disclosure. As shown in FIG. 8 the outer surface 222 of the core cowl 122 defines a peak cowl diameter (D) in the radial direction R with respect to axial centerline 112. The outer surface 216 of the combustor casing 212 defines a maximum combustor casing diameter (d) along the radial direction R with respect to axial centerline 112. The core engine 146 defines an overall core axial length (L) along the axial direction A with respect to axial centerline 112. An under-core cowl axial length (L1) is defined along the axial direction A with respect to axial centerline 112.

In exemplary embodiments, as shown in FIG. 8, the turbomachine rear support frame or exhaust nozzle 140 includes a strut 228 having a trailing edge 230 within a working gas flowpath of the gas turbine engine 100. The overall core axial length (L) is measured from a forward-most portion of the leading edge 202 of a respective primary fan blade 154 to an aft-most portion of the trailing edge 230 of the strut 228. The gas turbine engine 100 further includes a high-pressure compressor inlet guide vane 232 having a leading edge 234 where the under-core cowl axial length (L1) along the axial direction is measured from the leading edge 234 of the high-pressure compressor inlet guide vane 232 to the trailing edge of the strut 228.

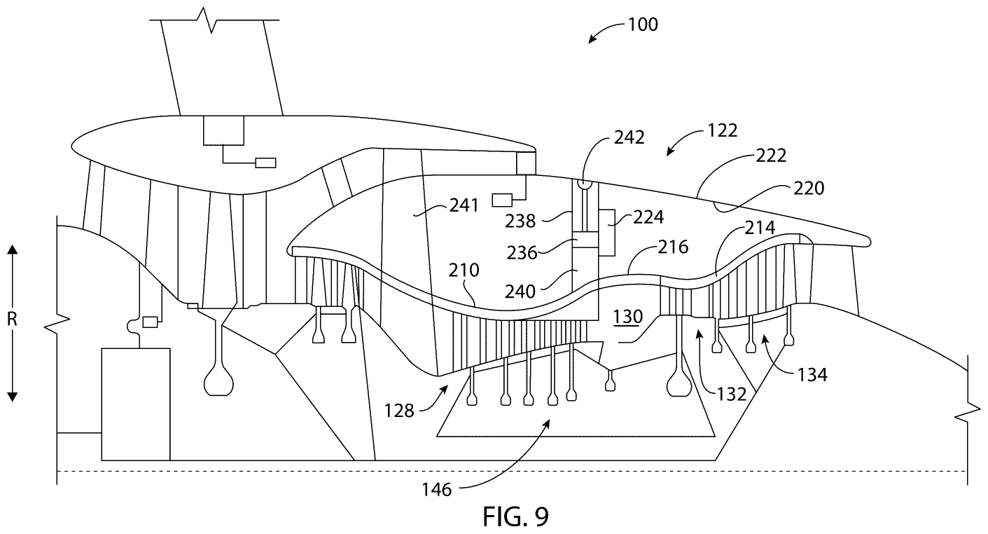

FIG. 9 is a schematic cross-sectional view of the gas turbine engine 100 as shown in FIG. 4, according to an exemplary embodiment of the present disclosure. In exemplary embodiments, engine component 224 is selectively coupled to the core engine 146 or the core cowl 122. When the engine component 224 is coupled to the core cowl 122, the engine component 224 travels with the core cowl 122 when pivoted away from the core engine 146. When the engine component 224 is coupled to the core engine 146, the engine component 224 stays coupled to the core engine 146 when the core cowl 122 is pivoted away from the core engine 146. In exemplary embodiments and as previously presented, the engine component 224 is one of a heat exchanger, a sensor, a controller, a pump, a duct, a valve, fire and overheat detection system components, fire extinguisher components, or a generator. It should be appreciated that this list is not all inclusive of possible engine components that may be selectively coupled to the core cowl 122 or the core engine 146.

In particular, it will be appreciated that in at least certain exemplary embodiments, the engine component 224 may be the controller, such as an engine controller, such as a full authority digital engine control (“FADEC”) controller. As will be appreciated, the gas turbine engine 100 depicted includes an unducted fan (see, e.g., unducted fan 152 in FIG. 4). In such a manner, the gas turbine engine 100 does not include a nacelle surrounding the fan (see, e.g., nacelle 66 surrounding fan 52 in FIG. 2). Without the nacelle, the engine controller may need to be located within the core cowl 122 of the gas turbine engine 100. As will further be appreciated, however, the environment within the core cowl 122 may be much hotter than within a nacelle, particularly closer to the turbomachinery components (e.g., the HP compressor, combustor, and HP turbine). Accordingly, positioning the engine controller outwardly along the radial direction R from the turbomachinery components and, e.g., selectively coupled to the core cowl 122 may reduce a temperature of the engine controller during operation of the gas turbine engine 100 to maintain a temperature of the engine controller below a maximum threshold for the electronics of the engine controller (e.g., below 200 degrees Fahrenheit), and allow for positioning of the engine controller within the core cowl 122. Briefly, a ratio of the peak cowl diameter (D) in the radial direction R and maximum combustor casing diameter (d) along the radial direction R may further facilitate such a positioning of the engine controller.

It should be appreciated, however, that in other embodiments, the engine component 224 may additionally or alternatively be any other suitable component traditionally found within a nacelle of a ducted gas turbine engine, such as a lubrication oil tank, a lubrication oil pump, power electronics (e.g., inverters), electric machines, etc. Moreover, although the engine controller is described as being positioned within the core cowl 122 above, in other embodiments, the engine controller and/or one or more other suitable components traditionally found within a nacelle of a ducted gas turbine engine may be positioned within a pylon used to mount the gas turbine engine to an aircraft (such as to a wing or fuselage of the aircraft).

In exemplary embodiments, the engine component 224 is selectively coupled to the core engine 146 or the core cowl 122 via a fastener 236. As shown in FIG. 9, the fastener 236 may be disposed between a core cowl structure 238 such as a strut or bracket, and a core engine structure 240 such as a strut, a casing or bracket. The core cowl structure 238 may be fixedly coupled to the core cowl 122, such that the core cowl structure 238 moves with the core cowl 122, as described below. By contrast, the core engine structure 240 is not moveable with the core cowl 122 and instead may be fixedly coupled to a stationary and structural component of the core engine 146, such as the compressor casing 210 (as in the embodiment depicted), or one or more of the combustor casing 212, turbine casing 214, or a support frame such as a compressor frame 241, a mid-frame, or rear support frame (not shown) or turbomachine exhaust nozzle 140 (FIG. 2), etc.

The fastener 236 may be fixedly connected to the engine component 224. The fastener 236 may comprise a cam lock type fitting, bayonet fitting, quarter-turn fastener or other mechanical or electromechanical fastener or device that allows selectively coupling the engine component 224 to the core cowl 122 or the core engine 146. In particular embodiments, the core cowl 122 defines or includes an access opening or hatch 242 wherein the fastener 236 is accessible from the access opening 242.

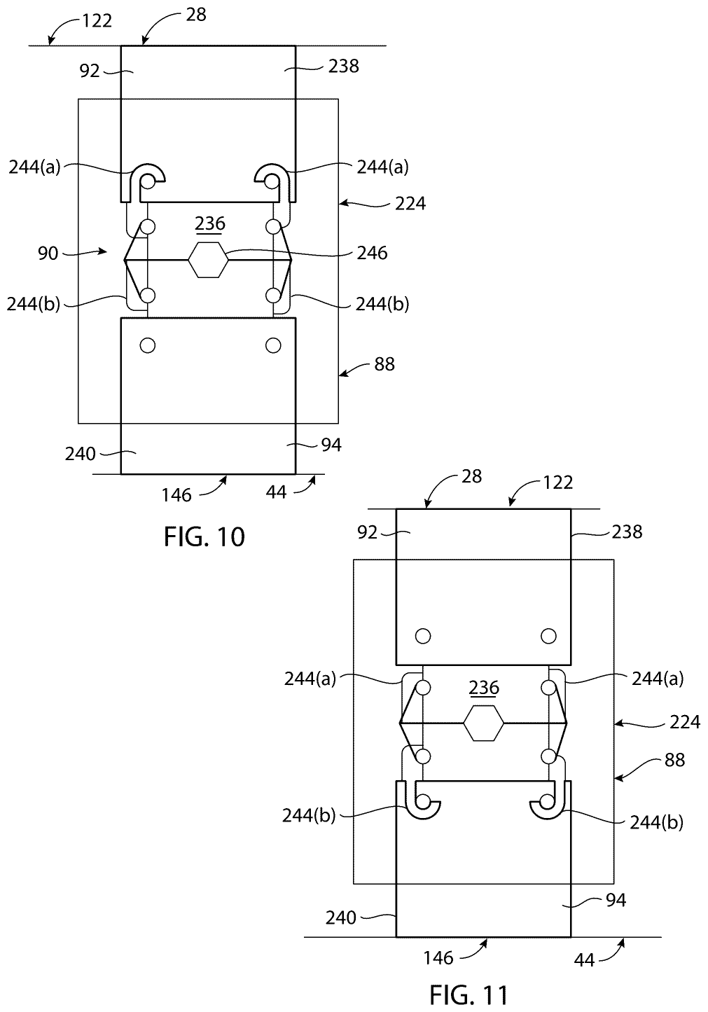

FIGS. 10 and 11 are schematic illustrations including engine component 224 or engine component 88, a portion of core cowl structure 238 or core cowl structure 92, an exemplary fastener 236 or fastener 90, and a portion of the core engine structure 240 or core engine structure 94 according to the present disclosure. In at least one embodiment, as shown in FIG. 10, the fastener 236, 90 includes a first plurality of articulating tabs 244(a) and a second plurality of articulating tabs 244(b). The tabs 244(a), 244(b) may be articulated about a pivot point 246 via a key or tool (not shown). The key or tool may inserted through the access opening 242, 98 shown in FIGS. 9 and 3.

In an exemplary embodiment, as show in FIG. 10, when in a first position the first plurality of tabs 244(a) engages with the core cowl structure 238, 92 and the second plurality of tabs 244(b) disengage from the core engine structure 240, 94, thereby coupling the engine component 224, 88 to the core cowl 122, 28 and decoupling the engine component 224, 88 from the core engine 146, 44. In this configuration, the engine component 224, 88 will travel with the core cowl 122, 28 when it is opened and rotated outward from the core engine 146, 44. In addition, in this configuration, the core cowl 122, 28 may carry the weight load of the engine component 224, 88 during operation of the gas turbine engine 100.

As shown in FIG. 11, when in a second position the first plurality of tabs 244(a) are disengaged from the core cowl structure 238, 92 and the second plurality of tabs 244(b) are engaged with the core engine structure 240, 94 thereby coupling the engine component 224, 88 to the core engine 146, 44, and decoupling the engine component 224, 88 from the core cowl 122, 28. In this configuration, the engine component 224, 88 will be rigidly coupled to the core engine 146, 44 whether the core cowl 122, 28 is opened or closed.

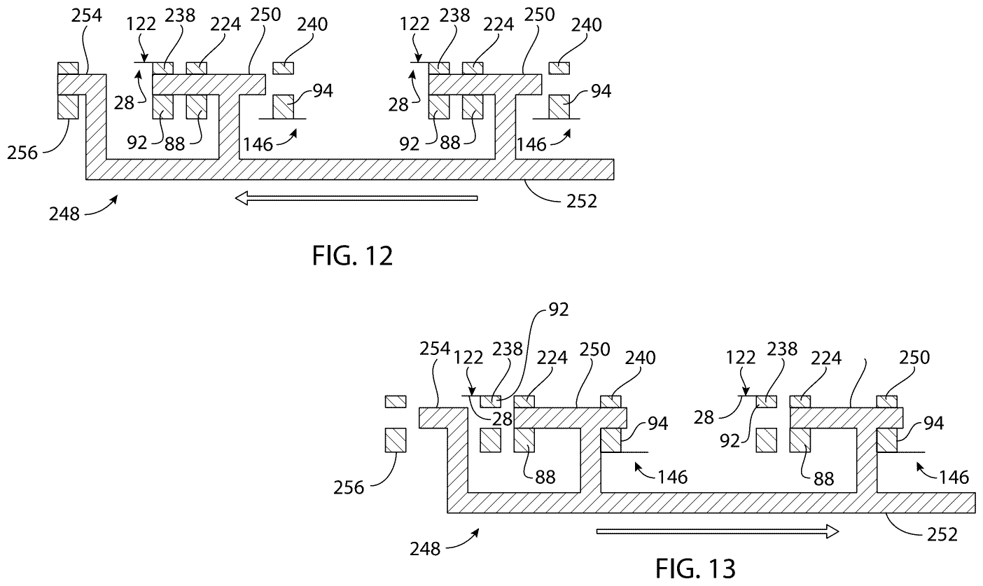

FIGS. 12 and 13 are schematic illustrations including engine component 224, 88, a portion of core cowl structure 238, 92, a push-pull mechanism 248, and a portion of the core engine structure 240, 94 according to exemplary embodiments of the present disclosure. In various embodiments, as shown in FIGS. 12 and 13, the engine component 224, 88 is selectively coupled to the core cowl 122, 28 (FIG. 12) or the core engine 146 (FIG. 13) via push-pull mechanism 248. The push-pull mechanism 248 includes at least one protrusion or pin 250 fixed to a slidable rod 252. In a first position, as shown in FIG. 12, the pin(s) 250 engage(s) with the engine component 224, 88 and the core cowl 122, 28 via the core cowl structure 238, 92 and are disengaged from the core engine 146. In a second position, as shown in FIG. 13, the pin(s) 250 engage(s) with the with the engine component 224, 88 and the core engine 146, 44 via the core engine structure 240, 94 and are disengaged or decoupled from the core cowl 122, 28. In exemplary embodiments, the slidable rod 252 may be manipulated between the first position and the second position by a technician manually. In other embodiments, the slidable rod 252 may be manipulated between the first position and the second position hydraulically or electrically. The slidable rod 252 will be movable while the core cowl 122, 28 is in a closed or at least partially closed state.

In exemplary embodiments as shown in FIGS. 12 and 13, the push-pull mechanism includes a second pin 254. As shown in FIG. 12 the second pin 254 engages with a door counterbalance mechanism or system 256 when the first pin(s) 250 is/are engaged with the core cowl 122, 28 and the engine component 224, 88. In exemplary embodiments, the door counterbalance mechanism 256 includes either a spring, or pressurized gas strut to counterbalance the weight of the core cowl 122, 28 as it is manipulated between open and closed states.

As alluded to earlier, the inventors discovered, unexpectedly during the course of gas turbine engine design—i.e., designing gas turbine engines having a variety of different primary fan and secondary fan characteristics—and evaluating an overall propulsive efficiency, significant relationships exist in a ratio of a core cowl diameter ratio (CDR), equal to the peak cowl diameter (D) divided by the maximum combustor casing diameter (d), and a core cowl length ratio (CLR), equal to the under-core cowl axial length (L1) divided by the overall core axial length (L). These relationships can be thought of as an indicator of the ability of a gas turbine engine to provide sufficient packaging space between the core engine combustor casing and the core cowl for packaging/mounting various accessories and/or engine systems, while also having a core engine capable of producing sufficient power to drive primary and secondary fans, particularly in more complex engine designs.

As engines become more complex (e.g., hybrid electric/load sharing between shafts, closed-loop thermal management systems, hot fuel, unducted, etc.), a reduction in core cowl size is concomitantly desired for greater overall engine performance. This, along with, in the case of an open rotor design (FIG. 4), the elimination of an outer nacelle enclosing a primary fan of the engine, has posed a significant challenge with engine accessory and engine support system packaging design that was not previously present in earlier engine designs. It will also be appreciated that a reduction in overall core engine axial length results in a reduction in space for packaging various engine accessories and support system components which are typically coupled to the outer nacelle, the core engine casings, or to various support frames of the gas turbine engine, generally beneath the core cowl.

It will be appreciated that a larger core cowl diameter is preferred to accommodate the packaging needs of a particular gas turbine engine design. However, if the core cowl diameter is too large various issues such as excess drag and weight may affect overall engine performance or propulsion efficiency. In addition, or in the alternative, if the core cowl is too large for a particular gas turbine engine design, issues with mounting and installing the engine occur. It will also be appreciated that a smaller core length for a given engine design provides various benefits, including but not limited to, reduced overall engine weight. This particular design is enabled at least in part by the three-stream engine design described above which provides less flow through the engine core for a given thrust output. However, it is to be appreciated that the engine length cannot be too small because of the power required to drive primary and mid-fans of the three-stream engine.

It will moreover be appreciated that elements that previously were previously mounted to nacelle and that are temperature sensitive, i.e., electronics, FADEC, have more limited/restricted areas where they can reside within the engine. For example, it was found that for the 3-stream engine embodiment that the FADEC is preferably located in the space located between third stream and outer nacelle, or forward of the compressor.

It will moreover be appreciated that inventors considered placement alternatively within the aircraft pylon supporting the engine (not shown in drawings). The discovery, below (Expression (1) and (2)) may be equally insightful and define the packaging size in those cases where some of the engine components normally housed in nacelle are moved to pylon, and where those components are located within the core cowl.

Notably, however, an engine having a core cowl diameter ratio (CDR) within the ranges described herein, particularly when also having a core engine length ratio (CLR) within the ranges described herein, may be particularly suited for mounting one or more of the components traditionally found within a nacelle of a ducted gas turbine engine within the core cowl of the gas turbine engine. For example, an engine having a core cowl diameter ratio (CDR) within the ranges described herein, particularly when also having a core engine length ratio (CLR) within the ranges described herein, may have a sufficient amount of room for these components, and further may have a sufficient amount of separation from hot turbomachinery during operation to allow positioning of one or more of these components within the core cowl, for example, power electronics and a Full Authority Digital Engine Control (FADEC), temperature-sensitive sensors, power cables.

As noted above, the inventors of the present disclosure discovered bounding the relationships defined by the core cowl diameter ratio (CDR) to the core engine length ratio (CLR) can result in a gas turbine engine maintaining or even improving upon a desired propulsive efficiency, while also taking into account the gas turbine engine's packaging concerns, weight concerns, and power requirements. The relationship discovered, infra, can identify an improved engine configuration suited for a particular mission requirement, one that takes into account installation, packaging and loading, power requirements, and other factors influencing the optimal choice for an engine configuration.

In addition to yielding an improved gas turbine engine, as explained in detail above, utilizing this relationship, the inventors found that the number of suitable or feasible gas turbine engine designs incorporating a primary fan and a secondary fan, and defining a third stream, capable of meeting both the propulsive efficiency requirements and packaging, weight could be greatly diminished, thereby facilitating a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

The desired relationships providing for the improved gas turbine engine, discovered by the inventors, are expressed as:

$$CDR = D / d \qquad ( 1 )$$

$$CLR = L 1 / L \qquad ( 2 )$$

where CDR is maximum core cowl diameter D to maximum combustor casing diameter ratio d, and CLR is under-core cowl axial length L1 divided by overall core axial length L.

Values for various parameters of the influencing characteristics of an engine defined by Expressions (1) and (2) are set forth below in TABLE 1:

TABLE 1

| | | Ranges appropriate for using |
|---|---|---|
| Symbol | Description | Expression (1) |
| D/d | Core Cowl | 2.7 to 3.5, such as 2.8 to 3.3, |
| | Diameter | such as 2.9 to 3.1 |
| | Ratio (CDR) | |
| L1/L | Core Cowl | 0.25 to 0.50, such as 0.3 to |
| | Length | 0.45, such as 0.35 to 0.45, |
| | Ratio (CLR) | such as .40 to .45 |

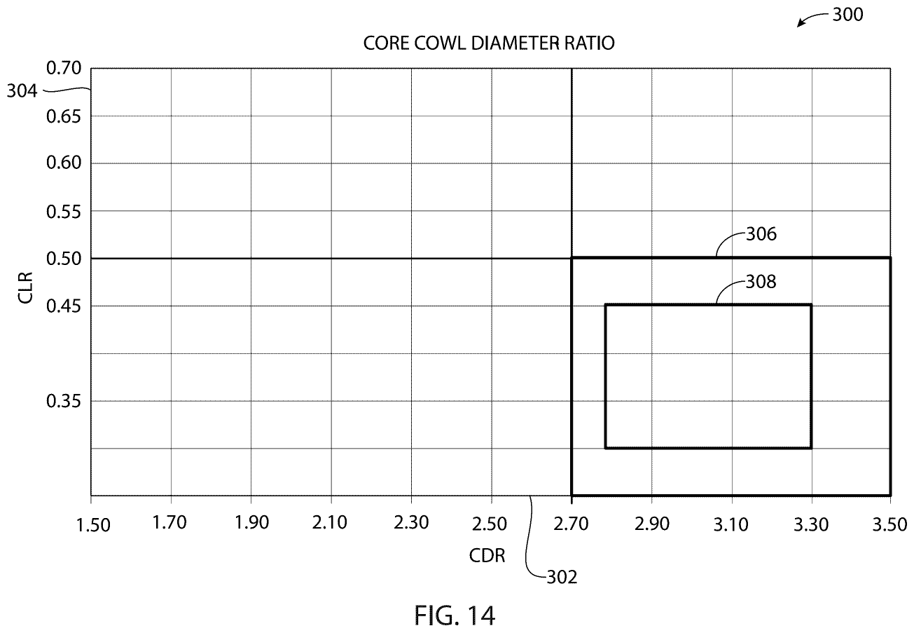

FIG. 14 is a plot 300 illustrating the relationship between CDR and CLR and showing the relationships between the various parameters of Expressions (1) and (2). The plot 300 includes CDR values on an X-axis 302 and CLR values on a Y-axis 304. The plot 300 depicts an area 306 of CDR and CLR values where a gas turbine engine would provide sufficient packaging space between a core engine combustor casing and a core cowl for packaging/mounting various accessories and/or engine systems, while also having a core engine capable of producing sufficient power to drive primary and secondary fans. The plot 300 further depicts an area 308 of CDR and CLR values where a gas turbine engine may provide more desired packaging space between the core engine combustor casing and the core cowl for packaging/mounting various accessories and/or engine systems, while also having the core engine capable of producing sufficient power to drive primary and secondary fans. The exemplary gas turbine engine of FIG. 4 defines a CDR and a CLR within the area 308.

It will be appreciated that although the discussion above is generally relating to the open rotor engine 100 described above with reference to, e.g., FIG. 8, in various embodiments of the present disclosure, the relationships outlined above with respect to, e.g., Expressions (1) and (2) may be applied to any other suitable engine architecture.

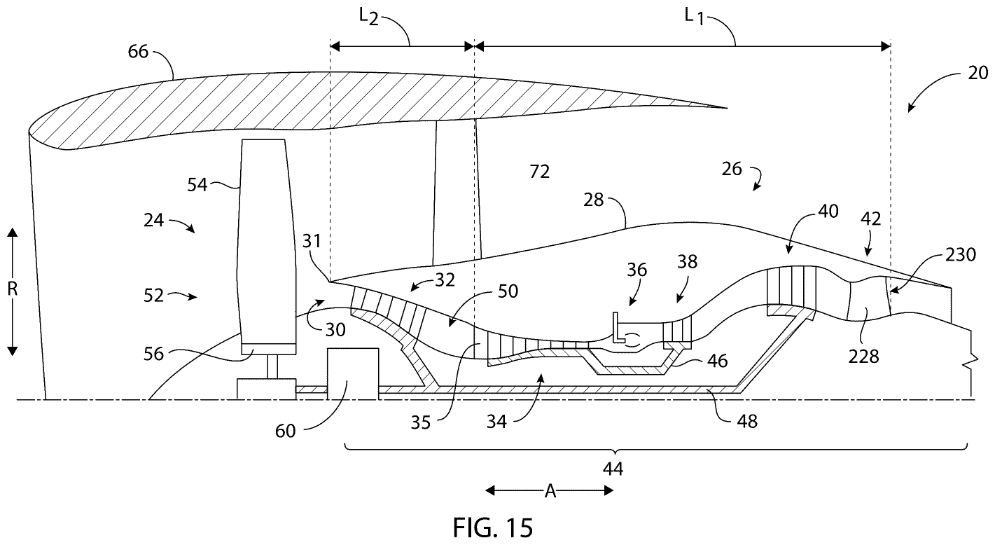

Referring now to FIG. 15, a gas turbine engine 20 in accordance with another exemplary aspect of the present disclosure is provided. The exemplary gas turbine engine of FIG. 15 is configured in a similar manner as the exemplary gas turbine engine 20 described above with reference to FIGS. 2 and 3. Accordingly, the exemplary gas turbine engine 20 of FIG. 15 is configured as a ducted gas turbine engine (i.e., includes a fan 52 with a nacelle 66 enclosing the fan 52). The same or similar numbers may refer to the same or similar parts.

For example, the gas turbine engine 20 generally includes a includes a fan section 24 and a turbomachine 26 disposed downstream from the fan section 24. The exemplary turbomachine 26 depicted generally includes an engine casing or core cowl 28 that defines an annular core inlet 30. The core cowl 28 at least partially encases, in serial flow relationship, a compressor section including a booster or low-pressure compressor 32 and a high-pressure compressor 34, a combustion section 36, a turbine section including a high-pressure turbine 38 and a low-pressure turbine 40, and at least a portion of a jet exhaust nozzle 42. Together, these components or sections make up a core engine 44 of the turbomachine 26.

A high-pressure shaft 46 drivingly connects the high-pressure turbine 38 to the high-pressure compressor 34. A low-pressure shaft 48 drivingly connects the low-pressure turbine 40 to the low-pressure compressor 32. The compressor section, combustion section 36, turbine section, and jet exhaust nozzle 42 together define a working gas flow path 50 through the gas turbine engine 20.

For the embodiment depicted, the fan section 24 includes a fan 52 having a plurality of fan blades 54 coupled to a disk 56 in a spaced apart manner. As depicted, the fan blades 54 extend outwardly from disk 56 generally along the radial direction R. The fan blades 54 are rotatable about the longitudinal centerline 22 by the low-pressure shaft 48.

In an exemplary embodiment, as shown in FIG. 15, the gas turbine engine 20 further includes a gearbox 60. The gearbox 60 includes a plurality of gears for adjusting a rotational speed of the fan 52 relative to a rotational speed of the low-pressure shaft 48, such that the fan 52 and the low-pressure shaft 48 may rotate at more efficient relative speeds. The gearbox 60 may be any type of gearbox suitable to facilitate coupling the low-pressure shaft 48 to the fan 52 while allowing each of the low-pressure turbine 40 and the fan 52 to operate at a desired speed. For example, in some embodiments, the gearbox 60 may be a reduction gearbox.

More specifically, in some embodiments, the gearbox 60 may define a gear ratio of the input rotational speed (e.g., the low-pressure shaft 48) to the output rotational speed greater than 3 and less than 14. For example, in certain exemplary embodiments, the gearbox 60 may define a gear ratio greater than 4, such as greater than 5, such as greater than 6 and less than 12, such as less than 11. Inclusion of the gearbox 60 with a relatively high gear ratio may allow for a relatively high diameter fan 52 in combination with a relatively high speed low-pressure turbine 40.

As will also be appreciated, the gas turbine engine 20 defines an under-core cowl axial length (L1) along an axial direction A. More specifically, the gas turbine engine 20 includes a high-pressure compressor inlet guide vane 35 having a leading edge (not labeled), where the under-core cowl axial length (L1) is measured along the axial direction A from the leading edge of the high-pressure compressor inlet guide vane 35 to a trailing edge 230 of a strut 228 extending through the exhaust nozzle 42 (which may be a strut of a turbine rear frame). The under-core cowl axial length (L1) is therefore generally a measure along the axial direction A from the high-pressure compressor 34 to the exhaust of the gas turbine engine 20.

Further, the gas turbine engine 20 defines an initial compression axial length (L2) along the axial direction A. The initial compression axial length (L2) is measured along the axial direction A from a splitter 31 positioned at the inlet 30 of the turbomachine 26 to the leading edge of the high-pressure compressor inlet guide vane 35. In the embodiment depicted, the low-pressure compressor 32 is located downstream of the splitter 31 and upstream of the leading edge of the high-pressure compressor inlet guide vane 35 (and is the only compressor within this axial location).

It will be appreciated, however, that in other exemplary embodiments, the compressor section may have one or more intermediate stages of compression (e.g., an intermediate-pressure compressor in addition to the low-pressure compressor 32).

Further, it will be appreciated that the exemplary gas turbine engine 20 depicted in FIG. 15 may be configured as a narrow-body engine (i.e., an engine configured to provide thrust to a narrow-body aircraft). In such a manner, the gas turbine engine 20 may be configured to generate at least 18,000 pounds of thrust and less than 80,000 pounds of thrust during operation at a rated speed during standard day operating conditions, such as between 25,000 and 60,000 pounds of thrust during operation at a rated speed during standard day operating conditions, such as between 25,000 and 50,000 pounds of thrust during operation at a rated speed during standard day operating conditions.

It will be appreciated that although the description of the under-core cowl axial length (L1) and the initial compression axial length (L2) is described above with reference to the gas turbine engine 20 of FIG. 15 (which includes a speed reduction device, i.e., reduction gearbox 60, for transmitting shaft power to the main or primary fan, a nacelle 66 enclosing fan 52; and is a two stream engine, i.e., includes a bypass airflow passage 72 and a working gas flowpath 50, but not a third stream), in other embodiments, aspects of the present disclosure may be applied to other suitable gas turbine engines. For example, in other embodiments, the aspects described herein with respect to the under-core cowl axial length (L1) and the initial compression axial length (L2) (and the ICLR, as defined below), may apply to an unducted gas turbine engine (i.e., does not include a nacelle surrounding the primary fan; see, e.g., FIG. 4), a three stream gas turbine engine (i.e., includes a third stream; see, e.g., FIG. 4), etc. Notably, when applied to a three stream gas turbine engine, the initial compression axial length (L2) may be defined from a splitter at an upstream-most inlet to a ducted portion of the engine, downstream of the primary fan (e.g., the splitter at the engine inlet 182 in FIG. 4) to the leading edge of the high-pressure compressor inlet guide vane 35.

As will be appreciated from the description herein, the inventors further discovered, unexpectedly, during the course of designing high bypass gas turbine engines (i.e., bypass ratio above 12) having a variety of turbomachine characteristics, a significant relationship exist in a ratio of the initial compression axial length (L2) to the under-core cowl axial length (L1). This ratio, referred to herein as an initial compression length ratio (ICLR), reflects a space available for packaging, including the portion of the undercowl space available for locating more temperature-sensitive components for engines, and accounting for the less space available because the fan duct size and space typically chosen for storing accessories and power or communications equipment is limited or no longer available (as bypass ratio increases, the weight and drag associated with the fan duct correspondingly increases in size so as to becomes too prohibitive unless the fan duct storage volume is reduced in size, thereby mitigating the drag and weight associated with the higher bypass area).

In some embodiments, when combined with the CDR, it was unexpectedly found that an undercowl space was discovered that best balanced the need for accommodating a high-pressure compressor having 9, 10 or 11 stages; or a high-pressure compressor having less than 8 stages combined with a low-pressure compressor (or booster) having 4, 5 or 6 stages, while meeting a need for reducing a drag profile or skin friction of the engine casing as much as possible. In other embodiments, it was unexpectedly found that an undercowl space was discovered that best balanced the need for accommodating a low-pressure turbine having 4, 5 or 6 stages while balancing the need for reducing a drag profile or skin friction of the engine casing as much as possible. Importantly, in each of these examples the CDR and ICLR values also account for the packaging needed in the casing for components that may no longer be stored in the fan nacelle or when the fan nacelle is no longer present (e.g., as discussed earlier in connection with the open fan).

Compared to more traditional turbofan engines that have a relatively low diameter fan that rotate relatively quickly as a result of being driven directly from a low-pressure turbine of the turbofan engine (i.e., without a reduction gearbox), the inventors have found that by using a higher diameter fan driven through a reduction gearbox, the under-core cowl length (L1) may be reduced. In particular, such allows the primary fan to rotate at a lower angular rate relative to the low-pressure turbine, which efficiency can increase by rotating at a higher rate while maintaining a desired tip speed of the fan. Higher speeds of the low-pressure turbine may allow for less stages while extracting the same (or greater) amount of power. The lower speeds of the fan may allow for the fan to increase in diameter, which leads to a higher bypass ratio and lowered specific fuel consumption.

However, reduction of L1 may impose additional stress on high-pressure components (e.g., the high-pressure compressor and a high-pressure turbine). In particular, increases in initial compression length ratio (ICLR) may generally require the overall compressor ratio to be increased, which generally results in higher temperatures and pressures at an exit of the high-pressure compressor and at an inlet to the high-pressure turbine. Accordingly, increasing the initial compression length ratio (ICLR) too much may create an undesirable amount of stress (and premature wear) on the gas turbine engine.

In addition to yielding an improved turbofan engine, as explained in detail above, utilizing this relationship, the inventors found that the number of suitable or feasible turbofan engine designs capable of meeting both the propulsive efficiency requirements and limited stress and wear requirements could be greatly diminished, thereby facilitating a more rapid down selection of designs to consider as a turbofan engine is being developed. Such a benefit provides more insight to the requirements for a given turbofan engine well before specific technologies, integration and system requirements are developed fully. Such a benefit avoids late-stage redesign.

The desired relationships providing for the improved turbofan engine, discovered by the inventors, are expressed as:

$$ICLR = L 2 / L 1 \qquad ( 3 )$$

where ICLR is a ratio of the initial compression axial length (L2) to the under-core cowl axial length (L1).

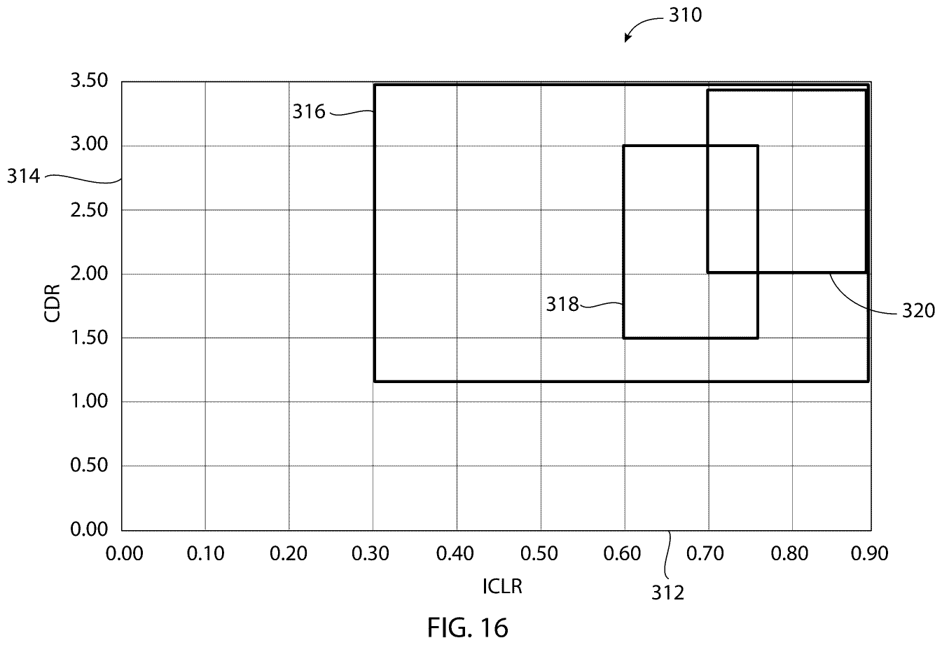

FIG. 16 is a plot 310 illustrating ICLR values, and more specifically, illustrating ICLR values along an X-axis 312 and CDR (Core Cowl Diameter Ratio) along the Y-axis 314. The plot 310 depicts an area 316 of ICLR values of a gas turbine engine in accordance with one or more aspects of the present disclosure where the gas turbine engine would provide desirable propulsive efficiency without overly stressing and wearing the gas turbine engine. The area 316 reflects ICLR values greater than or equal to 0.3 and less than or equal to 0.9, with CDR values greater than or equal to 1.24 and less than or equal to 3.5.

Referring still to the plot 310 of FIG. 16, the plot 310 further defines an area 318 of ICLR values of a gas turbine engine in accordance with one or more additional aspects of the present disclosure. The area 318 reflects ICLR values greater than or equal to 0.60 and less than or equal to 0.75, with CDR values greater than or equal to 1.5 and less than or equal to 3.0. The gas turbine engines of the present disclosure falling within the area 318 may be two stream turbofan engines (i.e., turbofan engines without a third stream), ducted turbofan engines, or both. As will be appreciated, two stream turbofan engines may not require as large of an initial compression axial length L2, and similarly ducted turbofan engines may be limited in maximum fan diameter (which as will be appreciated from the discussion above may similarly limit the ICLR). The exemplary gas turbine engine of FIG. 15 defines an ICLR and CDR within the area 318.

Referring still to the plot 310 of FIG. 16, the plot 310 further defines an area 320 of ICLR values of a gas turbine engine in accordance with one or more further aspects of the present disclosure. The area 320 reflects ICLR values greater than or equal to 0.70 and less than or equal to 0.89, with CDR values greater than or equal to 2.0 and less than or equal to 3.4. The gas turbine engines of the present disclosure falling within the area 320 may be three stream turbofan engines (i.e., turbofan engines including a third stream, such as the turbofan engines of FIGS. 4, 6, 8 and 9 having fan ducts 172), unducted turbofan engines, or both. As will be appreciated, three stream turbofan engines may include a larger initial compression axial length L2 (e.g., by virtue of the mid-fan), and similarly unducted turbofan engines may include a fan with a larger fan diameter (which as will be appreciated from the discussion above may allow for an increase in the ICLR). The exemplary gas turbine engine of FIG. 4 defines an ICLR and CDR within the area 320.

Notably, the above areas 316, 318, 320 may more specifically be directed to narrow-body engines. In such a manner, the gas turbine engines within these ranges may be configured to generate at least 18,000 pounds of thrust and less than 80,000 pounds of thrust during operation at a rated speed during standard day operating conditions, such as between 25,000 and 60,000 pounds of thrust during operation at a rated speed during standard day operating conditions, such as between 25,000 and 50,000 pounds of thrust during operation at a rated speed during standard day operating conditions. As will be appreciated, as an engine extends outside of this thrust class, a relationship of fan diameter, fan speed, high-pressure compressor size, and/or low-pressure turbine size may interact differently, such that the areas of ICLR values may not as readily capture desired gas turbine engines.

Another example of an unducted turbofan engine can be found in U.S. patent application Ser. No. 16/811,368 (Published as U.S. Patent Application Publication No. 2021/0108597), filed Mar. 6, 2020 (FIG. 10, Paragraph [0062], et al.; including an annular fan case 13 surrounding the airfoil blades 21 of rotating element 20 and surrounding vanes 31 of stationary element 30; and including a third stream/fan duct 73 (shown in FIG. 10, described extensively throughout the application)). Various additional aspects of one or more of these embodiments are discussed below. These exemplary aspects may be combined with one or more of the exemplary gas turbine engine(s) discussed above with respect to the figures.

For example, in some embodiments of the present disclosure, the engine may include a heat exchanger located in an annular duct, such as in a third stream. The heat exchanger may extend substantially continuously in a circumferential direction of the gas turbine engine (e.g., at least 300 degrees, such as at least 330 degrees).

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

As such, it will be appreciated that an engine of such a configuration may be configured to generate at least 25,000 pounds and less than 80,000 of thrust during operation at a rated speed, such as between 25,000 and 50,000 pounds of thrust during operation at a rated speed, such as between 25,000 and 40,000 pounds of thrust during operation at a rated speed. Alternatively, in other exemplary aspects, an engine of the present disclosure may be configured to generate much less power, such as at least 2,000 pounds of thrust during operation at a rated speed.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter. In certain suitable embodiments, the fan includes at least eight (8) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades.

Further, in certain exemplary embodiments, the rotor assembly may define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R1/R2 may be between 1 and 10, or 2 and 7, or at least 3.3, at least 3.5, at least 4 and less than or equal to 7, where R1 is the radius of the primary fan and R2 is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps. A fan pressure ratio (FPR) for the primary fan of the fan assembly can be 1.04 to 2.20, or in some embodiments 1.05 to 1.2, or in some embodiments less than 1.08, as measured across the fan blades of the primary fan at a cruise flight condition.

In order for the gas turbine engine to operate with a fan having the above characteristics to define the above FPR, a gear assembly may be provided to reduce a rotational speed of the fan assembly relative to a driving shaft (such as a low-pressure shaft coupled to a low-pressure turbine). In some embodiments, a gear ratio of the input rotational speed to the output rotational speed is between 3.0 and 4.0, between 3.2 and 3.5, or between 3.5 and 4.5 (inclusive of the endpoints). In some embodiments, a gear ratio of the input rotational speed to the output rotational speed is greater than 4.1. For example, in particular embodiments, the gear ratio is within a range of 4.1 to 14.0, within a range of 4.5 to 14.0, or within a range of 6.0 to 14.0. In certain embodiments, the gear ratio is within a range of 4.5 to 12 or within a range of 6.0 to 11.0.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low-pressure compressor may include 1 to 8 stages, a high-pressure compressor may include 4 to 15 stages, a high-pressure turbine may include 1 to 2 stages, and/or a low-pressure turbine (LPT) may include 1 to 7 stages. In particular, the LPT may have 4 stages, or between 4 and 7 stages. For example, in certain embodiments, an engine may include a one stage low-pressure compressor, an 11-stage high-pressure compressor, a two-stage high-pressure turbine, and 4 stages, or between 4 and 7 stages for the LPT. As another example, an engine can include a three-stage low-pressure compressor, a 10-stage high-pressure compressor, a two stage high-pressure turbine, and a 7 stage low-pressure turbine.

The reduced installed drag may further provide for improved efficiency, such as improved specific fuel consumption. Additionally, or alternatively, the reduced installed drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Additionally, it should be appreciated that ranges of power loading and/or rotor blade tip speed may correspond to certain structures, core sizes, thrust outputs, etc., or other structures of the core engine. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art. Although depicted above as an unshrouded or open rotor engine in the embodiments depicted above, it should be appreciated that aspects of the disclosure provided herein may be applied to shrouded or ducted engines, partially ducted engines, aft-fan engines, or other gas turbine engine configurations, including those for marine, industrial, or aero-propulsion systems. Certain aspects of the disclosure may be applicable to turbofan, turboprop, or turboshaft engines. However, it should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (D) of the engine, L/D of the engine, desired cruise altitude, and/or desired operating cruise speed, or combinations thereof.

Also provided herein are systems for mounting or fastening components and accessories located in the core cowl or fan cowl of the engine. It has been determined that a smaller overall axial length of the engine core for a given engine design provides various benefits, including but not limited to, reduced overall engine weight. For open rotor engines, removing the outer nacelle and reducing the overall axial length of the engine core significantly reduces engine accessory storage space. The diameter of a core cowl can be increased to make room for the accessories between an engine casing and an inner surface of the core cowl, however, the core cowl diameter cannot be too large due to potential performance penalties such as excessive drag and installation difficulties. Similarly, the diameter of the fan cowl, which can also house engine accessories, cannot be too thick in a radial direction due to potential performance penalties.

Exemplary systems for mounting, fastening, or a combination thereof are described herein to provide adaptive spacing and compact packaging or bundling of components and accessories within the core cowl or fan cowl. These meet constraints as required above and further save a significant amount of space, cost, and weight. One example of a system for fastening includes a tube spacing and fastening system that bundles multiple tubes. One example of a system for mounting is a mounting assembly for accessory engine components or other components located in the core cowl or the fan cowl. The mounting assembly includes a versatile platform spaced from an engine casing to which one or more components can be mounted, where the engine casing includes at least the compressor casing, the combustor casing, and the turbine casing. That is, the mounting assemblies disclosed herein not only allow for engine accessories to be mounting upstream of the combustor, but also allows for engine accessories to be mounted at and/or downstream of the combustor in hotter sections of the engine. Better distribution of components under cowl allows for more efficient external dimensions.

In other words, the mounting assembly allows for unique placement of the accessories within one or both of the core cowl or the fan cowl, opening up doors to placements for accessory engine components that allow a smaller overall axial length of the engine core in the engine, including, by way of example, an open rotor engine. The mounting assembly can couple to or provide support for components such as, but not limited to, tubes and duct. Further the combination of both the fastening assembly and the mounting assembly provides for compact and secure location of the tubes, duct, engine components or accessories, or any combination thereof in one or both of the core cowl or the fan cowl.

To more clearly and concisely describe and point out the subject matter, the following definitions are provided for specific terms, which are used throughout the following description and the appended claims, unless specifically denoted otherwise with respect to a particular embodiment. The term “tube spacing and fastening system” as used in the context refers to a group of interacting or interrelated elements that act according to a set of rules to form a unified whole deployed to spatially separate tubes or its equivalents, such as pipes, rods, bars or any tubular structure and at the same time, to fasten them together. The tube spacing and fastening system is a system for fastening tubes in the unducted turbofan engine 100 (FIG. 4). The detailed description uses numerical and letter designations to refer to features of tube spacing and fastening systems in the drawings. Like or similar designations in the drawings and description have been used to refer to like or similar systems for fastening illustrated as tube spacing and fastening systems. As used herein, the numerals “520,” “540,” “560,” and “580” may be used interchangeably to distinguish one system from another and are not intended to signify location or importance of the individual systems.

The term “spacer element” as used in the context refers to a device or piece used to create or maintain a desired amount of space between two or more objects. The detailed description uses numerical and letter designations to refer to features of spacer elements in the drawings. Like or similar designations in the drawings and description have been used to refer to like or similar spacer elements. As used herein, the numerals “522,” “542,” “562,” and “582” may be used interchangeably to distinguish one spacer element from another and are not intended to signify location or importance of the individual spacer elements.

The term “core part” as used in the context refers to a central and foundational portion of a spacer element, usually distinct from the enveloping portions by a difference in nature or structure or function. The detailed description uses numerical and letter designations to refer to features of core parts in the drawings. Like or similar designations in the drawings and description have been used to refer to like or similar core parts. As used herein, the numerals “529,” “545,” and “586” may be used interchangeably to distinguish one core part from another and are not intended to signify location or importance of the individual core parts.

The term “fastening element” as used in the context refers to a device or component that structurally joins or affixes two or more objects together. In general, fasteners are used to create non-permanent joints, that is, joints that can be removed or dismantled without damaging the joining components. The detailed description uses numerical and letter designations to refer to features of fastening elements in the drawings. Like or similar designations in the drawings and description have been used to refer to like or similar fastening elements. As used herein, the numerals “523,” “546,” “572,” and “592” may be used interchangeably to distinguish one fastening element from another and are not intended to signify location or importance of the individual fastening elements.

The term “raised slot edge” as used in the context refers to elevated sides of a narrow, elongated depression, groove, notch, slit, or aperture, especially a narrow opening on a spacer element for receiving or admitting something of a planar dimension such as a fastening strap or band. The detailed description uses numerical and letter designations to refer to features of raised slot edges in the drawings. Like or similar designations in the drawings and description have been used to refer to like or similar raised slot edges. As used herein, the numerals “554,” and “568” may be used interchangeably to distinguish one raised slot edge from another and are not intended to signify location or importance of the individual raised slot edges.

The term “top end” as used in the context refers to the highest or uppermost point, portion, or surface of a spacer element. The detailed description uses numerical and letter designations to refer to features of top ends in the drawings. Like or similar designations in the drawings and description have been used to refer to like or similar top ends. As used herein, the numerals “537,” and “565” may be used interchangeably to distinguish one top end from another and are not intended to signify location or importance of the individual top ends.

Similarly, the term “bottom end” as used in the context refers to the lowest or lowermost point, portion, or surface of a spacer element. The detailed description uses numerical and letter designations to refer to features of bottom ends in the drawings. Like or similar designations in the drawings and description have been used to refer to like or similar bottom ends. As used herein, the numerals “538,” and “566” may be used interchangeably to distinguish one bottom end from another and are not intended to signify location or importance of the individual bottom ends.

The term “top tray slot” as used in the context refers to a narrow, elongated depression, groove, notch, slit, or aperture, especially a narrow opening on top of a spacer element for receiving or admitting something of a planar dimension such as a fastening strap or a band. The detailed description uses numerical and letter designations to refer to features of top tray slots in the drawings. Like or similar designations in the drawings and description have been used to refer to like or similar top tray slots. As used herein, the numerals “552,” and “567” may be used interchangeably to distinguish one top tray slot from another and are not intended to signify location or importance of the individual top tray slots.

The term “tube outer surface” as used in the context refers to an outermost or uppermost or exterior boundary or layer or area of a tube. The detailed description uses numerical and letter designations to refer to features of tube outer surfaces in the drawings. Like or similar designations in the drawings and description have been used to refer to like or similar tube outer surfaces. As used herein, the numerals “526,” “547,” “573,” and “593” may be used interchangeably to distinguish one tube outer surface from another and are not intended to signify location or importance of the individual tube outer surfaces.

The tube spacing and fastening system of the present disclosure provides for coupling multiple tubular structures together. The tube spacing and fastening system of the present disclosure couples or connects multiple tubular structures together without brazes or welds. In some examples, the tube spacing and fastening system may include a spacer element and a fastening band for coupling the multiple tubular structures. The spacer element functionally addresses an engineering contradiction of holding the tubular structures together and, at the same time, spatially separating them from another. The fastening band extends around the outer surfaces of the tubular structures and fastens them to the spacer element, loosely below a predetermined temperature range and conversely, tightly above the predetermined temperature range.

The spacer element is also configured to distribute stress in each of the plurality of tubular structures in relation to the spacer element. Surface features may be present on the spacer. Further, the tube spacing and fastening system of the present disclosure may allow for coupling of multiple tubular structures in a manner that reduces, prevents, or eliminates high stress concentrations.

Gas turbine engine installations include tubes or conduits carrying fuel, oil, hydraulic fluids or pressurized air. The tubes or conduits are usually bundled together to carry the fluid within or across several compartments and components (such as fan, compressor, turbine) of the engine or to discharge the fluid overboard. Tube or pipe assemblies deployed in engineering assemblies found in aircraft engines typically bundle the tubes using spacers. The spacers may be permanently joined to the tube bundle, for example, with brazed or welded blocks and tabs. For example, a typical tube assembly of exemplary tubular structures may include, in a non-limiting manner, tubes, pipes, rods, bars, or combinations thereof. In one instance, an exemplary tube assembly may include a bank of exemplary tubes permanently joined (e.g., brazed or welded) in a clamp forming a clamp-tube assembly. In one instance, an exemplary tube assembly may include a bank of exemplary tubes permanently joined (e.g., brazed or welded) in a spacer forming a permanently joined spacer-tube assembly.

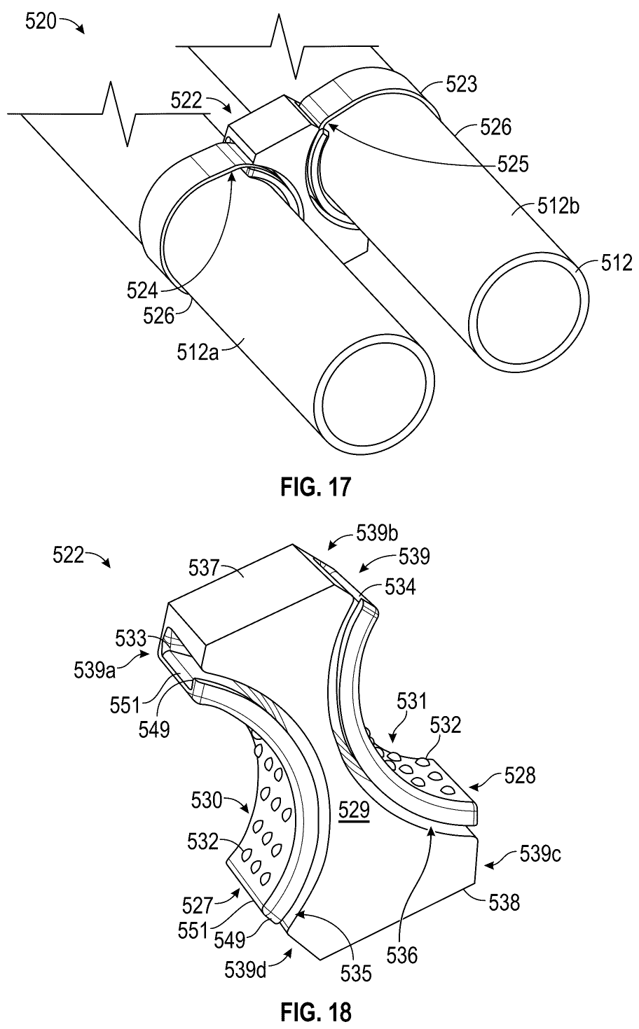

FIG. 17 shows a schematic, perspective view of a system having tube spacing and fastening system for tubular structures, such as tubes, pipes, rods and bars, according to an embodiment of the present disclosure, typically found in engineering assemblies associated with aircraft engines. Referring to FIG. 17, a bank of exemplary tubes 512 is assembled in a tube spacing and fastening system 520. The tube spacing and fastening system 520 is located within the core cowl 122 (FIG. 4) or the fan cowl 170 (FIG. 4). The tube spacing and fastening system 520 may include a spacer element 522 configured to engage the exemplary tubes 512 and spatially separate one exemplary tube 512a from another exemplary tube 512b. The spacer element 522 may spatially separate the exemplary tubes 512 and distribute stress in the tube spacing and fastening system 520. Further, a fastening element 523 is configured to extend around at least a portion of an outer surface 526 of the exemplary tubes 512 and the fastening element 523 is configured to extend around at least a portion of the outer surface 526 of the exemplary tubular structures 512, and to fasten the exemplary tubes 512 to the spacer element 522 in an adaptively spaced configuration. In one instance, the adaptively spaced configuration may include a first length of the fastening element 523 below a predetermined temperature range and a second length of the fastening element 523 above the predetermined temperature range, such that the first length is different from the second length. Further, in another instance, the adaptively spaced configuration may include a first configuration, wherein the exemplary tubes 512 are movably spaced around the spacer element 522 and a second configuration, wherein the exemplary tubes 512 are immovably spaced around the spacer element 522. The fastening element 523 includes at least a first part 524 and a second part 525.

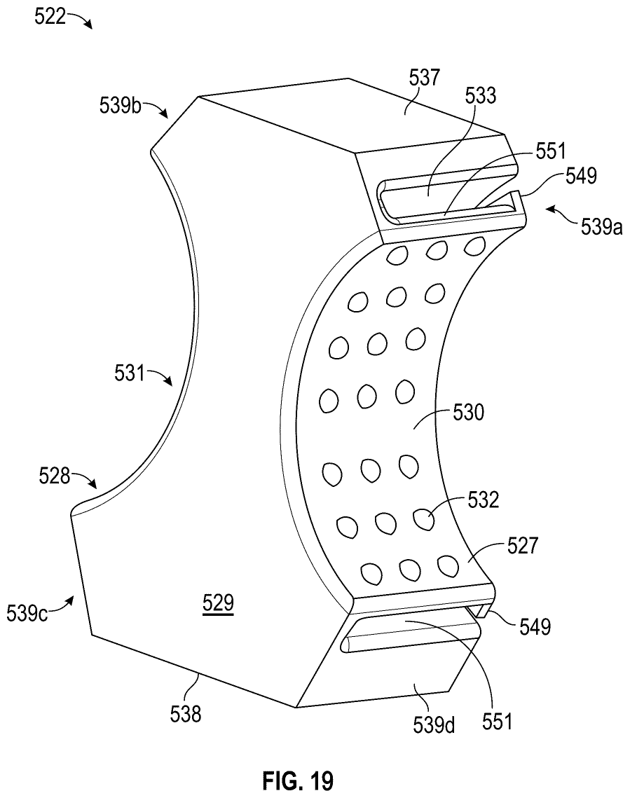

FIG. 18 shows an enlarged schematic, perspective front view of the spacer element 522 as in the tube spacing and fastening system 520 for exemplary tubes 512 of FIG. 17. FIG. 19 shows an enlarged schematic, perspective back view of the spacer element 522 for the tube spacing and fastening system 520 of FIG. 17. Referring to FIGS. 18 and 19, the spacer element 522 may include two opposing faces, a first cradle bracket 527 and a second cradle bracket 528, separated by a core part 529 positioned in the center of the spacer element 522 and in between the first cradle bracket 527 and the second cradle bracket 528. The first cradle bracket 527, the second cradle bracket 528, and/or the core part 529 may be concave or may be any shape configured to complement the shape of the exemplary tubes 512. In one instance, the core part 529 may be a double-concave core part. The spacer element 522 may be a spacer block and may be a solid block. The first cradle bracket 527 and the second cradle bracket 528 may be formed in the body of the spacer element 522.

With continued reference to FIGS. 18 and 19, a first contact surface 530 may engage the corresponding first exemplary tube 512a (FIG. 17) at the first cradle bracket 527 and a second contact surface 531 may engage the corresponding second exemplary tube 512b (FIG. 17) at the second cradle bracket 528. The first contact surface 530, the second contact surface 531, or both, may include a number of exemplary surface features 532, such as, for example, but not limited to, indentations or protrusions.

Going into more detail, the spacer element 522 employs the first cradle bracket 527 configured to engage the first exemplary tube 512a (FIG. 17) and the second cradle bracket 528 configured to engage the second exemplary tube 512b (FIG. 17). The core part 529 spatially separates the first cradle bracket 527 from the second cradle bracket 528, and, thereby, spatially separates the first exemplary tube 512a engaged in the first cradle bracket 527 and the second exemplary tube 512b engaged in the second cradle bracket 528. The spacer element 522 further includes a first recess 533 on one side, carved between the first cradle bracket 527 and a first corresponding surface 535 of the core part 529. In a similar manner, the spacer element 522 further includes a second recess 534 on the other side, carved between the second cradle bracket 528 and a second corresponding surface 536 of the core part 529.

The first recess 533 is configured to accommodate the first part 524 (FIG. 17) of the fastening element 523 and the second recess 534 is configured to accommodate the second part 525 (FIG. 17) of the fastening element 523. Each of the first recess 533 and the second recess 534 includes a projected lip 549 (FIGS. 18 and 19) and a seat 551 (FIGS. 18 and 19) that, together, keep the fastening element 523 within the respective recess 533 and 534 and prevent from slipping out of the recess, under stress. Continuing to refer to FIGS. 18 and 19, the first cradle bracket 527, the second cradle bracket 528, and the core part 529 may join at a top end 537 of the spacer element 522 and at a bottom end 538 of the spacer element 522.

In an embodiment of the current disclosure, the fastening element 523 may be a wrap-around band made of a shape memory alloy (SMA). Without being held to any particular theory, it is currently believed that the scientific effect of exemplary shape-memory alloys is based on the phenomenon of continuous appearance and disappearance of the martensite phase with falling temperatures and rising temperatures. This thermoelastic behavior is the result of the transformation from a parent austenite phase, stable at an elevated temperature, to the martensite phase. Specifically, when a pre-deformed, shape memory alloy specimen is heated to the temperature of the parent austenite phase, a complete recovery of the deformation takes place. Complete recovery in this process is limited by the fact that strain must not exceed a critical value which ranges, for example, from 3% to 4% for copper shape-memory effect alloys to 6% to 8% for nickel-titanium shape-memory alloys.

The shape-memory effect, as embodied by the fastening element 523 as an SMA band, is a spontaneous, reproducible, and reversible shape change associated with heating and cooling throughout an overall transformation temperature range. Further, it is possible to condition or ‘train’ a shape-memory alloy to have a shape-memory effect by repeating the cooling and heating process a number of times. The reversible shape change could be, for example, lengthening and shortening as the trained shape-memory alloy sample is cycled between two transitional temperatures.

Referring to FIG. 17, when the fastening element 523 is a shape memory alloy band, the fastening element 523 of the current disclosure may have an overall transition temperature range above atmospheric temperature and below a temperature such that the shape memory alloy band may assume a first configuration (length) for tightly supporting the exemplary tubes 512 at a temperature above the overall transition temperature and may assume a second configuration (length) for loosely engaging the exemplary tubes 512 below the overall transition temperature. Thus, for the exemplary tubes 512 to engage with the spacer element 522, the shape memory alloy band may generate high radial compressive force that swages the underlying exemplary tubes 512.

In operation, when the fastening element 523 is a shape memory alloy (SMA) band, the band is configured to be oversized in a cooled, martensitic state and, then, during operation, the band is warmed up to a smaller, contracted size to generate an elastic radial compressive force and thereby engage the exemplary tubes 512 with the spacer element 522. Further, referring to FIG. 17, the shape memory alloy (SMA) band, in one embodiment of the current disclosure, generates high radial compressive force and swages (compresses or shrinks) underlying tube surfaces to locally yield at the static metal-to-metal joints by swaging a number of surface features (protrusions or indentations or teeth or dimples or ridges) configured on the contact surfaces and, at the same time, remain in continued contact with the spacer element 522.

Any shape-memory alloy may be used in the present disclosure as long as it demonstrates an adequate shape-memory effect. In one embodiment of the current disclosure, the shape-memory alloys include nickel-titanium alloys, in weight ratios selected to deform at a temperature above a desired transition temperature. Further, the chemical composition and transition temperature for the shape memory metal (SMA) are further selected to be appropriate for the desired tube spacing and fastening system operating temperature between ambient and about 1000° F.

Thus, exemplary shape memory alloy (SMA) bands for the fastening element 523 of FIG. 17 utilize their shape-memory characteristic and corresponding configured and memorized length to provide a temperature-sensitive length change and, thereby, a significant degree of adaptive spacing of the exemplary tubes 512 during operation. Specifically, when the exemplary tubes 512 tubes are at their operating temperature above the transition temperature of the shape memory alloy (SMA) bands, typical shape memory alloy (SMA) bands transform to their memorized shorter length, providing a tight and reduced spacing and lateral loading on the exemplary tubes 512. Referring to FIGS. 17, 18, and 19, the shape memory alloy (SMA) band for the fastening element 523 of the current disclosure may engage the first cradle bracket 527 and the second cradle bracket 528 and the outer surfaces 526 of the exemplary tubes 512 upon heating above the parent austenite transition temperature range to a high temperature, tight configuration of the shape-memory alloy.

Conversely, once cooled below the martensite transition temperature range, typical shape memory alloy (SMA) bands convert to their low temperature configuration and are in an expanded length or stretched length or oversized length corresponding to the lower temperatures. Typically, such high temperature configurations are associated with operational conditions when the exemplary tubes 512 need to be in compact, tight and immovable contact. Further low temperature configurations are associated with maintenance or shutdown of the engineering spacing and fastening system and the shape memory alloy (SMA) band enable assume a loose configuration enabling a slidable or movable disengagement of the exemplary tubes 512 from their respective cradle brackets and the spacer element 522. The shape memory alloy (SMA) bands and their shape-memory effect thus inherently provide adaptive spacing for the exemplary tubes 512, in relation to each other and to the spacer element 522 to which they are fastened.

The stress distribution effect of the shape memory alloy (SMA) bands may be further enhanced by adopting a stress-adaptive configuration of the spacer element 522 and related parts and components. For example, contact surfaces where two or more parts engage and/or interact with each other (e.g., the first contact surface 530 and/or the second contact surface 531) may include a stress-adaptive configuration (e.g., surface features configured to reduce contact stress between parts). In another embodiment of the disclosure, one, or more, or all, of the joints 539 in spacer element 522 are filleted for optimal stress distribution at the corners where the fastening element 523 engages with the spacer element 522. In other words, a first exemplary joint 539a between the first cradle bracket 527 and the top end 537, a second exemplary joint 539b between the second cradle bracket 528 and the top end 537, a third exemplary joint 539c between the first cradle bracket 527 and the bottom end 538, and a fourth exemplary joint 539d between the second cradle bracket 528 and the bottom end 538 are all filleted joints.

Referring to FIGS. 17, 18, and 19, the exemplary tubes 512 can have a diameter in the range of 0.25 to 1.0 inches (0.635 centimeters to 2.54 centimeters) and wall thickness in the range of 0.020 to 0.049 inches (0.0508 centimeters to 1.2446 centimeters). It is contemplated that the width of the spacer element 522 can be any width. For example, the width of the spacer element 522 can be of the order of 0.5 inches (1.27 centimeters). It is further contemplated that the thickness of the shape memory alloy (SMA) band can be any thickness, for example in a range of 0.020 to 0.063 inches (0.0508 centimeters to 0.16002 centimeters).

Continuing to refer to FIGS. 18 and 19, additional stress distribution configurations may include specially contouring the first contact surface 530 and the second contact surface 531 between the exemplary tubes 512 and the first cradle bracket 527 and the second cradle bracket 528. Accordingly, instead of full surface contact between a stiffer block (e.g., spacer element 522) and a thin-walled tube (e.g., exemplary tubes 512), which generates higher edge contact stress, the spacer element 522 may include exemplary surface features 532. The exemplary surface features 532 may be protrusions (also known as ‘beads’) in one instance and may be indentations (also known as ‘dimples’) in another instance. In yet another instance, the surface features 532 may be any combination of protrusions and indentations. The exemplary surface features 532 can be of different shapes with varying cross sections such as spherical-circular (as shown in FIGS. 18 and 19), or elliptical, or square, or trapezoidal, or triangular, or any combination of these. Thus, the exemplary surface features 532 may create a low stress field at discrete points of contact on the exemplary tubes 512. Specifically, the first exemplary tube 512a joins the first cradle bracket 527 at the first contact surface 530 and the second exemplary tube 512b joins the second cradle bracket 528 at the second contact surface 531, and either the first contact surface 530, or the second contact surface 531, or both include the exemplary surface features 532 that may include protrusions and/or indentations, which may provide effective stress optimization configuration. Thus, referring to FIGS. 17, 18, and 19, the metal-to-metal contacts at the ‘thick-walled’ first cradle bracket 527 and the ‘thick-walled’ second cradle bracket 528 may result in high stresses, so the exemplary surface features 532 (protrusions/indentations) may be included in a non-limiting manner. In other words, the exemplary surface features 532 (protrusions/indentations) may be omitted in another instance, if desired.

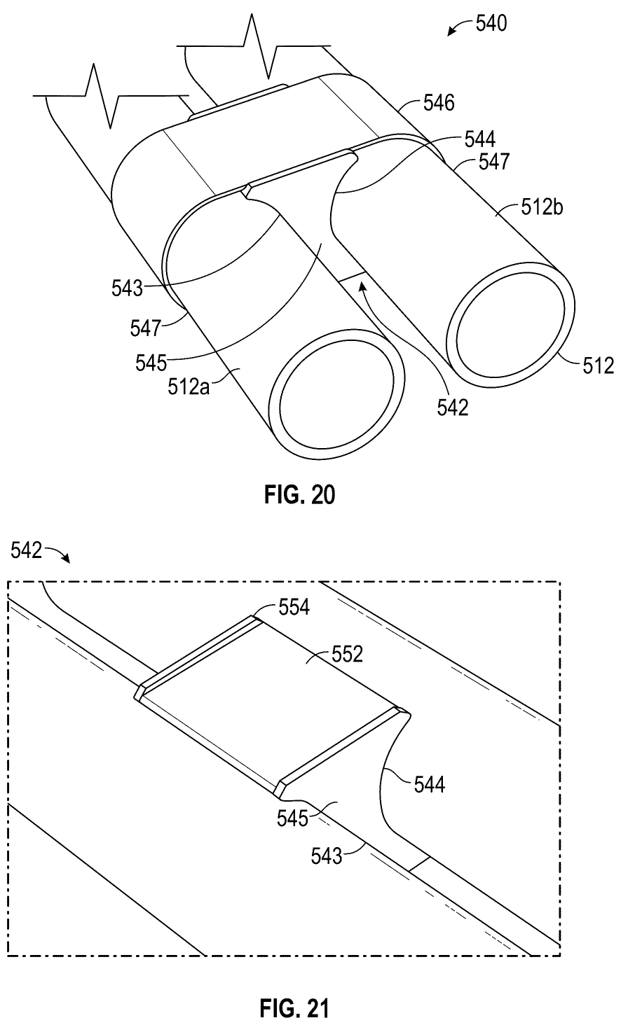

FIG. 20 shows a schematic, perspective view of a tube spacing and fastening system 540 for the exemplary tubes 512, according to an embodiment of the present disclosure. Referring to FIG. 20, the tube spacing and fastening system 540 includes a spacer element 542 with two opposing faces shaped as a first cradle bracket 543 and a second cradle bracket 544 separated by a core part 545. In an embodiment of the current disclosure, outer surfaces of the first cradle bracket 543 and the second cradle bracket 544 may be marked with exemplary surface features including protrusions/indentations (not visible, such as described with respect to FIGS. 18 and 19). Continuing to refer to FIG. 20, a fastening element 546 is extended around at least part of an outer surface 547 of each of the exemplary tubes 512 in the tube spacing and fastening system 540 to fasten the exemplary tubes 512 to the spacer element 542. In one instance, the fastening element 546 may be a shape memory alloy (SMA) band.

FIG. 21 shows an enlarged schematic, perspective view of the spacer element 542 as in the tube spacing and fastening system 540 for the exemplary tubes 512 of FIG. 20, according to an embodiment of the present disclosure. Continuing to refer to FIG. 21, the spacer element 542 is configured as a solid block that includes a seating slot or groove 552 to accommodate the fastening element 546, embodied as a shape memory alloy (SMA) band. The fastening element 546, embodied as a shape memory alloy (SMA) band, typically extends around the spacer element 542 and the exemplary tubes 512. Further, the seating slot or groove 552 may include raised edges 554 on the spacer element 542 to provide a secure or snug seating arrangement for the fastening element 546, embodied as a shape memory alloy (SMA) band within the seating slot or groove 552.

Continuing to refer to FIG. 21, additional stress distribution configurations may include specially contouring the contact surfaces between the exemplary tubes 512 and the first cradle bracket 543 and the second cradle bracket 544. Accordingly, instead of full surface contact between a stiffer block (e.g., the spacer element 542) and a thin-walled tube (e.g., the exemplary tubes 512), which generate higher edge contact stress, the spacer element 542 may include exemplary surface features (not shown). The exemplary surface features may be protrusions (also known as ‘beads’) in one instance and may be indentations (also known as ‘dimples’) in another instance. In yet another instance the surface features may be any combination of protrusions and indentations. Thus, the exemplary surface features may create a low stress field at discrete points of contact on the exemplary tubes 512. Specifically, the first exemplary tube 512a joins the first cradle bracket 543 at a corresponding first contact surface (not shown) and the second exemplary tube 512b joins the second cradle bracket 544 at a corresponding second contact surface (not shown), and either the first contact surface or the second contact surface or both include exemplary surface features that may include protrusions and/or indentations, which may provide effective stress distribution configuration. Thus, referring to FIGS. 20 and 21, the metal-to-metal contacts at the ‘thick-walled’ first cradle bracket 543 and the ‘thick-walled’ second cradle bracket 544 may result in high stresses, so exemplary surface features (protrusions/indentations) may be included, in a non-limiting manner. In other words, the exemplary surface features (protrusions/indentations) may be omitted in another instance, as desired.

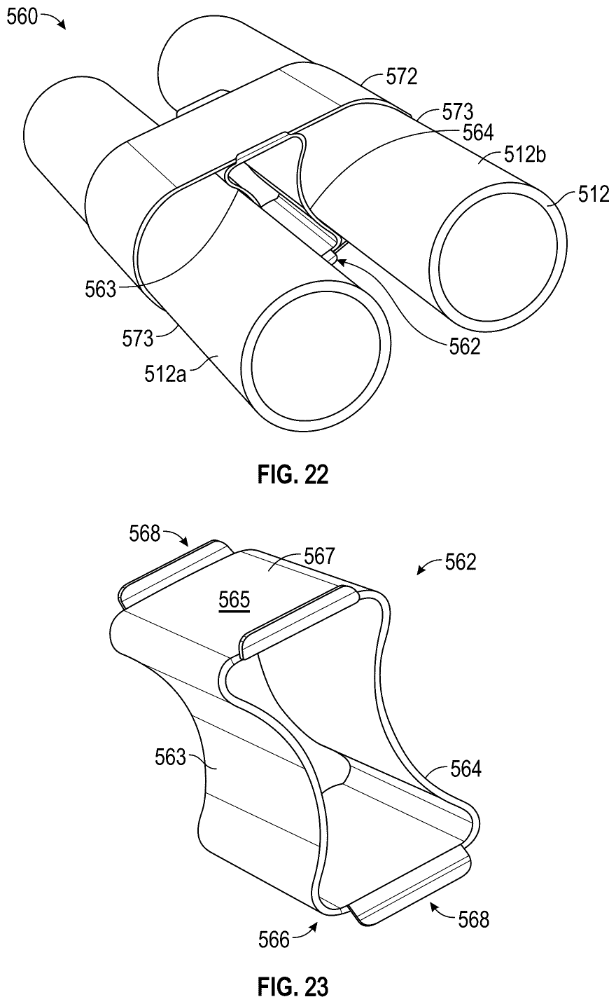

FIG. 22 shows a schematic, perspective view of a tube spacing and fastening system 560 for the exemplary tubes 512, according to an embodiment of the present disclosure. Referring to FIG. 22, the bank of exemplary tubes 512 are assembled in a tube spacing and fastening system 560. Tube spacing and fastening system 560 includes a spacer element 562 with two opposing faces shaped as a first thin-walled bracket 563 and a second thin-walled bracket 564. In one embodiment of the disclosure, outer surfaces of the first thin-walled bracket 563 and second thin-walled bracket 564 are marked with protrusions and/or indentations (not shown), such as described with respect to FIGS. 18 and 19. The thin-walled bracket 564 and the thin-walled bracket 563 may function as cradles, such as described with respect to FIGS. 17 to 21, such that the tube spacing and fastening system 560 of FIGS. 22 and 23 includes a plurality of cradles (e.g., thin-walled bracket 564 and thin-walled bracket 563).

FIG. 23 shows an enlarged schematic, perspective view of the spacer element 562 as part of the tube spacing and fastening system 560 for the exemplary tubes 512 of FIG. 22, according to an embodiment of the present disclosure. Continuing to refer to FIG. 23, the spacer element 562 has a top end 565, a bottom end 566, and a top tray slot 567 with a raised slot edges 568. Further, referring to FIG. 22 and FIG. 23, a fastening element 572, embodied as a shape memory alloy (SMA) band, is extended around outer surfaces 573 of the exemplary tubes 512 in the tube spacing and fastening system 560 to fasten them to the spacer element 562.

The tube spacing and fastening system 560 may include the spacer element 562 with two opposing faces shaped as the first thin-walled bracket 563 and the second thin-walled bracket 564. In another embodiment of the disclosure, the first thin-walled bracket 563 is configured to engage the first exemplary tube 512a and the second thin-walled bracket 564 is configured to engage the second exemplary tube 512b. The first thin-walled bracket 563 and the second thin-walled bracket 564 join each other at the top end 565 on top of the spacer element 562 and further at the bottom end 566 of the spacer element 562. Further, the first thin-walled bracket 563 and the second thin-walled bracket 564 are spatially separated by a hollow space in between the first thin-walled bracket 563 and the second thin-walled bracket 564.

Continuing to refer to FIGS. 22 and 23, additional stress distribution configurations may include specially contouring the contact surfaces between the exemplary tubes 512 and the first thin-walled bracket 563 and the second thin-walled bracket 564. Accordingly, instead of full surface contact between a stiffer block (e.g., the spacer element 562) and a thin-walled tube (e.g., the exemplary tubes 512), which generate higher edge contact stress, the spacer element 562 may include exemplary surface features (not shown). The exemplary surface features may be protrusions (also known as ‘beads’) in one instance and may be indentations (also known as ‘dimples’) in another instance. In yet another instance, the surface features may be any combination of protrusions and indentations. Thus, the exemplary surface features may create a low stress field at discrete points of contact on the exemplary tubes 512. Specifically, the first exemplary tube 512a joins the first thin-walled bracket 563 at a corresponding first contact surface (not shown) and the second exemplary tube 512b joins the second thin-walled bracket 564 at a corresponding second contact surface (not shown), and either the first contact surface, or the second contact surface, or both, include exemplary surface features that may include protrusions and/or indentations, which may provide effective stress distribution configuration. Thus, referring to FIGS. 22 and 23, the metal-to-metal contacts at the first thin-walled bracket 563 and the second thin-walled bracket 564 may not result in high stresses, so the exemplary surface features 532 may not be included in a non-limiting manner. In another instance, however, the exemplary surface features 532 may be included and formed as protrusions/indentations, as desired, in order to reduce existing stress.

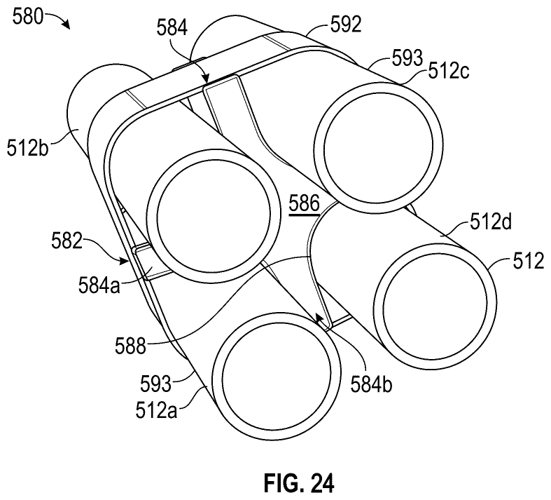

FIG. 24 is a schematic, perspective view of a tube spacing and fastening system 580 for the exemplary tubes 512 in accordance with an embodiment of the current disclosure. Referring to FIG. 24, the tube spacing and fastening system 580 includes a spacer element 582. The spacer element 582 may be any predetermined formation, such as a star formation, or cross formation, or any combination thereof. The spacer element 582 may include one or more radial arms 584 arranged in a star formation. Further, each of the radial arms 584 joins at its respective base with a core part 586. The radial arms 584 and the core part 586 may be integral and unitary or may be separate parts coupled or connected together. In the non-limiting example of FIG. 24, there are four exemplary radial arms 584 extending from the core part 586, but, in other embodiments, there may be fewer or more than four radial arms 584. The number of radial arms 584 may be selected based on the number of the exemplary tubes 512 desired to be coupled together.

With continued reference to FIG. 24, an exemplary pair of adjacent radial arms 584a and 584b (two adjacent radial arms) and the core part 586 joining at their respective base, may form an exemplary cradle bracket 588, to engage a corresponding tubular structure, embodied as an outer surface 593 of the exemplary tubes 512. Accordingly, in the example of FIG. 24, four cradle brackets 588 may be formed to accommodate four exemplary tubes-a first exemplary tube 512a, a second exemplary tube 512b, a third exemplary tube 512c and a fourth exemplary tube 512d. The tube spacing and fastening system 580 may include the spacer element 582 constructed in a star formation, or a cross formation, or any combination thereof, with the exemplary radial arms 584 extending outward from the core part 586. In an embodiment, outer surfaces of the radial arms 584 (e.g., the surfaces forming the cradle bracket 588) may be marked with surface features including protrusions/indentations (not shown), such as described with respect to FIGS. 18, 19, 21, 23, and 26A to 26C. Continuing to refer to FIG. 24, a fastening element 592, embodied as a shape memory alloy (SMA) band may be extended around the outer surfaces 593 of each of the exemplary tubes 512 in the tube spacing and fastening system 580 to fasten them to an exemplary star formation, or a cross formation, or any combination thereof, of the spacer element 582.

FIG. 25 is a schematic, perspective view of a tube spacing and fastening system 600 for the exemplary tubes 512 in accordance with an embodiment of the current disclosure. Referring to FIG. 25, the tube spacing and fastening system 600 includes a spacer element 682. The spacer element 682 includes three exemplary radial arms 684a, 684b, and 684c arranged in a star formation. Each of the radial arms 684a, 684b, and 684c joins at its respective base with a core part 686. The radial arms 684a, 684b, and 684c and the core part 686 can be integral and unitary or can be separate parts coupled or connected together.

With continued reference to FIG. 25, an exemplary pair of adjacent radial arms 684b and 684c (two adjacent radial arms) and the core part 686 joining at their respective base, form an exemplary cradle bracket 688, to engage a corresponding tubular structure, embodied as an outer surface 693 of the exemplary tubes 512. Accordingly, in the example of FIG. 25, three cradle brackets 688 are formed to accommodate three exemplary tubes—the first exemplary tube 512a, the second exemplary tube 512b, and the third exemplary tube 512c. The outer surfaces of the radial arms 684a, 684b, and 684c (e.g., the surfaces forming the cradle bracket 688) are marked with surface features including protrusions/indentations (not shown), such as described with respect to FIGS. 18, 19, 21, 23, and 26A to 26C. Continuing to refer to FIG. 25, a fastening element 692, embodied as a shape memory alloy (SMA) band is extended around the outer surfaces 693 of each of the exemplary tubes 512a, 512b and 512c to fasten them to the spacer element 682.

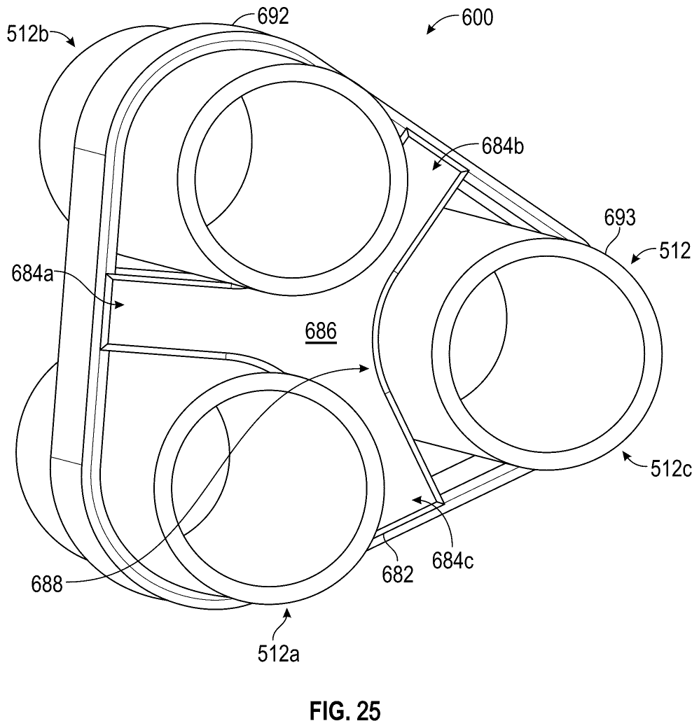

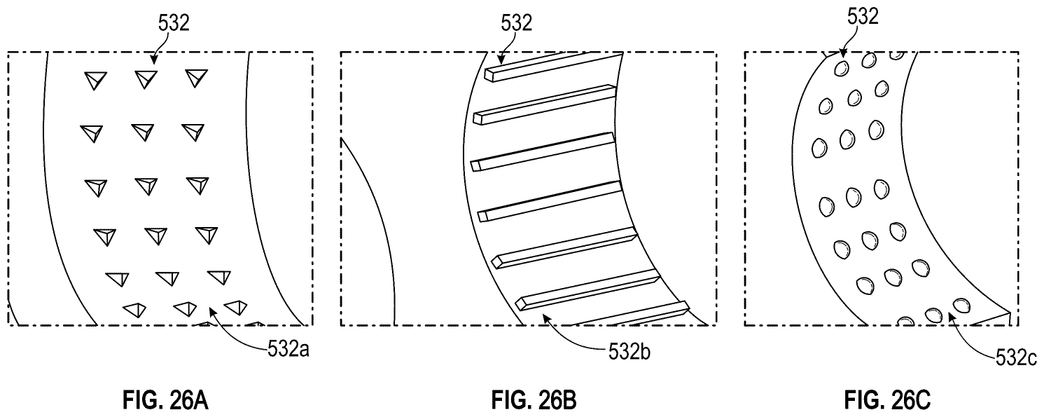

FIGS. 26A to 26C show exemplary surface features 532, which may be provided in any or all of the spacer elements described herein, such as, for example, the spacer element 522 (FIG. 19), the spacer element 542 (FIG. 20), the spacer element 562 (FIG. 22), the spacer element 582 (FIG. 24), and the spacer element 682 (FIG. 25). The exemplary surface features 532 may be prismatic surface features 532a (FIG. 26A), elongated rectangular surface features 532b (FIG. 26B), or rounded, semi-spherical surface features 532c (FIG. 26C). Other shapes are also contemplated, such as, for example, cubes or other polygonal shapes, elliptical, square, trapezoidal, triangular, elongated curved shapes, continuous shapes, discrete shapes, etc. Any combination of the surface features shown and/or the surface features described may be provided on the spacer elements of the present disclosure. The surface features 532 may be protrusions, indentations, or combinations thereof. More than one shape of surface features 532 may be provided on a single bracket surface of a spacer element. More than one shape of surface features 532 may be provided on different bracket surfaces of a single spacer element. The surface features 532 described herein may be formed with additive manufacturing, electrical discharge texturing, or electroforming.

Referring to FIG. 17 to FIG. 26C, the spacer element 522, the spacer element 542, the spacer element 562, the spacer element 582, and the spacer element 682 may be additively manufactured. Further, specifically, the spacer element 522, the spacer element 542, the spacer element 562, the spacer element 582, and the spacer element 682 may be optionally contoured with dimples/ridges/beads through additive manufacturing economically. In other embodiments of the disclosure, other manufacturing methods, such as traditional subtractive manufacturing may be employed to produce the parts from typical machined blocks. As for spacing and fastening system material, the spacer elements 522, 542, 562, and 582 are made of steel, Inconel®, or other suitable metals, such as nitinol (Ni—Ti) that meet high temperature applications as well as provide inherent elasticity to retain extending strength needed for braze-free and weld-free joints.

Any of the spacer blocks, fastening elements, and spacing and fastening systems described herein may be combined with all or portions of the other spacer blocks, fastening elements, and spacing and fastening systems described herein. Although a single spacing and fastening system is shown for the exemplary tubes 512, more may be provided along the length of the exemplary tubes 512. In such a manner, the tube spacing and fastening systems of the present disclosure may include a plurality of spacer blocks and fastening elements. The number may be selected based on the desired coupling and securement of the exemplary tubes 512.

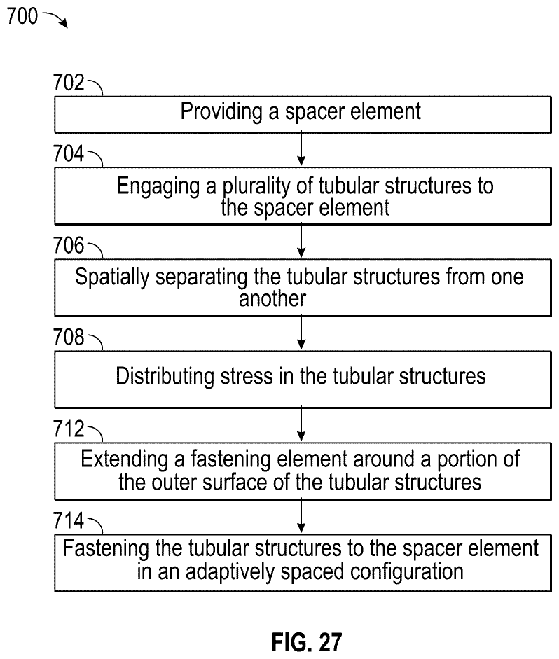

FIG. 27 is a block diagram of a method 700 of spacing and fastening tubular structures in accordance with one embodiment of the current disclosure. Referring to FIG. 27, the method 700 of spacing and fastening tubular structures, such as the exemplary tubes 512, includes in step 702, providing a spacer element, in step 704, engaging a plurality of tubular structures to the spacer element, in step 706, spatially separating the plurality of tubular structures from one another, and in step 708, distributing stress in the plurality of tubular structures. The method 700 further includes, in step 712, extending a fastening element around at least a portion of an outer surface of the plurality of tubular structures and in step 714, fastening the plurality of tubular structures to the spacer element in an adaptively spaced configuration.

In another embodiment of the current disclosure, the method 700 of spacing and fastening tubes further includes non-permanently engaging a first exemplary tube 512a to a first cradle bracket (FIGS. 18 and 19, 527; FIG. 20, 543; FIG. 22, 563; FIG. 24, 588; FIG. 25, 688), engaging a second exemplary tube 512b to a second cradle bracket (FIGS. 18 and 19, 528; FIG. 20, 544; FIG. 22, 564; FIG. 24, 588; FIG. 6, 688) such that the first exemplary tube 512a and the second exemplary tube 512b are spatially separated.

In one aspect of the disclosure, the tube spacing and fastening systems of the present disclosure use appropriate fastening elements to space and fasten the tubes and/or pipes with their structural integrity intact and without any cutting or shearing of the tubes and/or pipes. The spacing and fastening elements, as described in the embodiments of the current disclosure, thereby, improve on several critical operational performance factors including high stress concentration (Kt) at tube joints, difficulty in controlling uniformness of quality (owing to voids, limited braze/weld witness feature, and lack of coverage), low high-cycle fatigue (HCF) capability of material flux, geometric stress concentration, and rapid transition from flexible tube surfaces to stiff constraining elements.

Although described as engaging the exemplary tubes 512, the connection provided by the spacer element and the fastening element may be permanent in one instance. In other instances, the connection provided by the spacer element and fastening element to engage the exemplary tubes 512 may be non-permanent. In some embodiments, the spacer element and the fastening element may be retrofit onto the exemplary tubes 512. The spacer element and the fastening element may be capable of being serviceable or replaceable, in the manufacturing plant or in the field.

The tube spacing and fastening systems of the present disclosure may include shape memory alloy (SMA) bands as a fastening element that provides an advantage over permanently joined spacing and fastening system configurations that sometime hold the tubes too tenaciously during tube reconstitution and/or tend to score the tubes during installation.

The tube spacing and fastening systems of the present disclosure provide a non-brazed, non-welded connection or coupling of tubes. The non-brazed, non-welded tube bundle configurations using shape memory alloy (SMA) bands for connecting the tubes and the spacer element may address issues associated with stress concentration of brazed or welded joints. Shape memory alloy (SMA) bands extended around tubes joining at the spacer element offer smooth stress distribution without any sudden transition of stiffness from spacer element to the tubes.

The tube spacing and fastening systems of the present disclosure may provide adaptive spacing and fastening and dismantling by employing thermally elastic compressive shape memory alloy (SMA) bands that continue to keep tube bundles in continued contact with spacer element even in case of contact wear as is customary for non-brazed and non-welded tube bundle configurations.

The tube spacing and fastening systems of the present disclosure include shape memory alloy (SMA) bands as fastening elements that are provided with a memorized length, and are produced and installed generally around tubes so as to provide tube adaptive spacing. When the shape memory alloy (SMA) bands are at their operating temperature above the transition temperature of the shape memory alloy (SMA) bands, the shape memory alloy (SMA) bands transform to the memorized length, thereby providing reduced spacing and lateral loading to the tubes. The shape memory alloy (SMA) bands thus inherently provide adaptive spacing for the tubes in the tube bundles, in relation to each other and the spacer element.

Exemplary shape memory alloys may include alloys of any of Ni—Ti, or Ni—Ti—Hf, or Ni—Ti—Pd or Ti—Au—Cu.

Any of the fastening elements of the present disclosure may be a shape memory alloy band. The shape memory alloy bands operate as fasteners to isolate a joint assembly of one or more tubular structures. In some examples, the shape memory alloy (SMA) properties improve the reliability and performance of tube assembly as compared to conventional metal fasteners. The shape memory alloy (SMA) bands enable a high performing and reliable isolation joint assembly through stress induced martensite transformation in shape memory alloy (SMA) band fasteners. For example, shape memory alloy (SMA) bands have superelasticity, variable stiffness, and high energy dissipation. These features may provide the following benefits:

Superelasticity: NiTi based shape memory alloy (SMA) bands demonstrate superelastic behavior up to eight percent to ten percent of recoverable strain. This is compared to 0.2 percent of recoverable strain in typical metal (e.g., steel). The superelastic behavior allows the shape memory alloy (SMA) fasteners to undergo large deformation under high engine imbalance condition without failure and allows for the shape memory alloy (SMA) band to recover back to the shape memory alloy (SMA) band's initial shape when the load (e.g., engine condition) is released.

Variable stiffness: NiTi based shape memory alloy (SMA) bands demonstrate unique variable stiffness that, combined with superelastic behavior, may be tuned to control the system response under different loading or engine operating condition. That is, tuned to allow control of the degree of fastening of the tubular structures.

High energy dissipation: shape memory alloy (SMA) exhibit high damping properties during martensitic phase transformation through hysteretic damping that may assist control of a vibratory response. NiTi shape memory alloy (SMA) bands may demonstrate high hysteretic material damping up to six percent, which is higher than conventional metal (e.g., steel) bands.

Furthermore, the shape memory alloy (SMA) bands design can be used as an effective isolation system to control tube response under engine vibration and/or imbalance condition as follows:

Normal engine vibration: At lower strains (less than one percent), the elastic modulus of the austenite phase of the shape memory alloy (SMA) band comes into action to withstand normal engine operating condition.

High engine vibration and imbalance loads: Under this engine condition, the shape memory alloy (SMA) band can be designed to deform to moderate to high strains levels (up to eight percent). At this strain level, the shape memory alloy (SMA) band behaves as a superelastic material with plateau stress. There may be little or no change in stress level, such that tube joint assembly can withstand large range deformation with almost no increase in stress levels. This low elastic modulus behaviour of the shape memory alloy (SMA) band acts as an effective isolation system for the tubular structures from high input vibration or engine imbalance loads.

Extreme engine imbalance condition like blade out: The shape memory alloy (SMA) band can be designed for large strain (eight percent to ten percent) development under extreme engine imbalance condition. Increased elastic modulus and high strength martensitic phase of fastener can withstand extreme imbalance condition without failure and can recover back to the initial shape of the shape memory alloy (SMA) band when the load is released.

The tube spacing and fastening systems of the present disclosure may include multiple configurations of spacer elements including recessed block, solid unrecessed block, thin-walled, cross formation, or star formation spacer elements that provide a wide flexibility in the number of tubes to be engaged and adaptability in the design of the fastening elements to effectively support and spatially separate individual tubes in an assembled bundle. In some examples, the spacer element may be a thick-walled, solid block. Such a block may include surface features on the contact surfaces to reduce stresses between the thin-walled tubes and the thick-walled spacer element. In some examples, the spacer element may be thin-walled.

The tube spacing and fastening systems of the present disclosure may provide effective stress distribution at tube spacing and fastening system joints, low stress field through protrusions, and/or indentations (also known as ‘beads’/‘dimples’) contoured on recessed blocks, solid blocks, thin-walled, cross formation, or star formation spacer elements, filleted joints and, thereby, improve reliability of each configuration of the tube bundle assemblies.

The tube spacing and fastening systems of the present disclosure may provide cost effective configurations that eliminate inspection and quality control issues related to permanently joined tube bundle assemblies such as brazed joints or welded joints. The tube spacing and fastening systems of the present disclosure improves ‘Time on Wing’ with by reducing typical field issues related to brazed or welded joints.

The tube spacing and fastening systems of the present disclosure inherently provide adaptive spacing and compact tube bundle routing for optimal tube packaging that saves a significant amount of space, cost, and weight. While the tube spacing and fastening systems provide improved packaging and bundling of the tubes, additional mounting assemblies can provide additional space, cost, and weight savings, within the open fan engine as described below.

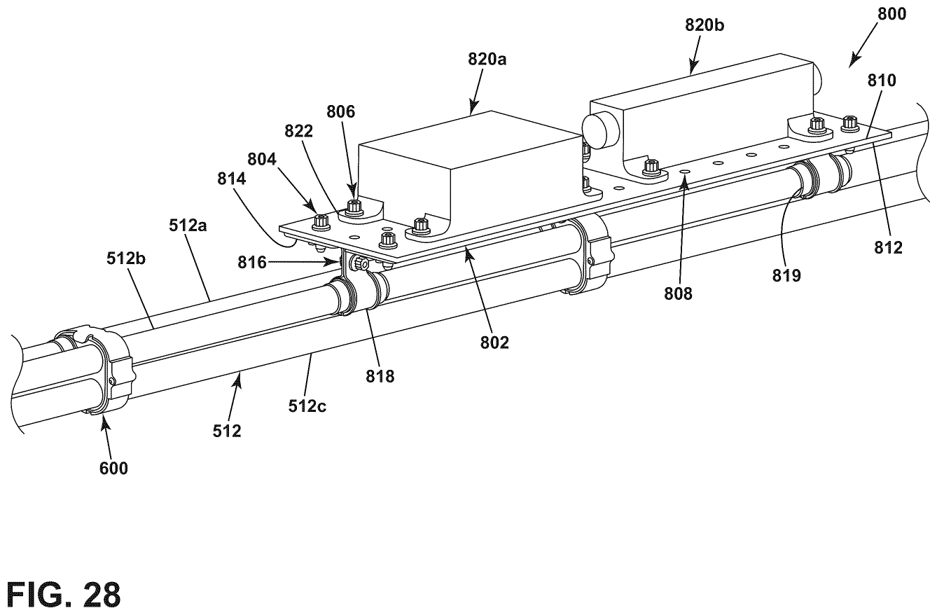

FIG. 28 illustrates a mounting assembly 800. The mounting assembly 800 is a system of mounting components or accessories within the unducted turbofan engine 100 (FIG. 4). The mounting assembly 800 can be located in the core cowl 122 (FIG. 4) or the fan cowl 170 (FIG. 4). The mounting assembly 800 includes a platform 802, a first set of fasteners 804, and a second set of fasteners 806. The platform 802 can include at least one aperture illustrated as a plurality of apertures 808. The platform 802 is illustrated as having a first surface 810 opposite a second surface 812, where the plurality of apertures 808 extends from the first surface 810 to the second surface 812. That is, the plurality of apertures 808 can be a plurality of through holes. While illustrated as a cylindrical, the plurality of apertures 808 can have any shape defined by an inner surface of the platform 802. It is further contemplated that any one or more of the plurality of apertures 808 can vary in diameter from one aperture to another. Further, the diameter of a single aperture of the plurality of apertures 808 can change as the single aperture extends from the first surface 810 to the second surface 812. Still further, while illustrated as evenly spaced, it is contemplated that a straight-line distance between adjacent apertures of the plurality of apertures 808 can vary.

The first set of fasteners 804 couples the platform 802 to one or more portions of the engine 100 (FIG. 4). The mounting assembly 800 comprises a tube clamp 816 having a set of wings 814. The first set of fasteners 804 extend through the platform 802 and one or more portions of the set of wings 814. That is, each fastener of the first set of fasteners 804 passes through an aperture of the plurality of apertures 808 and a wing of the set of wings 814 to couple the platform 802 to the tube clamp 816. The set of wings 814 of the tube clamp 816 extend from an annular portion 818 of the tube clamp 816. The annular portion 818 of the tube clamp 816 can circumscribe the exemplary tube 512b of the bank of exemplary tubes 512. One or more fittings 819 can be located between the tube 512b and the annular portion 818 of the tube clamp 816.

While illustrated as the tube clamp 816, the platform 802 can be coupled or fastened to one or more of the bank of exemplary tubes 512 by any number or combination of brackets, fittings, clamps, straps, or blocks. Further, one or more fasteners of the first set of fasteners 804 or tube clamps 816 can be unitarily formed with the platform 802 or welded to the platform 802.

The second set of fasteners 806 couples one or more engine accessories to the platform 802. The one or more engine accessories are illustrated as a first accessory 820a and a second accessory 820b. Each fastener of the second set of fasteners 806 extends through the platform 802 and a portion, illustrated as a leg 822, of the first accessory 820a or the second accessory 820b.

The mounting assembly 800 can couple to any number of tubes of the bank of tubes 512. The mounting assembly 800 can be used with or independently of a tube spacing and fastening system, illustrated as the tube spacing and fastening system 600.

The mounting assembly 800 provides an off-case component mounting assembly. That is, the mounting assembly 800 mounts components (i.e., first accessory 820a and second accessory 820b) in a way that they are spaced from the compressor casing 210, the combustor casing 212, and the one or more turbine casing(s) 214 (FIG. 8). The mounting assembly 800 can provide an off-case component mounting using underlying fluid distribution systems (i.e., tubes, ducts, manifolds, bank of exemplary tubes 512).

The platform 802 can be mounted on the underlying fluid distribution systems (i.e., bank of exemplary tubes 512) by means of any number of integral or removable mounting members, which facilitates installation/removal of the platform 802 and components (i.e., the first accessory 820a, the second accessory 820b).

The mounting assembly 800 controls the position, location and orientation of the platform 802, the first accessory 820a, and the second accessory 820b. The mounting assembly 800 maintains the platform 802, the first accessory 820a, and the second accessory 820b in the intended position/location under operational loads.

The bank of exemplary tubes 512 and the platform 802 can be used to provide shielding from engine case heat and radiation. It is contemplated that dedicated fluid cooling or integral insulation can be coupled to or included in the mounting assembly 800. The dedicated fluid cooling or integral insulation can be used to control the environment of at least the first accessory 820a or the second accessory 820b.

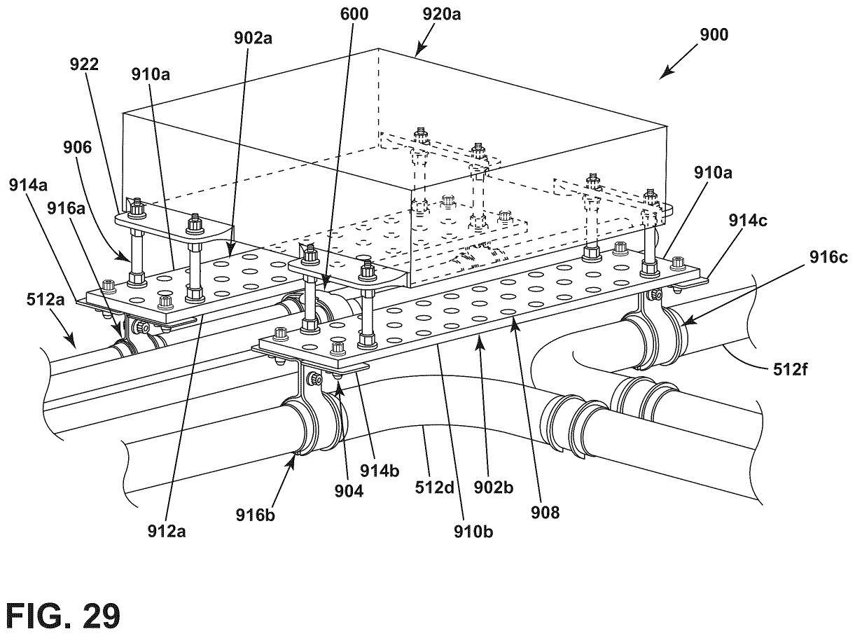

FIG. 29 illustrates another mounting assembly 900 for use in the core cowl 122 (FIG. 4) or the fan cowl 170 (FIG. 4) of the unducted turbine engine 100 (FIG. 4). The mounting assembly 900 is similar to the mounting assembly 800 (FIG. 28), therefore, like parts will be identified with like names with it being understood that the description of the mounting assembly 800 applies to the mounting assembly 900 unless noted otherwise.

The mounting assembly 900 includes a first platform 902a, a second platform 902b, a first set of fasteners 904, and a second set of fasteners 906. The first platform 902a and the second platform 902b include a plurality of apertures 908.

The first set of fasteners 904 couples the first platform 902a and the second platform 902b to one or more portions of the engine 100 (FIG. 4). As illustrated, the first platform 902a couples to a first tube clamp 916a. The first tube clamp 916 contacts a second surface 912a of the first platform 902a. The first tube clamp 916a extends to and is coupled with the exemplary tube 512a of the bank of exemplary tubes 512. A subset of the first set of fasteners 904 couples a first set of wings 914a of the first tube clamp 916a to the first platform 902a.

A second tube clamp 916b couples to another tube 512d and extends to couple to the second platform 902b. A subset of the first set of fasteners 904 couples a second set of wings 914b of the second tube clamp 916b to the second platform 902b. The third tube clamp 916c couples to yet another tube 512f. A subset of the first set of fasteners 904 couples a third set of wings 914c of the third tube clamp 916c to the second platform 902b. It is contemplated that any number of tube clamps can couple to one or more platform(s).

The second set of fasteners 906 couples the first accessory 920a to the first platform 902a and the second platform 902b. Unlike the second fasteners 806 (FIG. 28), the second set of fasteners 906 of the mounting assembly 900 can space the surface of the first accessory 920a from at least one of the first surfaces 910a of the first platform 902a or the first surface 910b of the second platform 902b.

The second set of fasteners 906 can pass through a receiving portion 922 of the first accessory 920a to couple the first accessory 920a to the first platform 902a and the second platform 902b.

The mounting assembly 900 can couple to any number of tubes. The mounting assembly 900 can be used with or independent of a tube spacing and fastening system, illustrated as the tube spacing and fastening system 600.

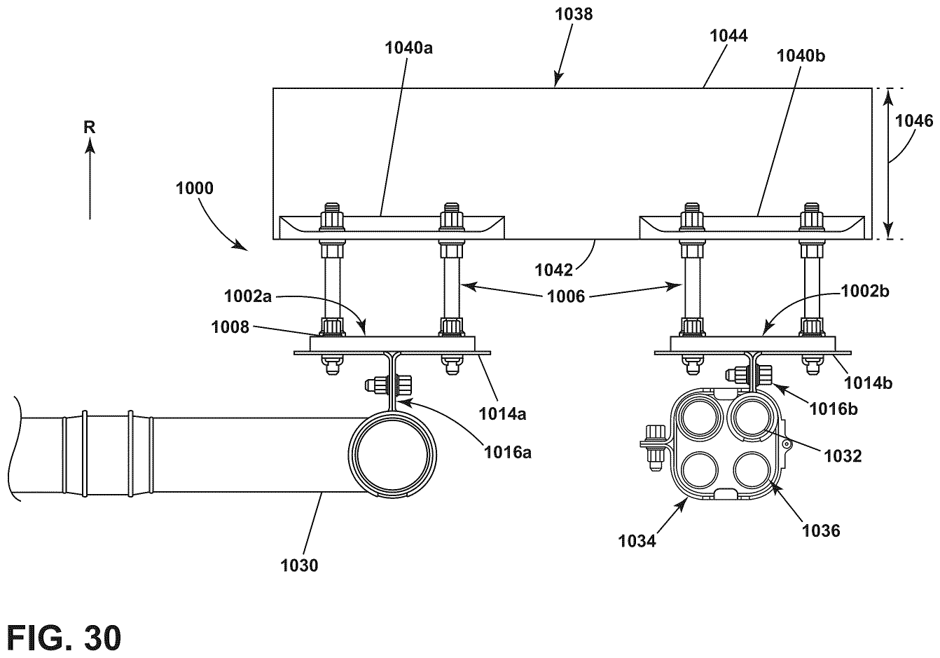

FIG. 30 illustrates another mounting assembly 1000 for use in the core cowl 122 (FIG. 4) or the fan cowl 170 (FIG. 4) of the unducted turbine engine 100 (FIG. 4). The mounting assembly 1000 is similar to the mounting assembly 800 (FIG. 28), 900 (FIG. 29), therefore, like parts will be identified with like names with it being understood that the description of the mounting assembly 800, 900 applies to the mounting assembly 1000 unless noted otherwise.

The mounting assembly 1000 includes a first platform 1002a, a second platform 1002b, and a set of fasteners 1006. The first platform 1002a and the second platform 1002b include a plurality of apertures 1008.

The first platform 1002a couples to a first tube 1030 via a first set of wings 1014a of the first tube clamp 1016a. Optionally, the tube clamp 1016a can be welded or otherwise coupled to the first platform 1002a.

The second platform 1002b couples to a second tube 1032 via a second set of wings 1014b of the second tube clamp 1016b. The second tube clamp 1016b can abut or be included in a tube binding system 1034. The tube binding system 1034 extends circumferentially around a bank of exemplary tubes 1036, as well as between adjacent tubes of the bank of exemplary tubes 1036.

The set of fasteners 1006 couples the first platform 1002a and the second platform 1002b to an engine accessory 1038. As illustrated, by way of example, the set of fasteners 1006 can pass through a portion of the engine accessory 1038 illustrated as protrusions 1040a, 1040b.

The engine accessory 1038 can have a radially inner surface 1042 and a radially outer surface 1044. An engine accessory length 1046 is measured from the radially inner surface 1042 to the radially outer surface 1044 in the radial direction R.

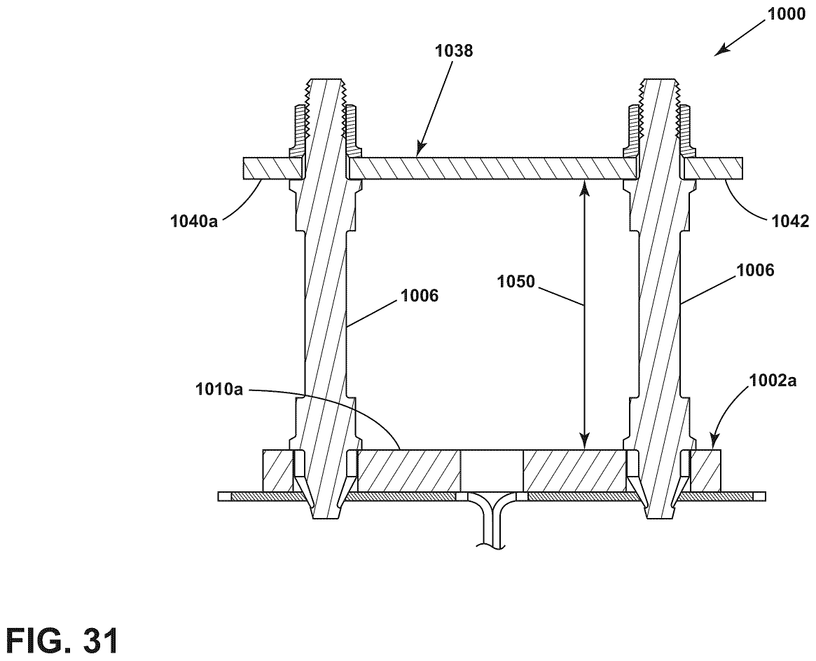

FIG. 31 illustrates a cross section of a portion of the mounting assembly 1000, further illustrating the coupling of the first platform 1002a to the protrusion 1040a of the engine accessory 1038 by a subset of the set of fasteners 1006.

A gap distance 1050 is measured from a first surface 1010a of the first platform 1002a to the protrusion 1040a or a radially inner surface 1042 of the engine accessory 1038. The gap distance 1050 is in a range of 1%-1000% of the engine accessory length 1046. For example, the gap distance 1050 can be in a range of 1%-100%. By way of further example, the gap distance 1050 can be in a range of 10%-150%. The gap distance 1050 balances the benefit of space between the core casings and a compact configuration.

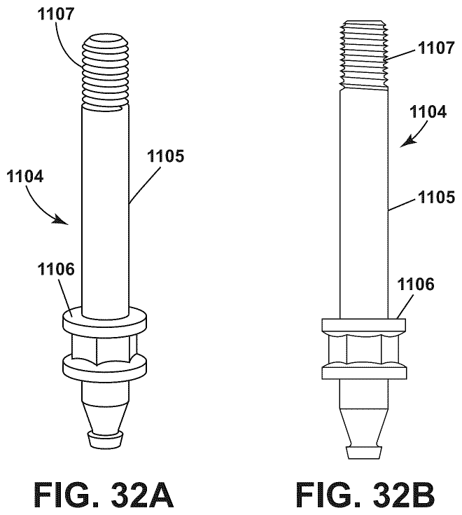

FIG. 32A is a perspective view of a fastener 1104 and FIG. 32B is a side view of the fastener 1104. The fastener 1104 can be a fastener of the first set of fasteners 804 (FIG. 28), 904 (FIG. 29) that couples the platform 802 (FIG. 28), 902 (FIG. 29) to one or more portions of the engine 100 (FIG. 4). The fastener 1104 has a body portion 1105 that can confront or be in contact with one or more portions of the inner surface of the platform 802, 902. The body portion 1105 can confront or be in contact with an inner surface of one of the set of wings 814 (FIG. 28), 914 (FIG. 29).

The fastener 1104 is a direct-mount fastener. As used herein, the term “direct-mount fastener” is defined as a fastener that brings two surfaces together along a body portion of the fastener. That is, a portion of the set of wing 814, 914 and a portion of the platform 802, 902 are in contact along the body portion 1105 when fastened with the fastener 1104.

A shelf or a stop 1106 can limit movement of one of the elements being fastened. The stop 1106 can provide a base on which one of the elements being fastened can rest. A securing portion, illustrated as a threaded portion 1107, allows for the fastener 1104 to receive a removable device such as, but not limited to, a lock nut, hex nut, wing nut, pin, or other known securing device.

When used in the mount assembly 800 (FIG. 28), 900 (FIG. 29), 1000 (FIG. 30), the fastener 1104 passes through two or more objects. A first object rests at the stop 1106. When the securing device is applied at the securing portion, illustrated as the threaded portion 1107, the two or more objects are selectively coupled via the fastener 1104.

It is further contemplated that the fastener 1104 can be a fastener of the second set of fasteners 806 (FIG. 28) that direct-mounts the platform 802 to the first accessory 820a, the second engine accessory 820b, or both.

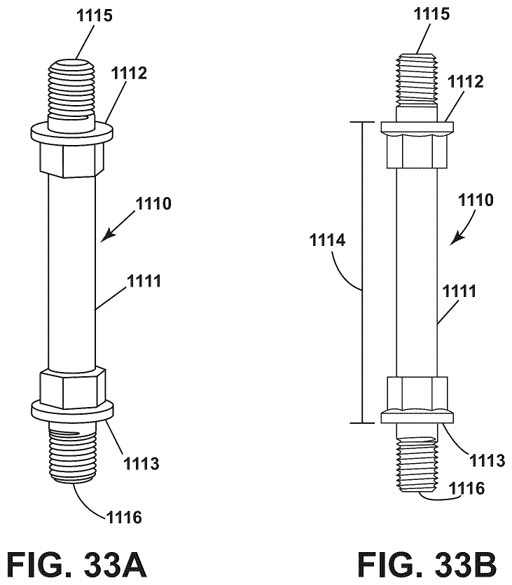

FIG. 33A is a perspective view of a fastener 1110 and FIG. 33B is a side view of the fastener 1110. The fastener 1110 can be a fastener of the second set of fasteners 906 (FIG. 29), 1006 (FIG. 30) that couples the platform 902a (FIG. 29), 902b (FIG. 29), 1002a (FIG. 30), 1002b (FIG. 30) and corresponding engine accessory 920a (FIG. 29), 1038 (FIG. 30).

The fastener 1110 has a body portion 1111 that extends between a first shelf 1112 and a second shelf 1113. The fastener 1110 is a spacer-mount fastener. As used herein, term “spacer-mount fastener” is defined as a fastener that anchors for fixes at least two objects together at a distance fixed by a portion of the fastener. That is, the fastener 1110 secures the engine accessory (i.e., the engine accessory 920a (FIG. 29), the engine accessory 1038 (FIG. 30)) to the platform (i.e., the platform 902a, 902b, 1002a, 1002b) where the engine accessory is spaced from the platform a predetermined distance equal to a length 1114 of the body portion 1111 measured from the first shelf 1112 to the second shelf 1113.

The fastener 1110 can include a first threaded portion 1115 and a second threaded portion 1116. The first threaded portion 1115 and the second threaded portion 1116, allow the fastener 1110 to receive a removable device such as, but not limited to, a lock nut, hex nut, wing nut, pin, or other known securing device.

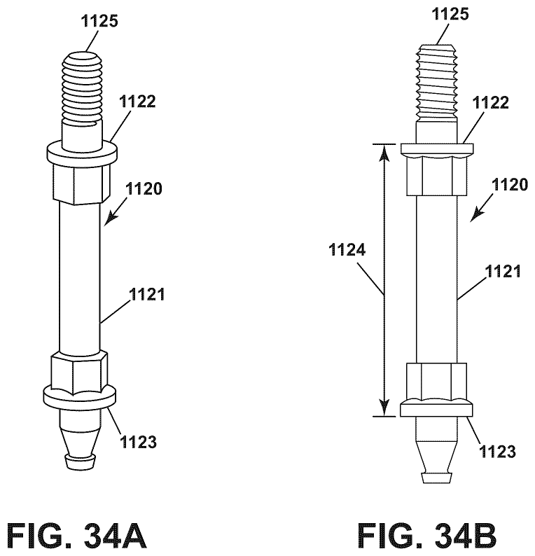

FIG. 34A is a perspective view of a fastener 1120 and FIG. 34B is a side view of the fastener 1120. The fastener 1120 can be a fastener of the second set of fasteners 906 (FIG. 29), 1006 (FIG. 30) that couples the platform 902a (FIG. 29), 902b (FIG. 29), 1002a (FIG. 30), 1002b (FIG. 30) and corresponding engine accessory 920a (FIG. 29), 1038 (FIG. 30).

The fastener 1120 has a body portion 1121 that extends between a first shelf 1122 and a second shelf 1123. The fastener 1120 is a spacer-mount fastener similar to the fastener 1110 (FIG. 33A). The fastener 1120 secures the engine accessory (i.e., the engine accessory 920a, the engine accessory 1038 (FIG. 29, FIG. 30)) to the platform (i.e., the platform 902a, 902b, 1002a, 1002b) where the engine accessory is spaced from the platform a predetermined distance equal to a length 1124 of the body portion 1121 measured from the first shelf 1122 to the second shelf 1123.

The fastener 1120 can include a threaded portion 1125 that allows the fastener 1120 to receive a removable device such as, but not limited to, a lock nut, hex nut, wing nut, pin, or other known securing device. While illustrated in FIG. 32A-34B as a nut/bolt threaded fastener, the fasteners can be a flower petal type interlocking mounting arrangement, a pitch circle diameter (PCD) wobble bolts, or rotational clamps. The fasteners in FIG. 32A-34B can be semi-permanent (fixed on one side) or removable from one or both ends.

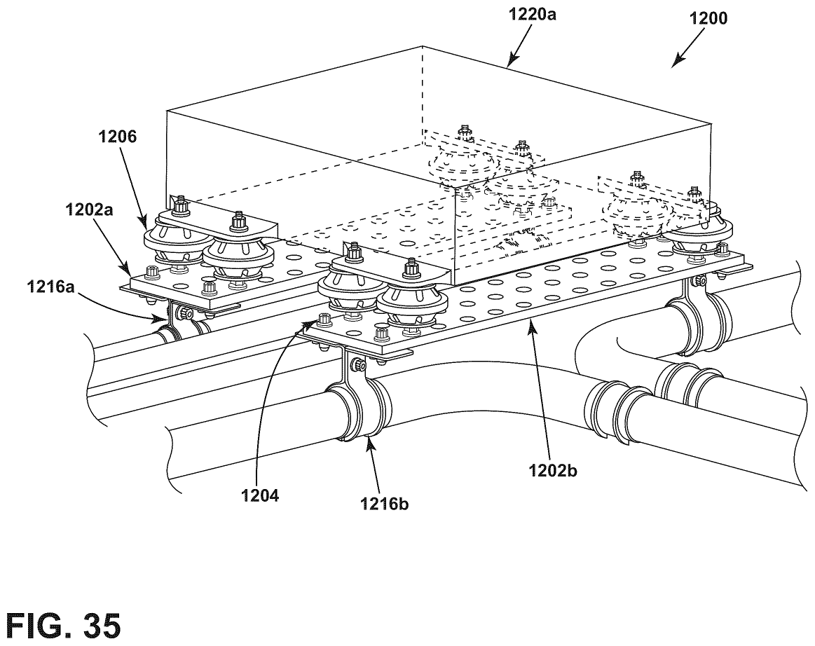

FIG. 35 illustrates a mounting assembly 1200. The mounting assembly 1200 is similar to the mounting assembly 900 (FIG. 29), therefore, like parts will be identified with like names with it being understood that the description of the mounting assembly 900 applies to the mounting assembly 1200 unless noted otherwise. The mounting assembly 1200 includes a first platform 1202a, a second platform 1202b, a first set of fasteners 1204, and a second set of fasteners illustrated as a set of vibration isolators 1206.

The first set of fasteners 1204 couples the first platform 1202a and the second platform 1202b to one or more portions of the engine 100 (FIG. 4). As illustrated, the first platform 1202a couples to at least a first tube clamp 1216a by a subset of first fasteners of the first set of fasteners 1204. Another subset of the first set of fasteners 1204 couples at least a second tube clamp 1216b to the second platform 1202b.

The set of vibration isolators 1206 couple a first accessory 1220a to the first platform 1202a and the second platform 1202b. The set of vibration isolators 1206 improve a vibratory response of the mounting assembly 1200. Any number of vibration isolators are considered in the set of vibration isolators 1206, including one. The number and location of the isolators in the set of vibration isolators 1206 depends on a load (i.e., size of the first accessory 1220a) and a vibratory input to the mounting assembly 1200, among other variables. The set of vibration isolators 1206 can be made of elastomeric, metallic, composite or a combination thereof.

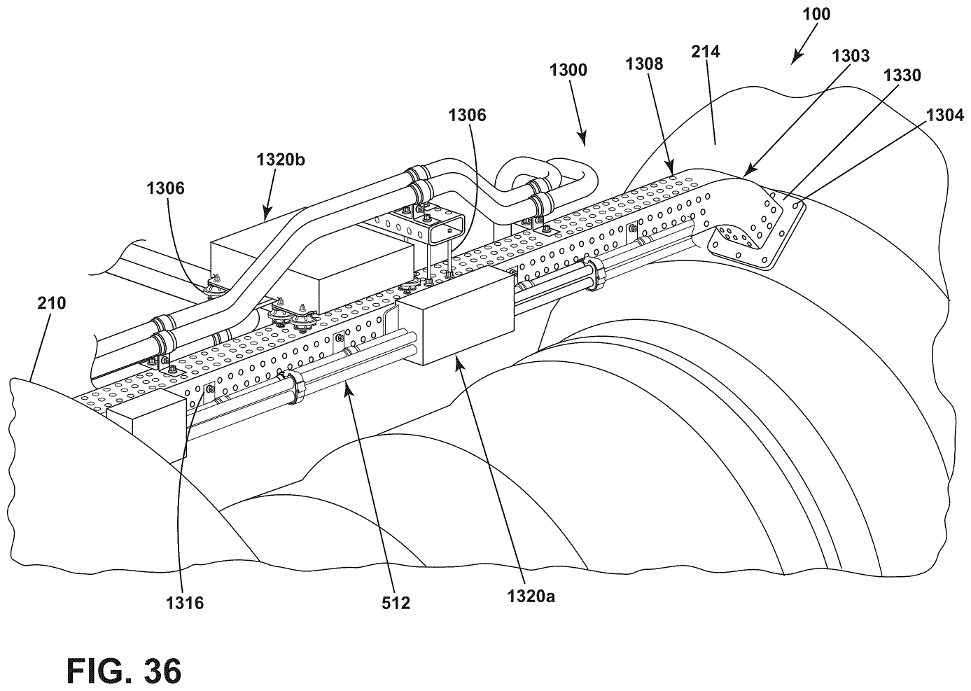

FIG. 36 illustrates a mounting assembly 1300. The mounting assembly 1300 is similar to the mounting assembly 800 (FIG. 28), 900 (FIG. 29), 1000 (FIG. 30), 1200 (FIG. 35); therefore, like parts will be identified with like names with it being understood that the description of the mounting assembly 800, 900, 1000, 1200 applies to the mounting assembly 1300 unless noted otherwise. The mounting assembly 1300 includes a box platform 1303, a first set of fasteners 1304, and a second set of fasteners 1306.

As illustrated, by way of example, the box platform 1303 includes at least three surfaces. The at least three surfaces each include a plurality of apertures 1308 extending therethrough. The box platform 1303 can be shaped as a box, a duct, a beam or a channel. The shaping of the box platform 1303 allows for a variation in mounting orientations for accessories. As a non-limiting example, the shaping of the box platform 1303 can be varied to mount accessories in at least one of a vertical orientation, an angled orientation, or in a horizontal orientation along one or more horizontal walls of the box platform 1303.

As illustrated, by way of example, the box platform 1303 extends from a base 1330. The base 1330 is coupled to the turbine casing 214 to the compressor casing 210. It will be appreciated, however, that other mounting configurations within the core cowl 122 (FIG. 8) with any number support structures are contemplated.

The first set of fasteners 1304 couples the box platform 1303 to one or more portions of the engine 100. The box platform 1303 can be coupled to or be formed with the base 1330 which can provide support when mounting to the casing, illustrated as the turbine casing 214.

It is contemplated that the exemplary tubes 512 can be coupled to the box platform 1303 via one or more tube clamps 1316. Put another way, the box platform 1303 can be coupled to any number of one or more tubes, ducts, or any combination thereof through use of the one or more tube clamps 1316.

By way of non-limiting example, a first accessory 1320a can be in contact or direct-mounted to the box platform 1303 by a subset of fasteners of the second set of fasteners 1306. A second accessory 1320b can be mounted to the box platform 1303 by another subset of fasteners of the second set of fasteners 1306 illustrated as a set of vibration isolators. A secondary platform 1302 can be mounted to and spaced from the box platform 1303 by yet another subset of fasteners of the second set of fasteners 1306. The mounting assembly 1300 can further include any number of additional fasteners, platforms, or combination thereof.

The box platform 1303 can include various materials. By way of non-limiting example, the box platform 1303 can include various materials such as elastomeric materials, metallic materials, composite materials, or any combination thereof. The box platform 1303 can include dedicated cooling, heating, or insulation as needed.

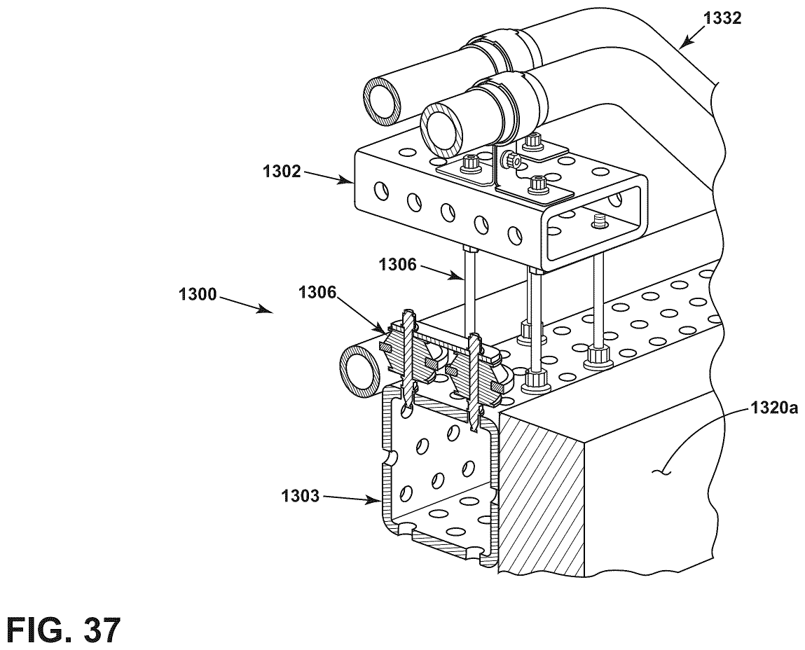

FIG. 37 is a cross section of a portion of the mounting assembly 1300 of FIG. 36 further illustrating the second set of fasteners 1306. By way of non-limiting example, the second set of fasteners 1306 include both vibration isolators and space-mounting fasteners that secure two objects that without the objects making direct contact. The first accessory 1320a is direct-mounted to the box platform 1303. The secondary platform 1302 can be used to support various tubes 1332, as illustrated. However, it is contemplated that one or more engine accessories can also be mounted to the secondary platform 1302.

While illustrated, by way of example, as solid, one or more of the vibration isolators can include multiple materials, layers, hollow portions, or any combination thereof. The vibration isolators can be any material or object designed to minimize transmission of vibrations and/or noise.

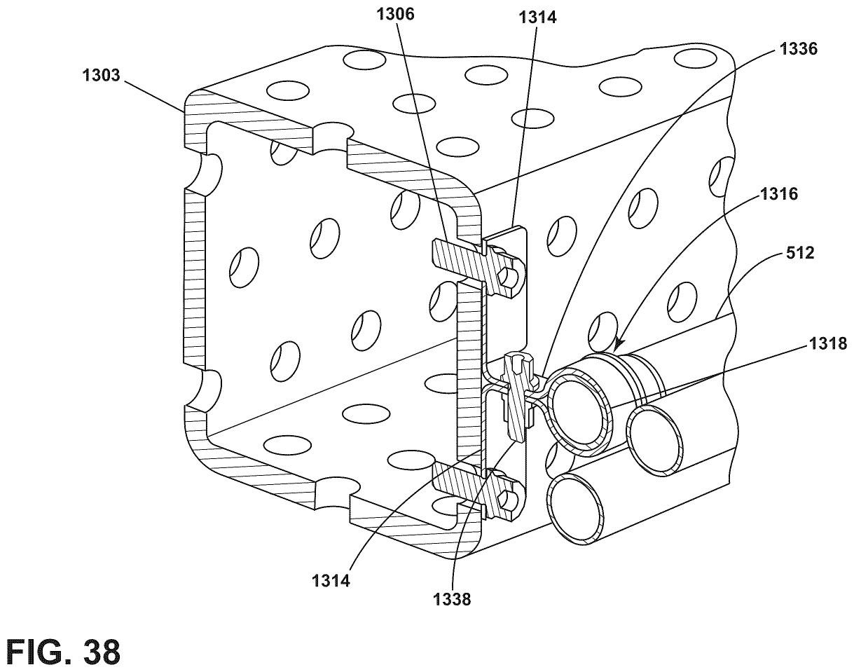

FIG. 38 is a cross section of a portion of the mounting assembly 1300 of FIG. 36 further illustrating the tube clamp 1316. The tube clamp 1316 can include an annular portion 1318 that circumscribes the exemplary tube 512a. The annular portion 1318 can extend into a clamping portion 1336 through which a clamp fastener 1338 passes to secure the annular portion 1318 about the exemplary tube 512a. Wings 1314 extend from the clamping portion 1336 and contact the box platform 1303. A subset of the second set of fasteners 1306 pass through and secure the set of wings 1314 to the box platform 1303. As such, the set of wings 1314 can be directly mounted to the box platform 1303.

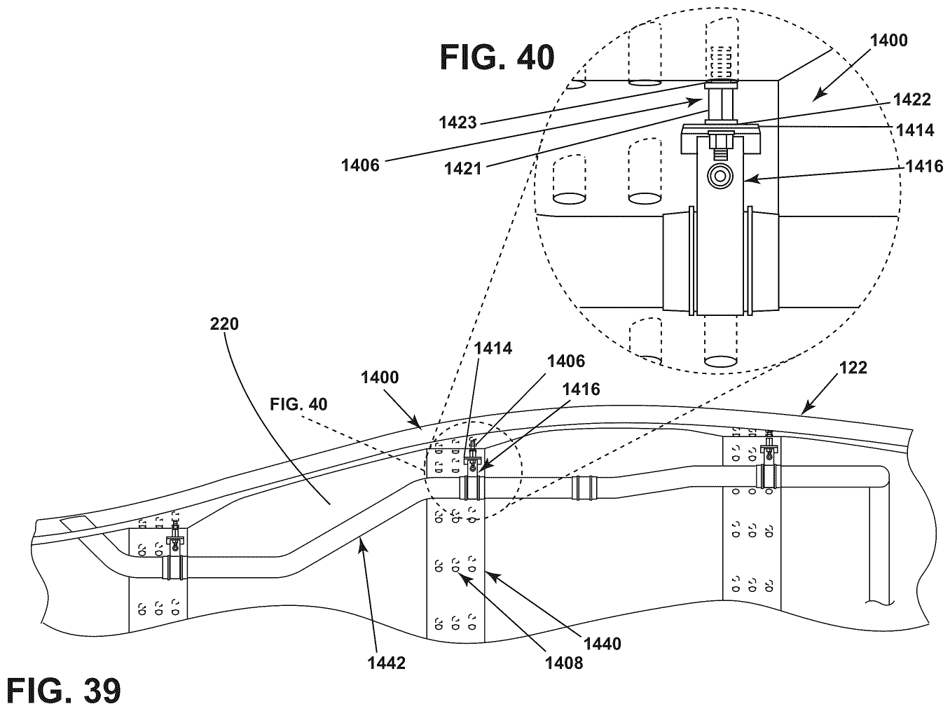

FIG. 39 illustrates a mounting assembly 1400. The mounting assembly 1400 includes a cowl platform 1440 coupled to the inner surface 220 of the core cowl 122. While illustrated at the inner surface 220 of the core cowl 122, it is contemplated that the mounting assembly 1400 or mounting assemblies similar to mounting assembly 1400 can be coupled to an inner surface of the fan cowl 170 (FIG. 8).

The mounting assembly 1400 can include any number of cowl platforms 1440 coupled to the inner surface 220 of the core cowl 122. The cowl platforms 1440 can circumscribe the inner surface 220 or be segmented. That is, the cowl platforms 1440 can be an annular platform or be an arcuate platform located along portions of the inner surface 220 of the core cowl 122.

The cowl platforms 1440 can be integrally formed or coupled to the inner surface 220. By way of non-limiting example, an exemplary tube 1442 is coupled to the cowl platforms 1440 via a tube clamp 1416 and fasteners 1406. The fasteners 1406 can pass through the set of wings 1414 and apertures 1408 in the cowl platform 1440, similar to that of the second platform 1202b (FIG. 35). It is contemplated that any number or combination of components, tubes, ducts, or bundles can be directly supported from the cowl platform 1440. The components, tubes, ducts, bundles or any combination thereof can be mounted using removable or fixed brackets, fasteners, or any combination thereof.

FIG. 40 is an enlarged view of a portion of the mounting assembly 1400 of FIG. 39 further the fastener 1406 coupling the cowl platform 1440 with the wing 1414 of the tube clamp 1416. The fastener 1406 includes a body portion 1421 that extends from the first shelf 1422 in direct contact with the wing 1414 to the second shelf 1423 in direct contact with the cowl platform 1440 (FIG. 39). Mounting from the cowling allows additional distance from the engine case heat.

Aspects of the mounting assemblies herein can be interchanged or combined. Additional platforms or components layers can be mounted from the base or original platform. The layered architecture of various mounting assemblies improves accessibility to components for maintenance/replacement purposes.

It is contemplated that any combination of the fastener assemblies, the mounting assemblies, or combination thereof can be located in the core cowl or the fan cowl, or combination thereof.

Benefits of the fastener assemblies, the mounting assemblies, or combinations of fastener assemblies and the mounting assemblies can include a compact configuration of engine accessories and other components within the core cowl, the fan cowl, or both.

The mounting platforms and fasteners allows effective space utilization and allows engine component, ducts, etc. spaced from the engine casing while minimizing the axial length of the unducted turbine engine.

The mounting platforms and fasteners allows effective space utilization and allow engine component that do not normally axially overlap the combustor section and/or the turbine section to be located on platforms that thermally isolate engine accessories This flexibility in locating engine accessories, ducts, etc. at spaced locations from the engine casing maintain aerodynamics of the core cowl and the fan cowl while minimizing the axial length of the unducted turbine engine.

The mounting assemblies disclosed herein allow for easy removal and placement of components and supporting tight packaging in a vertical multi-layer manner (i.e., on underlying tubes/ducts/harnesses).

This written description uses examples to disclose the present disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine defining an axial direction and a radial direction, the gas turbine engine comprising a turbomachine having an unducted primary fan, a core engine including a combustor and a combustor casing enclosing the combustor and defining an outer surface, and a core cowl surrounding at least a portion of the core engine and defining an inner surface and an outer surface. Wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction, wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L), and wherein the CDR is between 2.7 and 3.5 and wherein the CLR is between 0.25 and 0.50.

The gas turbine engine of the preceding clause, wherein the CDR is between 2.8 and 3.3.

The gas turbine engine of any preceding clause, wherein the CLR is between 0.3 and 0.45.

The gas turbine engine of any preceding clause, wherein the CLR is between 0.40 and 0.45.

The gas turbine engine of any preceding clause, wherein a void is defined between the outer surface of the combustor casing and the inner surface of the core cowl.

The gas turbine engine of any preceding clause, further comprising at least one engine accessory coupled to the inner surface of the core cowl.

The gas turbine engine of any preceding clause, further comprising a rear frame including a strut having a trailing edge, wherein the primary fan includes a primary fan blade having a leading edge, and wherein the overall core axial length (L) along the axial direction is measured from the leading edge of the primary fan blade to the trailing edge of the strut.

The gas turbine engine of any preceding clause, further comprising a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The gas turbine engine of any preceding clause, further comprising a ducted secondary fan disposed downstream from the primary fan.

The gas turbine engine of any preceding clause, wherein the ducted secondary fan is a single stage secondary fan.

The gas turbine engine of any preceding clause, wherein the gas turbine engine is a three-stream gas turbine engine.

An aircraft, comprising a wing and a gas turbine engine mounted to the wing, the gas turbine engine defining an axial direction and a radial direction, the gas turbine engine comprising: a turbomachine having an unducted primary fan, a core engine including a combustor and a combustor casing enclosing the combustor and defining an outer surface, a core cowl surrounding at least a portion of the core engine and defining an inner surface and an outer surface. Wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction. Wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L). Wherein the CDR is between 2.7 and 3.5 and wherein the CLR is between 0.25 and 0.50.

The aircraft as in the preceding clause, wherein the CDR is between 2.8 and 3.3.

The aircraft of any preceding clause, wherein the CLR is between 0.3 and 0.45.

The aircraft of any preceding clause, wherein the CLR is between 0.40 and 0.45.

The aircraft of any preceding clause, wherein a void is defined between the outer surface of the combustor casing and the inner surface of the core cowl of the gas turbine engine, and wherein at least one engine accessory is coupled to the inner surface of the core cowl.

The aircraft of any preceding clause, wherein the gas turbine engine further comprises a rear frame including a strut having a trailing edge, wherein the primary fan includes a plurality of primary fan blades where each primary fan blade has a leading edge, and wherein the overall core axial length (L) along the axial direction is measured from a leading edge of a respective primary fan blade of the plurality of primary fan blades to the trailing edge of the strut.

The aircraft of any preceding clause, wherein the gas turbine engine further comprises a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The aircraft of any preceding clause, the gas turbine engine further comprising a ducted secondary fan disposed downstream from the unducted primary fan.

A gas turbine engine, comprising: a core engine; a core cowl at least partially encasing a portion of the core engine, the core cowl having an inner surface and defining in part a void is between the inner surface and the core engine, the core cowl moveable relative to the core engine; and an engine component selectively coupled to the core engine or the core cowl.

The gas turbine engine of the preceding clause, wherein the core cowl is pivotable relative to the core engine.

A gas turbine engine, comprising a turbomachine and a housing at least partially encasing a portion of the turbomachine, the housing having an inner surface and defining in part a void between the inner surface and the portion of the turbomachine, the housing moveable relative to the portion of the turbomachine; and an engine component selectively coupled to the portion of the turbomachine or to the housing.

The gas turbine engine of the preceding clause, wherein the turbomachinery comprises a core engine, the housing comprises a core cowl at least partially encasing a portion of the core engine, the core cowl having an inner surface and defining in part a void between the inner surface and the core engine, wherein the core cowl is moveable relative to the core engine, and an engine component selectively coupled to the core engine or the core cowl, and wherein the core cowl is pivotable relative to the core engine.

The gas turbine engine of any preceding clause, wherein when the engine component is selectively coupled to the core cowl, the engine component travels with the core cowl when the core cowl is moved away from the core engine.

The gas turbine engine of any preceding clause, wherein the engine component is one of a heat exchanger, a sensor, a controller, a pump, a duct, a fire and overheat component, a generator, or a valve.

The gas turbine engine of any preceding clause, further comprising: a fastener, wherein the engine component is selectively connected to the core engine or the core cowl via the fastener.

The gas turbine engine of any preceding clause, wherein the core cowl defines an access opening, wherein the fastener is accessible through the access opening.

The gas turbine engine of any preceding clause, wherein the fastener includes a plurality of articulating tabs, wherein in a first position the plurality of articulating tabs engages with the core engine and the engine component and in a second position the plurality of tabs engages with the core cowl and the engine component.

The gas turbine engine of any preceding clause, further comprising a push-pull mechanism including a first pin, wherein the engine component is selectively coupled to the core engine or the core cowl via the push-pull mechanism, wherein the first pin engages with the core engine and the engine component when the push-pull mechanism is in a first position, and the first pin engages with the engine component and the core cowl when the push-pull mechanism is in a second position.

The gas turbine engine of any preceding clause, wherein the push-pull mechanism is manually actuated between the first position and the second position.

The gas turbine engine of any preceding clause, wherein the push-pull mechanism is electrically actuated between the first position and the second position.

The gas turbine engine of any preceding clause, wherein the push-pull mechanism includes a second pin, wherein the second pin engages with a door counterbalance mechanism when the first pin is engaged with the engine component and the core cowl.

The gas turbine engine of any preceding clause, wherein the gas turbine engine includes an unducted primary fan.

The gas turbine engine of any preceding clause, further comprising a ducted secondary fan disposed downstream from the primary fan, wherein the ducted secondary fan is a single stage secondary fan or a multi-stage secondary fan.

An aircraft, comprising a core engine and a core cowl at least partially encasing a portion of the core engine. The core cowl having an inner surface, wherein a void is defined between the inner surface and the core engine, wherein the core cowl is pivotally mounted to the gas turbine engine, and an engine component selectively coupled to the core engine or the core cowl.

The aircraft as in the preceding clause, wherein the engine component is selectively coupled to the core cowl, and wherein the engine component travels with the core cowl when the core cowl is pivoted away from the core engine.

The aircraft of any preceding clause, wherein the engine component is one of a heat exchanger, a sensor, a controller, a pump, a duct, a fire and overheat component, a generator, or a valve.

The aircraft of any preceding clause, wherein the engine component is selectively coupled to the core engine or the core cowl via a fastener, wherein the fastener is accessible from outside of the core cowl, wherein the fastener includes a plurality of articulating tabs, and wherein in a first position the plurality of articulating tabs engages with the core engine and the engine component, and in a second position the plurality of articulating tabs engages with the core cowl and the engine component.

The aircraft of any preceding clause, wherein the engine component is selectively coupled to the core engine or the core cowl via a push-pull mechanism including a first pin, wherein the first pin engages with the core engine and the engine component when the push-pull mechanism is in a first position, and the first pin engages with the engine component and the core cowl when the push-pull mechanism is in a second position.

The aircraft of any preceding clause, wherein the push-pull mechanism is manually actuated between the first position and the second position.

The aircraft of any preceding clause, wherein the push-pull mechanism includes a second pin, wherein the second pin engages with a door counterbalance mechanism when the first pin is engaged with the core cowl and the engine component.

The aircraft of any preceding clause, wherein the engine component is selectively connected to the core engine or the core cowl via a push-pull mechanism including a first pin, wherein the first pin engages with the core engine and the engine component when the push-pull mechanism is in a first position, and the first pin engages with the engine component and the core cowl when the push-pull mechanism is in a second position, wherein the push-pull mechanism is manually actuatable between the first position and the second position.

The aircraft of any preceding clause, wherein the gas turbine engine includes a ducted primary fan.

The gas turbine engine of any preceding clause, wherein the engine component is positioned within the core cowl.

The gas turbine engine of any preceding clause, wherein the engine component is one of a heat exchanger, a sensor, a controller, a pump, a duct, a fire and overheat component, a generator, or a valve.

The gas turbine engine of any preceding clause, wherein the engine component is an engine controller.

The gas turbine engine of any preceding clause, wherein the engine component is power electronics, a lubrication oil tank, a lubrication oil pump, an electric machine, or a combination thereof.

The gas turbine engine of any preceding clause, wherein the gas turbine engine is incorporated into an aircraft configured to cruise at an altitude between 28,000 feet and 65,000 feet.

The gas turbine engine of any preceding clause, wherein the gas turbine engine is configured to generate at least 18,000 pounds of thrust and less than 80,000 pounds of thrust when operated at a rated speed during standard day operating conditions.

A gas turbine engine defining an axial direction, the gas turbine engine comprising: a turbomachine having a primary fan, a core engine, and a core cowl surrounding at least a portion of the core engine, the turbomachine defining an under-core cowl axial length (L1) along the axial direction and an initial compression axial length (L2), the core engine comprising a gearbox, the primary fan being drivingly coupled to the core engine across the gearbox; wherein the gas turbine engine is configured to generate at least 18,000 pounds of thrust and less than 80,000 pounds of thrust when operated at a rated speed during standard day operating conditions, wherein the turbomachine defines an initial compression length ratio (ICLR) equal to the initial compression axial length (L2) divided by the under-core cowl axial length (L1), wherein the ICLR is greater than or equal to 0.55 and less than or equal to 0.9.

A gas turbine engine defining an axial direction, the gas turbine engine comprising: a turbomachine having a primary fan, a core engine, and a core cowl surrounding at least a portion of the core engine, the turbomachine defining an under-core cowl axial length (L1) along the axial direction and an initial compression axial length (L2), the core engine comprising a gearbox and a turbine section having a low-pressure turbine, the primary fan being drivingly coupled to the low-pressure turbine across the gearbox; wherein the low-pressure turbine comprises at least a total of four stages of low-pressure turbine rotor blades and up to six stages of low-pressure turbine rotor blades; wherein the turbomachine defines an initial compression length ratio (ICLR) equal to the initial compression axial length (L2) divided by the under-core cowl axial length (L1), wherein the ICLR is greater than or equal to 0.3 and less than or equal to 0.9.

A gas turbine engine defining an axial direction, the gas turbine engine comprising: a turbomachine having a primary fan, a core engine, and a core cowl surrounding at least a portion of the core engine, the turbomachine defining an under-core cowl axial length (L1) along the axial direction and an initial compression axial length (L2), the core engine comprising a gearbox having a gear ratio greater than or equal to 3.2:1 and less than or equal to 14:1, the primary fan being drivingly coupled to the core engine across the gearbox; wherein the turbomachine defines an initial compression length ratio (ICLR) equal to the initial compression axial length (L2) divided by the under-core cowl axial length (L1), wherein the ICLR is greater than or equal to 0.3 and less than or equal to 0.9.

A gas turbine engine defining an axial direction, the gas turbine engine comprising: a turbomachine having a primary fan, a core engine, and a core cowl surrounding at least a portion of the core engine, the core engine comprising a high-pressure compressor comprising at least a total of eight stages of high-pressure compressor rotor blades and up to a total of 11 stages of high-pressure compressor rotor blades, the core engine further comprising a gearbox, the primary fan being drivingly coupled to the core engine across the gearbox; wherein the turbomachine defines an under-core cowl axial length (L1) along the axial direction and an initial compression axial length (L2), wherein the turbomachine defines an initial compression length ratio (ICLR) equal to the initial compression axial length (L2) divided by the under-core cowl axial length (L1), wherein the ICLR is greater than or equal to 0.3 and less than or equal to 0.9.

The gas turbine engine of any preceding clause, wherein the ICLR is greater than or equal to 0.55 and less than or equal to 0.9.

The gas turbine engine of any preceding clause, wherein the ICLR is greater than or equal to 0.6 and less than or equal to 0.89.

The gas turbine engine of any preceding clause, wherein the primary fan is an unducted primary fan, and wherein the ICLR is greater than or equal to 0.7.

The gas turbine engine of any preceding clause, wherein the turbomachine further includes a fan cowl and defines a fan duct between the fan cowl and the core cowl configured as a third stream, and wherein the ICLR is greater than or equal to 0.7.

The gas turbine engine of any preceding clause, further comprising a nacelle surrounding at least in part the primary fan, and wherein the ICLR is greater than or equal to 0.6 and less than or equal to 0.75.

The gas turbine engine of any preceding clause, wherein the gas turbine engine is a two stream engine, and wherein the ICLR is greater than or equal to 0.6 and less than or equal to 0.75.

The gas turbine engine of any preceding clause, wherein the core engine comprises a compressor section and a turbine section, wherein the compressor section has a high-pressure compressor comprising a total of eight to ten stages of high-pressure compressor rotor blades, and wherein the turbine section has a low-pressure turbine comprising a total of three to five stages of low-pressure turbine rotor blades.

The gas turbine engine of any preceding clause, wherein the gas turbine engine is configured to generate at least 18,000 pounds of thrust and less than 80,000 pounds of thrust when operated at a rated speed during standard day operating conditions.

The gas turbine engine of any preceding clause, wherein the gas turbine engine is configured to generate between 25,000 and 60,000 pounds of thrust during operation at the rated speed during standard day operating conditions.

The gas turbine engine of any preceding clause, wherein the high-pressure compressor comprises a total of nine stages.

The gas turbine engine of any preceding clause, wherein the low-pressure turbine comprises a total of four stages.

A gas turbine engine defining an axial direction and a radial direction, the gas turbine engine comprising: a turbomachine having an unducted primary fan, a core engine including a combustor and a combustor casing enclosing the combustor and defining an outer surface, a core cowl surrounding at least a portion of the core engine and defining an inner surface and an outer surface; and a fastener assembly or a mounting assembly located between the core engine and the core cowl or within a fan cowl; wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction, wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L), wherein the CDR is between 2.7 and 3.5 and wherein the CLR is between 0.25 and 0.50.

The gas turbine engine of any preceding clause, wherein the fastener assembly comprises: spacer element coupled to a plurality of tubular structures, wherein at least one tubular structure of the plurality of tubular structures is in contact with the spacer element; and a fastening element configured to extend around at least a portion of an outer surface of the plurality of tubular structures, and to fasten the plurality of tubular structures to the spacer element in an adaptively spaced configuration.

The gas turbine engine of any preceding clause, wherein the adaptively spaced configuration comprises a first length of the fastening element below a predetermined temperature range and a second length of the fastening element above the predetermined temperature range, the first length being different from the second length.

The gas turbine engine of any preceding clause, wherein the adaptively spaced configuration comprises a first configuration, the plurality of tubular structures are movably spaced around the spacer element and a second configuration, the plurality of tubular structures are immovably spaced around the spacer element.

The gas turbine engine of any preceding clause, wherein the spacer element comprises: a core part positioned at a center of the spacer element; and a plurality of radial arms arranged in a predetermined formation comprising a cross formation, or a star formation, or any combination thereof, wherein at least one pair of adjacent radial arms and the core part form a cradle bracket configured to engage a corresponding tubular structure in the cradle bracket.

The gas turbine engine of any preceding clause, wherein the mounting assembly comprises a platform, a first set of fasteners coupling the platform to the gas turbine engine, and a second set of fasteners coupling the platform to one or more engine accessory or tube.

The gas turbine engine of any preceding clause, wherein the platform includes a plurality of apertures.

The gas turbine engine of any preceding clause, wherein the second set of fasteners include vibration dampeners.

The gas turbine engine of any preceding clause, wherein the platform is a box platform extending between two portions of the core casing.

The gas turbine engine of any preceding clause, further comprising at least one fastener assembly comprising a spacer element and a fastening element, and at least one mounting assembly comprising a platform.

The gas turbine engine of any preceding clause, wherein the spacer element includes three radial arms.

The gas turbine engine of any preceding clause, wherein the three radial arms are arranged in a star formation.

The gas turbine engine of any preceding clause, wherein each radial arms includes a base that couples with a core part.

The gas turbine engine of any preceding clause, wherein the radial arms and the core part are formed as a single piece.

The gas turbine engine of any preceding clause, wherein the radial arms and the core part are formed as separate parts coupled or connected together.

The gas turbine engine of any preceding clause, wherein the radial arms are arranged in a star formation.

The gas turbine engine of any preceding clause, wherein the spacer element includes a pair of adjacent radial arms and the core part coupled to a base of each of the pair of adjacent radial arms.

The gas turbine engine of any preceding clause, wherein the pair of adjacent radial arms form a cradle bracket.

The gas turbine engine of any preceding clause, wherein the cradle bracket receives a tubular structure.

The gas turbine engine of any preceding clause, wherein the tubular structure is an outer surface of a tube.

The gas turbine engine of any preceding clause, wherein the spacer element includes two or more cradle brackets.

The gas turbine engine of any preceding clause, wherein the spacer element includes a shape memory alloy.

The gas turbine engine of any preceding clause, wherein the shape memory alloy includes one or more of Ni—Ti, or Ni—Ti—Hf, or Ni—Ti—Pd or Ti—Au—Cu.

The gas turbine engine of any preceding clause, wherein the mounting assembly is located in the core cowl.

The gas turbine engine of any preceding clause, wherein the mounting assembly is located in the fan cowl.

The gas turbine engine of any preceding clause, wherein the mounting assembly is located in the fan cowl.

The gas turbine engine of any preceding clause, wherein the mounting assembly includes a platform, a first set of fasteners, and a second set of fasteners.

The gas turbine engine of any preceding clause, wherein the platform includes a plurality of apertures, wherein the plurality of apertures extend from a first surface through the platform to a second surface opposite the first surface.

The gas turbine engine of any preceding clause, wherein the first set of fasteners couples the platform to one or more portions of the gas turbine engine.

The gas turbine engine of any preceding clause, wherein the first set of fasteners couples the platform to one or more portions of the engine casings located at the low-pressure compressor, the high-pressure compressor, the high-pressure turbine the low-pressure turbine or any combination thereof.

The gas turbine engine of any preceding clause, wherein the mounting assembly further comprises a tube clamp having a set of wings.

The gas turbine engine of any preceding clause, wherein the first set of fasteners extend through the platform and one or more portions of the set of wings.

The gas turbine engine of any preceding clause, wherein the first set of fasteners couples the set of wings of the tube clamp to the platform.

The gas turbine engine of any preceding clause, wherein the set of wings of the tube clamp extend from an annular portion of the tube clamp.

The gas turbine engine of any preceding clause, wherein the annular portion of the tube clamp circumscribes a tube of a bank of tubes.

The gas turbine engine of any preceding clause, further comprising one or more fittings located between the tube and the annular portion of the tube clamp.

The gas turbine engine of any preceding clause, wherein the second set of fasteners couples one or more engine accessories to the platform.

The gas turbine engine of any preceding clause, wherein the second set of fasteners extends through the platform and a leg a first accessory or a second accessory.

The gas turbine engine of any preceding clause, wherein the mounting assembly can couples to multiple tubes of the bank of tubes.

The gas turbine engine of any preceding clause, wherein the mounting assembly is used with a tube spacing and fastening system.

The gas turbine engine of any preceding clause, wherein the first accessory or the second accessory mounted to the platform is spaced from one or more of the compressor casing, the combustor casing, or the turbine casing.

The gas turbine engine of any preceding clause, wherein the platform is mounted on underlying fluid distribution systems.

The gas turbine engine of any preceding clause, wherein the bank of tubes and the platform thermally insulate heat and radiation from the one or more engine accessories mounted to the platform.

The gas turbine engine of any preceding clause, wherein a first tube clamp contacts a second surface of the platform.

The gas turbine engine of any preceding clause, wherein a first tube clamp contacts a second surface of the platform.

The gas turbine engine of any preceding clause, wherein the second set of fasteners couples the platform to the accessory such that a surface of the accessory is spaced from a confronting surface of the platform.

The gas turbine engine of any preceding clause, wherein the mounting assembly includes a first platform, a second platform, and a set of fasteners.

The gas turbine engine of any preceding clause, wherein the first platform and the second platform include a plurality of apertures.

The gas turbine engine of any preceding clause, wherein the first platform couples to at least a first tube and the second platform couples to at least a second tube.

The gas turbine engine of any preceding clause, wherein the set of fasteners couples the first platform and the second platform to an engine accessory.

The gas turbine engine of any preceding clause, wherein a gap distance is measured from a first surface of the first platform to a protrusion or a radially inner surface of the engine accessory.

The gas turbine engine of any preceding clause, wherein the gap distance is in a range of 1%-1000% of an engine accessory length.

The gas turbine engine of any preceding clause, wherein the gap distance is in a range of 1%-100% of an engine accessory length.

The gas turbine engine of any preceding clause, wherein the gap distance is in a range of 10%-150% of an engine accessory length.

The gas turbine engine of any preceding clause, wherein the fastener is a direct-mount fastener.

The gas turbine engine of any preceding clause, wherein the fastener includes a body portion that contacts one or more portions of the inner surface of the platform.

The gas turbine engine of any preceding clause, wherein the body portion contacts an inner surface of one of the set of wings.

The gas turbine engine of any preceding clause, wherein the platform is coupled to multiple tube clamps.

The gas turbine engine of any preceding clause, wherein the fastener further includes a stop provided at a base.

The gas turbine engine of any preceding clause, wherein the fastener further includes a securing portion.

The gas turbine engine of any preceding clause, wherein the fastener is a spacer-mount fastener.

The gas turbine engine of any preceding clause, wherein the fastener includes a body portion that extends between a first shelf and a second shelf.

The gas turbine engine of any preceding clause, wherein the fastener includes a first threaded portion and a second threaded portion.

The gas turbine engine of any preceding clause, wherein the mounting assembly includes a first platform, a second platform, a first set of fasteners, and a second set of fasteners.

The gas turbine engine of any preceding clause, wherein at least a subset of the second set of fasteners is a set of vibration isolators.

The gas turbine engine of any preceding clause, wherein the set of vibration isolators couple a first accessory to the first platform and the second platform.

The gas turbine engine of any preceding clause, wherein the mounting assembly includes a box platform.

The gas turbine engine of any preceding clause, wherein the box platform extends from a base coupled to one of the turbine casing or the compressor casing.

The gas turbine engine of any preceding clause, wherein a first accessory is direct-mounted to the box platform.

The gas turbine engine of any preceding clause, wherein the mounting assembly further comprises a secondary platform.

The gas turbine engine of any preceding clause, wherein the secondary platform supports one or more tubes.

The gas turbine engine of any preceding clause, wherein the mounting assembly includes a cowl platform located at the inner surface of the core cowl.

The gas turbine engine of any preceding clause, wherein the mounting assembly includes a cowl platform located at an inner surface of the fan cowl.

The gas turbine engine of any preceding clause, wherein the cowl platform is an arcuate platform circumscribing at least a portion of the inner surface of the core cowl, the fan cowl, or both.

The gas turbine engine of the preceding clause, wherein the CDR is between 2.8 and 3.3.

The gas turbine engine of any preceding clause, wherein the CLR is between 0.3 and 0.45.

The gas turbine engine of any preceding clause, wherein the CLR is between 0.40 and 0.45.

The gas turbine engine of any preceding clause, wherein each tubular structure is spaced from other tubular structures of the plurality of tubular structures.

The gas turbine engine of any preceding clause, wherein a void is defined between the outer surface of the combustor casing and the inner surface of the core cowl.

The gas turbine engine of any preceding clause, further comprising at least one engine accessory coupled to the inner surface of the core cowl.

The gas turbine engine of any preceding clause, further comprising a rear frame including a strut having a trailing edge, wherein the primary fan includes a primary fan blade having a leading edge, and wherein the overall core axial length (L) along the axial direction is measured from the leading edge of the primary fan blade to the trailing edge of the strut.

The gas turbine engine of any preceding clause, further comprising a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The gas turbine engine of any preceding clause, further comprising a ducted secondary fan disposed downstream from the primary fan.

The gas turbine engine of any preceding clause, wherein the ducted secondary fan is a single stage secondary fan.

The gas turbine engine of any preceding clause, wherein the gas turbine engine is a three-stream gas turbine engine.

The gas turbine engine of any preceding clause, wherein the fastener assembly includes a spacer element configured to engage a plurality of tubular structures, to spatially separate the plurality of tubular structures from one another, and to distribute stress in the plurality of tubular structures. A fastening element is configured to extend around at least a portion of an outer surface of the plurality of tubular structures, and to fasten the plurality of tubular structures to the spacer element in an adaptively spaced configuration.

The gas turbine engine of any preceding clause, wherein the adaptively spaced configuration comprises a first length of the fastening element below a predetermined temperature range and a second length of the fastening element above the predetermined temperature range. The first length is different from the second length.

The gas turbine engine of any preceding clause, wherein the adaptively spaced configuration comprises a first configuration, wherein the plurality of tubular structures are movably spaced around the spacer element and a second configuration, wherein the plurality of tubular structures are immovably spaced around the spacer element.

The gas turbine engine of any preceding clause, wherein the spacer element includes a first thin-walled bracket to engage a first tubular structure of the plurality of tubular structures and a second thin-walled bracket to engage a second tubular structure of the plurality of tubular structures. The first thin-walled bracket and the second thin-walled bracket join at a top end of the spacer element and at a bottom end of the spacer element.

The gas turbine engine of any preceding clause, wherein the spacer element includes a first cradle bracket configured to engage a first tubular structure of the plurality of tubular structures, a second cradle bracket configured to engage a second tubular structure of the plurality of tubular structures, and a core part separating the first cradle bracket and the second cradle bracket. The first cradle bracket, the second cradle bracket, and the core part join at a top end of the spacer element and at a bottom end of the spacer element.

The gas turbine engine of any preceding clause, wherein a first joint between the first cradle bracket and the top end, or a second joint between the second cradle bracket and the top end, or a third joint between the first cradle bracket and the bottom end, or a fourth joint between the second cradle bracket and the bottom end, or any combination thereof, comprises a filleted joint.

The gas turbine engine of any preceding clause, further comprising a first recess formed between the first cradle bracket and a first corresponding surface of the core part, and a second recess formed between the second cradle bracket and a second corresponding surface of the core part. The first recess is configured to accommodate a first part of the fastening element, and the second recess is configured to accommodate a second part of the fastening element.

The gas turbine engine of any preceding clause, wherein a first tubular structure of the plurality of tubular structures engages with the first cradle bracket at a first contact surface and a second tubular structure of the plurality of tubular structures engages with the second cradle bracket at a second contact surface. The first contact surface, or the second contact surface, or both of the first contact surface and the second contact surface includes a plurality of surface features configured to distribute the stress in the plurality of tubular structures.

The gas turbine engine of any preceding clause, wherein the plurality of surface features comprises a plurality of protrusions, or indentations, or any combination thereof.

The gas turbine engine of any preceding clause, wherein the spacer element includes a core part positioned at a center of the spacer element, and a plurality of radial arms arranged in a predetermined formation, each radial arm joining at a respective base with the core part. At least one pair of adjacent radial arms and the core part form a cradle bracket configured to engage a corresponding tubular structure in the cradle bracket.

The gas turbine engine of any preceding clause, wherein the predetermined formation comprises a cross formation, or a star formation, or any combination thereof.

The gas turbine engine of any preceding clause, wherein the fastening element comprises a shape memory alloy (SMA) band.

The gas turbine engine of any preceding clause, wherein the shape memory alloy (SMA) band comprises nickel-titanium shape-memory alloy.

The gas turbine engine of any preceding clause, wherein the platform is a box platform or a cowl platform.

The gas turbine engine of any preceding clause, wherein the platform is a plurality of platforms.

The gas turbine engine of any preceding clause, wherein at least one engine accessory is directly mounted to the platform.

The gas turbine engine of any preceding clause, wherein at least one engine accessory is mounted to the platform by the second set of fasteners, wherein the wherein at least one engine accessory is spaced from the box platform.

The gas turbine engine of any preceding clause, wherein at least a subset of the second set of fasteners includes a first shelf and a second shelf.

The gas turbine engine of any preceding clause, wherein the platform is coupled to two or more tubes.

The gas turbine engine of any preceding clause, wherein the platform is multiple platforms and wherein an engine accessory is coupled to the multiple platforms.

The gas turbine engine of any preceding clause, wherein the platform is coupled to a tube by a tube clamp.

The gas turbine engine of any preceding clause, wherein the platform is coupled to multiple tubes by multiple tube clamps.

The gas turbine engine of any preceding clause, wherein the platform is a box platform having four sides, wherein each side includes a plurality of apertures.

The gas turbine engine of any preceding clause, wherein the platform include one or more of elastomeric materials, metallic materials, composite materials.

The gas turbine engine of any preceding clause, wherein the platform is a cowl platform.

The gas turbine engine of any preceding clause, wherein the cowl platform circumscribed the inner surface of the core cowl.

An aircraft, comprising: a wing; and a gas turbine engine mounted to the wing, the gas turbine engine defining an axial direction and a radial direction, the gas turbine engine comprising: a turbomachine having an unducted primary fan, a core engine including a combustor and a combustor casing enclosing the combustor and defining an outer surface, a core cowl surrounding at least a portion of the core engine and defining an inner surface and an outer surface; and a fastener assembly or a mounting assembly located between the core engine and the core cowl or within a fan cowl; wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction, wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L), wherein the CDR is between 2.7 and 3.5 and wherein the CLR is between 0.25 and 0.50.

The aircraft of any preceding clause, wherein the fastener assembly comprises: spacer element coupled to a plurality of tubular structures, wherein each tubular structure is in contact with the spacer element, and wherein at least one tubular structure of the plurality of tubular structures is spaced from other tubular structures of the plurality of tubular structures; and a fastening element configured to extend around at least a portion of an outer surface of the plurality of tubular structures, and to fasten the plurality of tubular structures to the spacer element in an adaptively spaced configuration.

The aircraft of any preceding clause, wherein the adaptively spaced configuration comprises a first length of the fastening element below a predetermined temperature range and a second length of the fastening element above the predetermined temperature range, the first length being different from the second length.

The aircraft of any preceding clause, wherein the adaptively spaced configuration comprises a first configuration, the plurality of tubular structures are movably spaced around the spacer element and a second configuration, the plurality of tubular structures are immovably spaced around the spacer element.

The aircraft of any preceding clause, wherein the spacer element comprises: a core part positioned at a center of the spacer element; and a plurality of radial arms arranged in a predetermined formation comprising a cross formation, or a star formation, or any combination thereof, wherein at least one pair of adjacent radial arms and the core part form a cradle bracket configured to engage a corresponding tubular structure in the cradle bracket.

The aircraft of any preceding clause, wherein the mounting assembly comprises a platform, a first set of fasteners coupling the platform to the gas turbine engine, and a second set of fasteners coupling the platform to one or more engine accessory or tube.

The aircraft of any preceding clause, wherein the platform includes a plurality of apertures.

The aircraft of any preceding clause, wherein the second set of fasteners include vibration dampeners.

The aircraft of any preceding clause, wherein the platform is a box platform extending between two portions of the core casing.

The aircraft of claim 1, further comprising at least one fastener assembly comprising a spacer element and a fastening element, and at least one mounting assembly comprising a platform.

The aircraft of any preceding clause, wherein each tubular structure is spaced from other tubular structures of the plurality of tubular structures.

The aircraft of the preceding clause, wherein the CDR is between 2.8 and 3.3.

The aircraft of any preceding clause, wherein the CLR is between 0.3 and 0.45.

The aircraft of any preceding clause, wherein the CLR is between 0.40 and 0.45.

The aircraft of any preceding clause, wherein a void is defined between the outer surface of the combustor casing and the inner surface of the core cowl.

The aircraft of any preceding clause, further comprising at least one engine accessory coupled to the inner surface of the core cowl.

The aircraft of any preceding clause, further comprising a rear frame including a strut having a trailing edge, wherein the primary fan includes a primary fan blade having a leading edge, and wherein the overall core axial length (L) along the axial direction is measured from the leading edge of the primary fan blade to the trailing edge of the strut.

The aircraft of any preceding clause, further comprising a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The aircraft of any preceding clause, further comprising a ducted secondary fan disposed downstream from the primary fan.

The aircraft of any preceding clause, wherein the ducted secondary fan is a single stage secondary fan.

The aircraft of any preceding clause, wherein the gas turbine engine is a three-stream gas turbine engine.

The aircraft of any preceding clause, wherein the fastener assembly includes a spacer element configured to engage a plurality of tubular structures, to spatially separate the plurality of tubular structures from one another, and to distribute stress in the plurality of tubular structures. A fastening element is configured to extend around at least a portion of an outer surface of the plurality of tubular structures, and to fasten the plurality of tubular structures to the spacer element in an adaptively spaced configuration.

The aircraft of any preceding clause, wherein the adaptively spaced configuration comprises a first length of the fastening element below a predetermined temperature range and a second length of the fastening element above the predetermined temperature range. The first length is different from the second length.

The aircraft of any preceding clause, wherein the adaptively spaced configuration comprises a first configuration, wherein the plurality of tubular structures are movably spaced around the spacer element and a second configuration, wherein the plurality of tubular structures are immovably spaced around the spacer element.

The aircraft of any preceding clause, wherein the spacer element includes a first thin-walled bracket to engage a first tubular structure of the plurality of tubular structures and a second thin-walled bracket to engage a second tubular structure of the plurality of tubular structures. The first thin-walled bracket and the second thin-walled bracket join at a top end of the spacer element and at a bottom end of the spacer element.

The aircraft of any preceding clause, wherein the spacer element includes a first cradle bracket configured to engage a first tubular structure of the plurality of tubular structures, a second cradle bracket configured to engage a second tubular structure of the plurality of tubular structures, and a core part separating the first cradle bracket and the second cradle bracket. The first cradle bracket, the second cradle bracket, and the core part join at a top end of the spacer element and at a bottom end of the spacer element.

The aircraft of any preceding clause, wherein a first joint between the first cradle bracket and the top end, or a second joint between the second cradle bracket and the top end, or a third joint between the first cradle bracket and the bottom end, or a fourth joint between the second cradle bracket and the bottom end, or any combination thereof, comprises a filleted joint.

The aircraft of any preceding clause, further comprising a first recess formed between the first cradle bracket and a first corresponding surface of the core part, and a second recess formed between the second cradle bracket and a second corresponding surface of the core part. The first recess is configured to accommodate a first part of the fastening element, and the second recess is configured to accommodate a second part of the fastening element.

The aircraft of any preceding clause, wherein a first tubular structure of the plurality of tubular structures engages with the first cradle bracket at a first contact surface and a second tubular structure of the plurality of tubular structures engages with the second cradle bracket at a second contact surface. The first contact surface, or the second contact surface, or both of the first contact surface and the second contact surface includes a plurality of surface features configured to distribute the stress in the plurality of tubular structures.

The aircraft of any preceding clause, wherein the plurality of surface features comprises a plurality of protrusions, or indentations, or any combination thereof.

The aircraft of any preceding clause, wherein the spacer element includes a core part positioned at a center of the spacer element, and a plurality of radial arms arranged in a predetermined formation, each radial arm joining at a respective base with the core part. At least one pair of adjacent radial arms and the core part form a cradle bracket configured to engage a corresponding tubular structure in the cradle bracket.

The aircraft of any preceding clause, wherein the predetermined formation comprises a cross formation, or a star formation, or any combination thereof.

The aircraft of any preceding clause, wherein the fastening element comprises a shape memory alloy (SMA) band.

The aircraft of any preceding clause, wherein the shape memory alloy (SMA) band comprises nickel-titanium shape-memory alloy.

The aircraft of any preceding clause, wherein the platform is a box platform or a cowl platform.

The aircraft of any preceding clause, wherein the platform is a plurality of platforms.

The aircraft of any preceding clause, wherein at least one engine accessory is directly mounted to the platform.

The aircraft of any preceding clause, wherein at least one engine accessory is mounted to the platform by the second set of fasteners, wherein the wherein at least one engine accessory is spaced from the box platform.

The aircraft of any preceding clause, wherein at least a subset of the second set of fasteners includes a first shelf and a second shelf.

The aircraft of any preceding clause, wherein the platform is coupled to two or more tubes.

The aircraft of any preceding clause, wherein the platform is multiple platforms and wherein an engine accessory is coupled to the multiple platforms.

The aircraft of any preceding clause, wherein the platform is coupled to a tube by a tube clamp.

The aircraft of any preceding clause, wherein the platform is coupled to multiple tubes by multiple tube clamps.

The aircraft of any preceding clause, wherein the platform is a box platform having four sides, wherein each side includes a plurality of apertures.

The aircraft of any preceding clause, wherein the platform include one or more of elastomeric materials, metallic materials, composite materials.

The aircraft of any preceding clause, wherein the platform is a cowl platform.

The aircraft of any preceding clause, wherein the cowl platform circumscribed the inner surface of the core cowl.

The aircraft of any preceding clause, wherein the gas turbine engine further comprises a rear frame including a strut having a trailing edge, wherein the primary fan includes a plurality of primary fan blades where each primary fan blade has a leading edge, and wherein the overall core axial length (L) along the axial direction is measured from a leading edge of a respective primary fan blade of the plurality of primary fan blades to the trailing edge of the strut.

The aircraft of any preceding clause, wherein the gas turbine engine further comprises a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The aircraft of any preceding clause, the gas turbine engine further comprising a ducted secondary fan disposed downstream from the unducted primary fan.

The aircraft of any preceding clause, wherein the mounting assembly is located in the core cowl.

The aircraft of any preceding clause, wherein the mounting assembly is located in the fan cowl.

The aircraft of any preceding clause, wherein the mounting assembly is located in the fan cowl.

The aircraft of any preceding clause, wherein the mounting assembly includes a platform, a first set of fasteners, and a second set of fasteners.

The aircraft of any preceding clause, wherein the platform includes a plurality of apertures, wherein the plurality of apertures extend from a first surface through the platform to a second surface opposite the first surface.

The aircraft of any preceding clause, wherein the first set of fasteners couples the platform to one or more portions of the gas turbine engine.

The aircraft of any preceding clause, wherein the first set of fasteners couples the platform to one or more portions of the engine casings located at the low-pressure compressor, the high-pressure compressor, the high-pressure turbine the low-pressure turbine or any combination thereof.

The aircraft of any preceding clause, wherein the mounting assembly further comprises a tube clamp having a set of wings.

The aircraft of any preceding clause, wherein the first set of fasteners extend through the platform and one or more portions of the set of wings.

The aircraft of any preceding clause, wherein the first set of fasteners couples the set of wings of the tube clamp to the platform.

The aircraft of any preceding clause, wherein the set of wings of the tube clamp extend from an annular portion of the tube clamp.

The aircraft of any preceding clause, wherein the annular portion of the tube clamp circumscribes a tube of a bank of tubes.

The aircraft of any preceding clause, further comprising one or more fittings located between the tube and the annular portion of the tube clamp.

The aircraft of any preceding clause, wherein the second set of fasteners couples one or more engine accessories to the platform.

The aircraft of any preceding clause, wherein the second set of fasteners extends through the platform and a leg a first accessory or a second accessory.

The aircraft of any preceding clause, wherein the mounting assembly can couples to multiple tubes of the bank of tubes.

The aircraft of any preceding clause, wherein the mounting assembly is used with a tube spacing and fastening system.

The aircraft of any preceding clause, wherein the first accessory or the second accessory mounted to the platform is spaced from one or more of the compressor casing, the combustor casing, or the turbine casing.

The aircraft of any preceding clause, wherein the platform is mounted on underlying fluid distribution systems.

The aircraft of any preceding clause, wherein the bank of tubes and the platform thermally insulate heat and radiation from the one or more engine accessories mounted to the platform.

The aircraft of any preceding clause, wherein a first tube clamp contacts a second surface of the platform.

The aircraft of any preceding clause, wherein a first tube clamp contacts a second surface of the platform.

The aircraft of any preceding clause, wherein the second set of fasteners couples the platform to the accessory such that a surface of the accessory is spaced from a confronting surface of the platform.

The aircraft of any preceding clause, wherein the mounting assembly includes a first platform, a second platform, and a set of fasteners.

The aircraft of any preceding clause, wherein the first platform and the second platform include a plurality of apertures.

The aircraft of any preceding clause, wherein the first platform couples to at least a first tube and the second platform couples to at least a second tube.

The aircraft of any preceding clause, wherein the set of fasteners couples the first platform and the second platform to an engine accessory.

The aircraft of any preceding clause, wherein a gap distance is measured from a first surface of the first platform to a protrusion or a radially inner surface of the engine accessory.

The aircraft of any preceding clause, wherein the gap distance is in a range of 1%-1000% of an engine accessory length.

The aircraft of any preceding clause, wherein the gap distance is in a range of 1%-100% of an engine accessory length.

The aircraft of any preceding clause, wherein the gap distance is in a range of 10%-150% of an engine accessory length.

The aircraft of any preceding clause, wherein the fastener is a direct-mount fastener.

The aircraft of any preceding clause, wherein the fastener includes a body portion that contacts one or more portions of the inner surface of the platform.

The aircraft of any preceding clause, wherein the body portion contacts an inner surface of one of the set of wings.

The aircraft of any preceding clause, wherein the platform is coupled to multiple tube clamps.

The aircraft of any preceding clause, wherein the fastener further includes a stop provided at a base.

The aircraft of any preceding clause, wherein the fastener further includes a securing portion.

The aircraft of any preceding clause, wherein the fastener is a spacer-mount fastener.

The aircraft of any preceding clause, wherein the fastener includes a body portion that extends between a first shelf and a second shelf.

The gas turbine engine of any preceding clause, wherein the fastener includes a first threaded portion and a second threaded portion.

The aircraft of any preceding clause, wherein the mounting assembly includes a first platform, a second platform, a first set of fasteners, and a second set of fasteners.

The aircraft of any preceding clause, wherein at least a subset of the second set of fasteners is a set of vibration isolators.

The aircraft of any preceding clause, wherein the set of vibration isolators couple a first accessory to the first platform and the second platform.

The aircraft of any preceding clause, wherein the mounting assembly includes a box platform.

The aircraft of any preceding clause, wherein the box platform extends from a base coupled to one of the turbine casing or the compressor casing.

The aircraft of any preceding clause, wherein a first accessory is direct-mounted to the box platform.

The aircraft of any preceding clause, wherein the mounting assembly further comprises a secondary platform.

The aircraft of any preceding clause, wherein the secondary platform supports one or more tubes.

The aircraft of any preceding clause, wherein the mounting assembly includes a cowl platform located at the inner surface of the core cowl.

The aircraft of any preceding clause, wherein the mounting assembly includes a cowl platform located at an inner surface of the fan cowl.

The aircraft of any preceding clause, wherein the cowl platform is an arcuate platform circumscribing at least a portion of the inner surface of the core cowl, the fan cowl, or both.

The aircraft of the preceding clause, wherein the CDR is between 2.8 and 3.3.

The aircraft of any preceding clause, wherein the CLR is between 0.3 and 0.45.

The aircraft of any preceding clause, wherein the CLR is between 0.40 and 0.45.

The aircraft of any preceding clause, wherein each tubular structure is spaced from other tubular structures of the plurality of tubular structures.

The aircraft of any preceding clause, wherein a void is defined between the outer surface of the combustor casing and the inner surface of the core cowl.

The aircraft of any preceding clause, further comprising at least one engine accessory coupled to the inner surface of the core cowl.

The aircraft of any preceding clause, further comprising a rear frame including a strut having a trailing edge, wherein the primary fan includes a primary fan blade having a leading edge, and wherein the overall core axial length (L) along the axial direction is measured from the leading edge of the primary fan blade to the trailing edge of the strut.

The aircraft of any preceding clause, further comprising a high-pressure compressor inlet guide vane having a leading edge, and a rear frame including a strut having a trailing edge, wherein the under-core cowl axial length (L1) along the axial direction is measured from the leading edge of the inlet guide vane to the trailing edge of the strut.

The aircraft of any preceding clause, further comprising a ducted secondary fan disposed downstream from the primary fan.

The aircraft of any preceding clause, wherein the ducted secondary fan is a single stage secondary fan.

The aircraft of any preceding clause, wherein the gas turbine engine is a three-stream gas turbine engine.

The aircraft of any preceding clause, wherein the fastener assembly includes a spacer element configured to engage a plurality of tubular structures, to spatially separate the plurality of tubular structures from one another, and to distribute stress in the plurality of tubular structures. A fastening element is configured to extend around at least a portion of an outer surface of the plurality of tubular structures, and to fasten the plurality of tubular structures to the spacer element in an adaptively spaced configuration.

The aircraft of any preceding clause, wherein the adaptively spaced configuration comprises a first length of the fastening element below a predetermined temperature range and a second length of the fastening element above the predetermined temperature range. The first length is different from the second length.

The aircraft of any preceding clause, wherein the adaptively spaced configuration comprises a first configuration, wherein the plurality of tubular structures are movably spaced around the spacer element and a second configuration, wherein the plurality of tubular structures are immovably spaced around the spacer element.

The aircraft of any preceding clause, wherein the spacer element includes a first thin-walled bracket to engage a first tubular structure of the plurality of tubular structures and a second thin-walled bracket to engage a second tubular structure of the plurality of tubular structures. The first thin-walled bracket and the second thin-walled bracket join at a top end of the spacer element and at a bottom end of the spacer element.

The aircraft of any preceding clause, wherein the spacer element includes a first cradle bracket configured to engage a first tubular structure of the plurality of tubular structures, a second cradle bracket configured to engage a second tubular structure of the plurality of tubular structures, and a core part separating the first cradle bracket and the second cradle bracket. The first cradle bracket, the second cradle bracket, and the core part join at a top end of the spacer element and at a bottom end of the spacer element.

The aircraft of any preceding clause, wherein a first joint between the first cradle bracket and the top end, or a second joint between the second cradle bracket and the top end, or a third joint between the first cradle bracket and the bottom end, or a fourth joint between the second cradle bracket and the bottom end, or any combination thereof, comprises a filleted joint.

The aircraft of any preceding clause, further comprising a first recess formed between the first cradle bracket and a first corresponding surface of the core part, and a second recess formed between the second cradle bracket and a second corresponding surface of the core part. The first recess is configured to accommodate a first part of the fastening element, and the second recess is configured to accommodate a second part of the fastening element.

The aircraft of any preceding clause, wherein a first tubular structure of the plurality of tubular structures engages with the first cradle bracket at a first contact surface and a second tubular structure of the plurality of tubular structures engages with the second cradle bracket at a second contact surface. The first contact surface, or the second contact surface, or both of the first contact surface and the second contact surface includes a plurality of surface features configured to distribute the stress in the plurality of tubular structures.

The aircraft of any preceding clause, wherein the plurality of surface features comprises a plurality of protrusions, or indentations, or any combination thereof.

The aircraft of any preceding clause, wherein the spacer element includes a core part positioned at a center of the spacer element, and a plurality of radial arms arranged in a predetermined formation, each radial arm joining at a respective base with the core part. At least one pair of adjacent radial arms and the core part form a cradle bracket configured to engage a corresponding tubular structure in the cradle bracket.

The aircraft of any preceding clause, wherein the predetermined formation comprises a cross formation, or a star formation, or any combination thereof.

The aircraft of any preceding clause, wherein the fastening element comprises a shape memory alloy (SMA) band.

The aircraft of any preceding clause, wherein the shape memory alloy (SMA) band comprises nickel-titanium shape-memory alloy.

The aircraft of any preceding clause, wherein the platform is a box platform or a cowl platform.

The aircraft of any preceding clause, wherein the platform is a plurality of platforms.

The aircraft of any preceding clause, wherein at least one engine accessory is directly mounted to the platform.

The aircraft of any preceding clause, wherein at least one engine accessory is mounted to the platform by the second set of fasteners, wherein the wherein at least one engine accessory is spaced from the box platform.

The aircraft of any preceding clause, wherein at least a subset of the second set of fasteners includes a first shelf and a second shelf.

The aircraft of any preceding clause, wherein the platform is coupled to two or more tubes.

The aircraft of any preceding clause, wherein the platform is multiple platforms and wherein an engine accessory is coupled to the multiple platforms.

The aircraft of any preceding clause, wherein the platform is coupled to a tube by a tube clamp.

The aircraft of any preceding clause, wherein the platform is coupled to multiple tubes by multiple tube clamps.

The aircraft of any preceding clause, wherein the platform is a box platform having four sides, wherein each side includes a plurality of apertures.

The aircraft of any preceding clause, wherein the platform include one or more of elastomeric materials, metallic materials, composite materials.

The aircraft of any preceding clause, wherein the platform is a cowl platform.

The aircraft of any preceding clause, wherein the cowl platform circumscribed the inner surface of the core cowl.

A method includes providing a spacer element, engaging a plurality of tubular structures to the spacer element, spatially separating the plurality of tubular structures from one another, and distributing stress in the plurality of tubular structures, extending a fastening element around at least a portion of an outer surface of the plurality of tubular structures, and fastening the plurality of tubular structures to the spacer element in an adaptively spaced configuration.

The method according to any preceding clause, wherein the fastening of the plurality of tubular structures to the spacer element in the adaptively spaced configuration comprises fastening the plurality of tubular structures to the spacer element by a first length of the fastening element below a predetermined temperature range, and fastening the plurality of tubular structures to the spacer element by a second length of the fastening element above the predetermined temperature range. The first length is different from the second length.

The method according to any preceding clause, wherein the fastening of the plurality of tubular structures to the spacer element in the adaptively spaced configuration comprises fastening the plurality of tubular structures to the spacer element in a first configuration, wherein the plurality of tubular structures are movably spaced around the spacer element, and a second configuration, wherein the plurality of tubular structures are immovably spaced around the spacer element.

The method according to any preceding clause, wherein the engaging of the plurality of tubular structures to the spacer element comprises engaging a first tubular structure of the plurality of tubular structures to a first thin-walled bracket of the spacer element, engaging a second tubular structure of the plurality of tubular structures to a second thin-walled bracket of the spacer element, and joining the first thin-walled bracket, the second thin-walled bracket at a top end of the spacer element and at a bottom end of the spacer element. The spatially separating the plurality of tubular structures from one another comprises spatially separating the first thin-walled bracket and the second thin-walled bracket by a hollow space in between the first thin-walled bracket and the second thin-walled bracket.

The method according to any preceding clause, wherein the engaging of the plurality of tubular structures to the spacer element comprises engaging a first tubular structure of the plurality of tubular structures to a first cradle bracket of the spacer element, engaging a second tubular structure of the plurality of tubular structures to a second cradle bracket of the spacer element, and joining the first cradle bracket, the second cradle bracket, and a core part of the spacer element at a top end of the spacer element and at a bottom end of the spacer element. The spatially separating the plurality of tubular structures from one another comprises spatially separating the first cradle bracket and the second cradle bracket by the core part positioned in between the first cradle bracket and the second cradle bracket.

The method according to any preceding clause, wherein the extending of the fastening element comprises filleting a first joint between the first cradle bracket and the top end, or a second joint between the second cradle bracket and the top end, or a third joint between the first cradle bracket and the bottom end, or a fourth joint between the second cradle bracket and the bottom end, or any combination thereof.

The method according to any preceding clause, wherein the extending of the fastening element comprises accommodating a first part of the fastening element in a first recess between the first cradle bracket and a first corresponding surface of the core part, and accommodating a second part of the fastening element in a second recess between the second cradle bracket and a second corresponding surface of the core part.

The method according to any preceding clause, wherein the engaging of each of the plurality of tubular structures to the spacer element comprises joining a first tubular structure of the plurality of tubular structures and the first cradle bracket at a first contact surface, joining a second tubular structure of the plurality of tubular structures and the second cradle bracket at a second contact surface. The distributing of stress in the plurality of tubular structures comprises providing a plurality of surface features on the first contact surface, or the second contact surface, or both of the first contact surface and the second contact surface.

The method according to any preceding clause, wherein the providing of the plurality of surface features comprises providing a plurality of protrusions, or indentations, or any combination thereof.

The method according to any preceding clause, wherein the providing of the spacer element comprises arranging a plurality of radial arms in a predetermined formation, joining each radial arm at a respective base with a core part of the spacer element, forming a cradle bracket with at least one pair of adjacent radial arms and the core part, and engaging a corresponding one of the plurality of tubular structures in the cradle bracket.

The method according to any preceding clause, wherein the arranging of the plurality of radial arms in the predetermined formation comprises arranging the plurality of radial arms in a cross formation, or arranging the plurality of radial arms in a star formation, or arranging the plurality of radial arms in any combination thereof.

The method according to any preceding clause, wherein the extending the fastening element comprises extending a shape memory alloy (SMA) band.

The method according to any preceding clause, wherein the shape memory alloy (SMA) band comprises nickel-titanium shape-memory alloy.

What is claimed is:

1. A gas turbine engine defining an axial direction and a radial direction, the gas turbine engine comprising:
a turbomachine having an unducted primary fan, a core engine including a combustor and a combustor casing enclosing the combustor and defining an outer surface, a core cowl surrounding at least a portion of the core engine and defining an inner surface and an outer surface; and
a fastener assembly or a mounting assembly located between the core engine and the core cowl or within a fan cowl;
wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction,
wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L),
wherein the CDR is between 2.7 and 3.5 and wherein the CLR is between 0 0.25 and 0.50.

2. The gas turbine engine of claim 1, wherein the fastener assembly comprises:
a spacer element coupled to a plurality of tubular structures, wherein at least one tubular structure of the plurality of tubular structures is in contact with the spacer element; and
a fastening element configured to extend around at least a portion of an outer surface of the plurality of tubular structures, and to fasten the plurality of tubular structures to the spacer element in an adaptively spaced configuration.

3. The gas turbine engine of claim 2, wherein the adaptively spaced configuration comprises the fastening element having a first length when the fastening element is below a predetermined temperature range and the fastening element having a second length when the fastening element is above the predetermined temperature range, the first length being different from the second length.

4. The gas turbine engine of claim 2, wherein the adaptively spaced configuration comprises a first configuration wherein the plurality of tubular structures are movably spaced around the spacer element and a second configuration wherein the plurality of tubular structures are immovably spaced around the spacer element.

5. The gas turbine engine of claim 2, wherein each tubular structure of the plurality of tubular structures is spaced from other tubular structures of the plurality of tubular structures.

6. The gas turbine engine of claim 1, wherein the spacer element comprises:
a core part positioned at a center of the spacer element; and
a plurality of radial arms arranged in a predetermined formation comprising a cross formation, a star formation, or a combination thereof,
wherein at least one pair of adjacent radial arms and the core part form a cradle bracket configured to engage a corresponding tubular structure in the cradle bracket.

7. The gas turbine engine of claim 1, wherein the mounting assembly comprises a platform, a first set of fasteners coupling the platform to the gas turbine engine, and a second set of fasteners coupling the platform to one or more engine accessory or tube.

8. The gas turbine engine of claim 7, wherein the platform includes a plurality of apertures.

9. The gas turbine engine of claim 7, wherein the second set of fasteners include vibration dampeners.

10. The gas turbine engine of claim 7, wherein the platform is a box platform extending between two portions of the core casing.

11. The gas turbine engine of claim 1, further comprising at least one fastener assembly comprising a spacer element and a fastening element, and at least one mounting assembly comprising a platform.

12. The gas turbine engine of claim 1, wherein the CDR is between 2.8 and 3.3.

13. The gas turbine engine of claim 1, wherein the CLR is between 0.3 and 0.45.

14. The gas turbine engine of claim 1, further comprising a ducted secondary fan disposed downstream from the primary fan.

15. The gas turbine engine of claim 1, wherein the gas turbine engine is a three-stream gas turbine engine.

16. An aircraft, comprising:
a wing; and
a gas turbine engine mounted to the wing, the gas turbine engine defining an axial direction and a radial direction, the gas turbine engine comprising:
a turbomachine having an unducted primary fan, a core engine including a combustor and a combustor casing enclosing the combustor and defining an outer surface, a core cowl surrounding at least a portion of the core engine and defining an inner surface and an outer surface; and
a fastener assembly or a mounting assembly located between the core engine and the core cowl or within a fan cowl;
wherein the outer surface of the core cowl defines a peak cowl diameter (D) in the radial direction, the outer surface of the combustor casing defines a maximum combustor casing diameter (d) along the radial direction, the core engine defines an overall core axial length (L) along the axial direction and an under-core cowl axial length (L1) along the axial direction,
wherein the gas turbine engine defines a core cowl diameter ratio (CDR) equal to the peak cowl diameter (D) divided by the maximum combustor casing diameter (d) and a core cowl length ratio (CLR) equal to the under-core cowl axial length (L1) divided by the overall core axial length (L),
wherein the CDR is between 2.7 and 3.5 and wherein the CLR is between 0 0.25 and 0.50.

17. The aircraft claim 16, wherein the fastener assembly comprises:
a spacer element coupled to a plurality of tubular structures, wherein at least one tubular structure of the plurality of tubular structures is in contact with the spacer element; and
a fastening element configured to extend around at least a portion of an outer surface of the plurality of tubular structures, and to fasten the plurality of tubular structures to the spacer element in an adaptively spaced configuration.

18. The aircraft of claim 16, wherein the mounting assembly comprises a platform, a first set of fasteners coupling the platform to the gas turbine engine, and a second set of fasteners coupling the platform to one or more engine accessory or tube.

19. The aircraft of claim 16, further comprising at least one fastener assembly comprising a spacer element and a fastening element, and at least one mounting assembly comprising a platform.

20. The aircraft as in claim 16, wherein a void is defined between the outer surface of the combustor casing and the inner surface of the core cowl of the gas turbine engine, and wherein at least one engine accessory is coupled to a cowl platform coupled to the inner surface of the core cowl.
